(19) United States
(12) Patent Application Publication
(10) Pub. No.: US 2003/0177187 A1
(43) Pub. Date: Sep. 18, 2003

(54) Computing grid for massively multi-player online games and other multi-user immersive persistent-state and session-based applications

(75) Inventors: David A. Levine, Shepherdstown, WV (US); Gabriel D. Minton, Keedysville, MD (US); Mark C. Wirt, Shepherdstown, WV (US); Barry A. Whitebook, Charles Town, WV (US)

Correspondence Address: STERNE, KESSLER, GOLDSTEIN & FOX PLLC, 1100 NEW YORK AVENUE, N.W., WASHINGTON, DC, 20005, US

(73) Assignee: BUTTERFLY.NET. INC.

(21) Appl. No.: 10/368,443

(22) Filed: Feb. 20, 2003

Related U.S. Application Data
(63) Continuation-in-part of application No. 09/721,979, filed on Nov. 27, 2000.
(60) Provisional application No. 60/364,640, filed on Mar. 18, 2002.
(60) Provisional application No. 60/364,639, filed on Mar. 18, 2002.

(51) Int. Cl. G06F 15/16; G06F 9/44

(52) U.S. Cl. 709/205; 709/315; 709/229; 709/226

(57) ABSTRACT

A method of managing a collaborative process includes defining a plurality of locales on a plurality of servers, creating a plurality of objects corresponding to players in the plurality of locales, and mediating object state of the objects between the locales in a seamless manner so that the locales form a seamless world.

### CROSS-REFERENCE TO RELATED APPLICATIONS

This application is a continuation-in-part of commonly assigned U.S. patent application Ser. No. 09/721,979, filed Nov. 27, 2000, and claims priority to commonly assigned U.S. Provisional Patent Application No. 60/364,640, filed Mar. 18, 2002, U.S. Provisional Patent Application No. 60/364,639, filed Mar. 18, 2002, all of which are hereby incorporated by reference in their entirety.

### BACKGROUND OF THE INVENTION

1. Field of the Invention

The present invention relates generally to computer network systems, and more particularly to computer network systems that facilitate multi-person interaction within multiple immersive environments.

2. Related Art

In recent decades, there has been rapid growth in the numbers of computers, and thus people, connected to the Internet, a vast network of computers connected by common communication protocols and data formats, and the World-Wide Web (WWW), a layer of structured information transmitted over the Internet. This increase of connectivity has allowed computer users to access various types of information, disseminate information, be participate in electronic commerce transactions, as well as engage in various forms of social interaction and entertainment previously limited by geographic and/or socio-political bounds.

Using the Internet, people can send electronic messages, play games and collaborate on work projects concurrently with other users regardless of terrestrial or extraterrestrial bounds. More particularly, there has been a dramatic rise in the number of servers connected to the Internet through which service providers offer users the opportunity to interact in an environment mediated by a software application. That is, several people can simultaneously provide inputs into a shared computer program and thus participate in the shared computer program. Each participant's actions, decisions, etc. can affect the shared virtual environment and thus affect the shared virtual environment for all participants. These programs are known as multi-user, interactive applications.

Today, many of the computers connected to the Internet have the ability to execute software programs that rapidly render and display data as animated, interactive three-dimensional (3D) representations of scenes. As the computer operator interacts with the 3D interface to the program, the computer redraws the 3D representation rapidly enough to convey to the user the sense of a continuous, ongoing reality in which the user is participating. The scenes that comprise these applications are composed of many separate models, each described by sets polygons. The dimensions of the polygons that make up the models, and thus the scenes, are manipulated by the software and hardware in end-user's computer, frame after frame, according to rules that mediate that inputs provided by the computer's operator and by remote events communicated to the portion of the software application resident on the local computer over the network. These events may have been originated by software processes (“daemons”) being executed independently on servers, generated by inputs performed by other users of the application on remote computers or caused by physical processes in the real world and translated to digital computer-processed events by sensors. Software real-time 3D renderers, such as DirectX (created by Microsoft), NetImmerse (created by Numerical Design Limited), Renderware (created by Criterion) and Alchemy (created by Intrinsic Graphics) and hardware 3D graphics acceleration cards, such as the GeForce FX (created by NVIDIA) and the RADEON 9700 Pro Visual Processing Unit (created by ATI), designed specifically for the manipulation of 3D scenes, are typically utilized on the end-user's computer for applications that require interactive, sequential, real-time 3D scene generation. In addition to manipulating the polygons that comprise the successive scenes, these specialized hardware and software sub-systems accelerate the rendering of elements that enhance the sense, or illusion, of a virtual reality existing independently of the computer and network systems. These elements may include z-buffering for efficient rendering and manipulation of the polygons, dynamic lighting, which allows the polygonal models to act as sources of illumination or cast shadows in a realistic manner, texture-maps which cover the polygonal models in photo-realistic graphics and bump-maps which apply dynamic lighting and shadows to the texture-maps to give a tactile sense of gouges, bumps or other irregularities in the models. Interactive applications that can manipulate and present data at a rate of 30 frames per second (FPS) or greater, which is sufficient to convey to the user a sense of continuous reality, are known as immersive applications.

Many forms of multi-user, immersive applications exist to simulate real-world phenomena within computer models. These interactive applications, known as Simulations, are useful in a variety of fields and support a number of disciplines, including energy (seismic analysis and reservoir analysis), financial services (derivative analysis, statistical analysis, portfolio risk analysis), manufacturing (mechanical/electric design, process simulation, finite element analysis, failure analysis), life sciences/bioinformatics (protein folding, drug discovery, protein sequencing), telecommunications/information technology (network and systems management) and academic research (weather analysis, particle physics). Simulations require accurate data and algorithms that describe real-world phenomena, such as the physical properties (strength, elasticity, etc.) of the materials used in a manufacturing process and the product to create a simulation of the process and a simulation of the product in use. Simulations can take numerous forms, including input as data in the form of text that describes the state of the processes and products at the point when the Simulation begins and output as text that describes the state of processes and products being simulated at the time when the simulation ends. Simulations that display successive 3D graphic renderings that represent real-world processes and products are known as immersive Simulations.

Within the field of manufacturing, immersive Simulations are often employed in the discipline that is loosely called Concurrent Engineering (CE) or concurrent product/process development. Computing systems that support CE are generally comprised of many separate sub-systems that each support a different aspect of the product design or manufacturing process. 3D CAD/CAM (Computer Aided Design, Computer Aided Manufacturing) tools allow design engineers to create 3D representations of the product or component parts of the while referencing the attributes of elements used in the design process culled from specialized databases, Product Description Management (PDM) systems store the work product of portions of the design process as files that that can be referencing by other engineers working on other parts of the product or process and project management, collaboration or workflow systems guide the engineering processes through the full life-cycle from conception of the product or processes through de-commissioning of the processes or end-of-lifing the product. In each of these systems, multi-user interaction within the context of the simulation and the application environment can be important.

Within the field of Concurrent Engineering, the state of the art tends to provides only loose integration between the applications or subsystems that provide multi-user interaction, the applications or subsystems that provide immersive simulation and applications or subsystems that collect data from sensors or otherwise interface with real-world processes and operations. While collaborative systems exist that allow engineers to exchange data, and to work on those data together, the majority of these systems are designed to merely transfer data files. Meta-information about the relationship of those files is stored (so that an interrelationship can be developed) in systems that are often termed “knowledge-based.” These systems aid in the management and development of large projects, but they do not provide a uniform or holistic view of the component data. The interactions of users with those data are through multiple client programs, with no application providing a view of the whole. Interaction among and between users of the system tends to be “out of band,” i.e., via email, instant messaging, Web-based discussion forums, etc. These communication systems can be bundled into an application suites, but the interactions take place outside the environment of the data models (the Simulations) themselves.

Visualization systems for collaborative work also exist. In general, these systems are data-file view utilities that allow users to view models produced by various client software programs with a single program. Additionally, they may allow users to annotate the files or modify them in some way, but they often do not allow the users to change those data to the same extent as the original authoring tools allow. These systems are beneficial in that users need not master the intricacies of multiple authoring tools to view different types of models, but again, they are not interactive.

Product and process life-cycle management systems (e.g., project management systems) are another important area of multi-user systems. These systems allow users to oversee the complete life-cycle, from conception to decommissioning of a product or system, including the design, manufacturing and operation of the product. Unfortunately these systems tend not to be closely integrated with the systems that are actually used to perform these discrete phases. They allow users to manage the system to an extent (by providing an overview of the program). Life-cycle management systems can also suffer from a common shortcoming in that real-time input that is germane to the operation of the program does not update the data model in real-time.

In the operation of systems (be they a building, a manufacturing line, etc.), embedded real-time systems are often employed. These systems employ a real-time protocol stack (RTPS) to share data amongst various machines or systems. These data can be control messages, environmental variable, status messages, etc. Commonly, the controlling system either communicates directly with the controlled devices, or publishes control messages that are distributed via middleware to subscribing controlled devices. In such applications reliability and time-responsiveness is very important, as a delay or loss of information in transmission can cause costly errors.

Just as immersive Simulations provide a common, holistic, interactive model of potential or historical real-world processes, Massively Multiplayer Online Games (MMOGs) provide an immersive, interactive model of imaginary realms. MMOGs have become an important and popular form of entertainment. MMOGs generally consist of a responsive, navigable 3D representation of a fictional realm based on themes, rules, and roles taken from literature, cinema, original concepts or stand-alone game franchises. The rules of many MMOGs are based on paper and dice role-playing games popularized in the dice game Dungeons and Dragons. They also contain a chat interface for textual communications between players and to display messages generated by the system (as represented by Non-Player Characters (NPCs)). MMOGs also provide tools for customizing the interface, characters and environment. The chat screen also provides a text window for messages generated by the system. Because the game-world persists even after the player logs out, MMOGs are also knows as Persistent-State World (PSW) games. MMOGs are also typically distributed independently of multi-user environments on CD-ROM or DVD or available for download over the Internet. These MMOGs connect to their own servers. In addition, services such as BattleZone provide a service for connecting players of session-based games. Unlike MMOGs, session-based games do not maintain the state of the game after the players have finished a game-playing session. Further examples of such online, multi-player games include “EverQuest” from (Verant Interactive/Sony Computer Entertainment America), “Ultima Online” from Electronic Arts, Inc., “Asheron's Call” from the Microsoft Corporation, and the like.

A common characteristic of the tools employed in the design, implementation, and operation of physical systems is that they are discrete: the tools used to design a building (for example) are not the same tools that are used to track the progress of the construction crews, which are in turn different tools than are used by those who run the building day-to-day. While this is understandable (and may be desirable owing to the specific nature of those tools), what is lacking is a system that provides an integrated model of the environment that takes data from disparate sources and allows users to interact with one another and the system itself though this shared model.

One common characteristic (and short-coming) among the various multi-person interactive applications is that they are based on the client-server paradigm. This means that most of the processing involved in executing these multi-person interactive applications is centralized on the server computers to which the client computers are connected. This method of creating a virtual community is not entirely scalable or reliable and does not provide for decentralized management of users and devices. Typically, because of the limited scalability, only a small subset of simultaneous users can interact with one another at any time. Users can only interact with those connected to the same server (i.e., in the same domain, or realm) so the model becomes segmented.

Another common characteristic (and short-coming) among the various multi-person, interactive applications is that the user (client) interface to the server-based virtual environment is typically a personal computer, workstation or terminal where the user must distinguish between the real world and the virtual world. Consequently, users of multi-person interactive environments employ terms such as IRL (“in real life”) to distinguish between their actual physical location (e.g., “I'm in my bedroom IRL.”), and the virtual world (e.g., “I'm in the living room”) which suggests that such a user is in the living room in the MMOG interactive application program, and not in the living room of their real house. In addition, the various multi-person interactive applications is that users cannot interact or otherwise respond to events that occur in the virtual (or real) environment when they are away from their personal computers, workstations or terminals. That is, users can not participate in the virtual, interactive, multi-person environment unless they are sitting at the computer. A further shortcoming is that due to their design and inability to cross technical platforms, current interactive applications are limited to a few client bases.

Aside from personal computers, workstations and terminals connected to the Internet, mobile phones, computer tablets, two-way pagers, personal digital assistants (PDAs) and the like, are commonly owned and each represent an opportunity to allow users to participate in multi-person, interactive applications. Conventional multi-user interactive applications, however, do not allow users to access the virtual environment using these devices.

Finally, another shortcoming among the various multi-person, interactive applications is that users cannot control physical devices such as machinery, appliances and vehicles (IRL), through their interactions with virtual world objects.

Given the foregoing, what is needed is a system, method and computer program product for providing a multitude of scalable, reliable, and high-performance persistent-state virtual worlds across a common infrastructure in the context of real-time control, multi-user gaming, simulation, collaborative engineering, and entertainment and e-commerce applications.

### SUMMARY OF THE INVENTION

The present invention is directed to a system, method and computer program product for a computing grid for massively Multiplayer on-line games and simulations that substantially obviates one or more of the problems and disadvantages of the related art.

Accordingly, in one aspect of the present invention there is provided a method of managing a collaborative process including defining a plurality of locales on a plurality of servers, creating a plurality of objects corresponding to players in the plurality of locales, and mediating object state of the objects between the locales in a seamless manner so that the locales form a seamless world.

In another aspect there is provided a method of distributing object state across a plurality of hosts including initiating a plurality of server processes on the multiple hosts; defining a plurality of objects whose object state is maintained by a corresponding server process; and mediating exchanges of object state information between the plurality of objects such that the plurality of objects perceive a seamless world formed by the server processes residing on multiple hosts.

In another aspect there is provided a method of distributing object state across server process boundaries including initiating a plurality of server processes; defining a plurality of objects whose object state is maintained by a corresponding server process; initiating a message sink for the object state on a first server process; and creating a message source for the object state on the second server process such that the message source transmits the object state of objects on the first server process to objects on the second server process.

In another aspect there is provided a method of distributing object state across server process boundaries including initiating a plurality of server processes; defining a plurality of objects whose object state is maintained by a corresponding server process; marshalling the object state on a first server process using a Network Protocol Stack (NPS) and at least one NPS packet; transmitting the object state across a process boundary to a second server process; and de-marshalling the object state on the second server.

In another aspect there is provided a method of managing a collaborative process including defining a plurality of objects on a plurality of servers, each server having a Network Protocol Stack; exchanging information about state of the objects between the servers using their Network Protocol Stacks, wherein, during the exchanging step, reliable packets and unreliable packets are exchanged such that only dropped reliable packets are resent upon notification from a corresponding Network Protocol Stack to a sender of a dropped packet.

In another aspect there is provided a method of managing a collaborative process including initiating a plurality of server processes; initiating at least one gateway connected to the plurality of server processes; directing data from a user to a server process by performing a discovery process to match the user to the server process; and dynamically redirecting the data from the user to another server process when a user moves from one server process to the another server process.

In another aspect there is provided a method of distributing object state across locale boundaries including initiating a plurality of locale threads; defining a plurality of objects whose object state is maintained in the locale threads; changing the object state of at least one object in a first locale; proxying marshaled data representing the changed object state through a proxy sentinel at the first locale to its corresponding stub sentinel at a second locale; distributing the marshaled data through the stub sentinel to a receiving object at the second locale.

In another aspect there is provided a method of effecting a distributed secure transaction including receiving a proposal for a transaction from a first user; verifying that the proposal is genuine; securing the proposal against tampering with a first password known only to the first user and the server; embedding the sealed proposal in a secure message, the secure message being sealed with a second password known only a second user; transmitting the secure message to a second user; receiving the secure message from the second user, wherein the authenticity of the secure message has been verified, and the secure message has been countersigned by the second user; verifying that the secure message has been properly countersigned; and executing the transaction.

Further features and advantages of the invention as well as the structure and operation of various embodiments of the present invention are described in detail below with reference to the accompanying drawings.

### BRIEF DESCRIPTION OF THE DRAWINGS/FIGS.

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram representing a system architecture of an embodiment of the present invention, showing connectivity among the parts.

FIG. 2 is a block diagram representing the system architecture of an embodiment of the present invention, highlighting the communications flow of the present invention.

FIG. 3 is a block diagram representing an architecture of an orientationally-aware peripheral (OAP) device according to an embodiment of the present invention.

FIG. 4 shows an overall architecture of an operational environment, or “Grid,” and the relationship of the hardware within the Grid.

FIG. 5 illustrates various components of the Grid.

FIG. 6 shows one embodiment of hardware use to embody the Grid.

FIG. 7 is an abstract representation of the Grid.

FIG. 8 illustrates a relationship among tables of the database of FIG. 4.

FIG. 9 illustrates a context agnostic aspect of the Grid.

FIG. 10 illustrates a palette of state choices available to a game designer.

FIG. 11 illustrates an authentication packet used for logging into the Grid.

FIG. 12 illustrates a response packet sent in response to the packet of FIG. 11.

FIG. 13 illustrates a one-way hash encrypted packet.

FIG. 14 illustrates a process of logging into the Grid.

FIG. 15 illustrates dynamic routing of packets by a Gateway to multiple Game Servers.

FIG. 16 illustrates in tabular form attributed relationships between identities, accounts, avatars, and games.

FIG. 17 illustrates an Identity request process.

FIG. 18 illustrates an Avatar instantiation process.

FIG. 19 illustrates instant messaging packets.

FIG. 20 illustrates a message secure packet type.

FIG. 21 illustrates an example of a Locale topology.

FIG. 22 illustrates intelligent Locale design.

FIG. 23 illustrates multiple Game Servers running multiple Locales.

FIG. 24 illustrates an example of a packet used for moving Embodiments of Record between Locales.

FIG. 25 illustrates movement across inter-server and intra-server boundaries for Embodiments of Record.

FIG. 26 illustrates a taxonomy of object classification in a game.

FIG. 27 illustrates a taxonomy of a packet.

FIG. 28 illustrates a packet header.

FIG. 29A illustrates how players and sentinels interact across Locale boundaries.

FIG. 29B illustrates Network Protocol Stack transmission protocol.

FIG. 30 illustrates a heartbeat packet beat speeding up after an interval of inactivity.

FIG. 31 shows a case of two unreliable packets being sent followed by two reliable packets.

FIG. 32 illustrates packet transmission from a receiver's perspective.

FIG. 33 illustrates a dropped heartbeat.

FIG. 34 illustrates a receiver protocol for receiving packets from clients.

FIG. 35 illustrates a scenario of a lost heartbeat packet in addition to lost reliable packets.

FIG. 36 shows an example of a UDP packet used in one embodiment of the present invention.

FIG. 37 shows a method of determining when packets have been lost in transit.

FIG. 38 is a flowchart illustrating operation of a Network Protocol Stack.

FIG. 39 shows a payload of packets used in the Network Protocol Stack.

FIG. 40 shows how values are passed as data sub-blocks.

FIGS. 41 and 42 illustrate additional details of the Network Protocol Stack packets.

FIG. 43 shows an example of a game object.

FIG. 44 shows a conceptual timeline for a dead reckoning model.

FIG. 45 illustrates terminology used in defining regions of interest of objects.

FIG. 46 shows interaction of objects located in different Locales, and different servers.

FIG. 47 is an alternative representation of FIG. 46.

FIG. 48 shows dynamic interaction between two players located in different Locales.

FIG. 49 illustrates a process of movement by a Thing in a game.

FIG. 50 illustrates transfer of Embodiment of Record between borders of locales.

FIG. 51 illustrates event multiplexing in a Dead Reckoning model.

FIG. 52 illustrates an aspect of area of interest management.

FIG. 53 illustrates a python sub-block type.

FIG. 54 shows a client receiving a secure request for a transaction.

FIG. 55 shows a packet used for a Daemon Controller.

FIG. 57 shows a finite state machine used by a Daemon Controller.

FIG. 58 is a flowchart depicting an embodiment of operation and control low of the multi-user bridging system of the present invention.

FIG. 59 is a block diagram of an exemplary computer system useful for implementing the present invention.

### DETAILED DESCRIPTION OF THE INVENTION

Reference will now be made in detail to the preferred embodiments of the present invention, examples of which are illustrated in the accompanying drawings.

### Table of Contents

I. Overview

II. Example System Architecture

III. Communications Flow

IV. Location Awareness

V. Application Database

A. Database

B. Grid Schema

C. Things

D. States

E. State Definitions

F. State Lists

VI. Software Architecture

A. General Considerations

B. X2Y Software Framework

1. Gateway

a. Client Authentication and the Login Thread

b. Active Sessions and Session Management

c. Game Avatar Selection

d. Embodiments and Session Bindings

e. Validation, Filtering and Packet Routing

f. Instant Messaging

g. Secure Messages and Distributed Transactions

h. Handling Denial-of-Service Attacks

2. Game Server

a. Initializing Locales

b. Embodiments of Record

c. Propagating State

d. Server Things

3. The Network Protocol Stack

a. Principles of Operation

b. The Packet Header

c. Packet Payloads

d. Block Formatting

e. Game Buffers and the NPS Game List

4. The Object state Propagation Subsystem

a. Marshalling Object State

b. Passing Values as Data Sub-Blocks

c. Passing References in Packets

5. The State Aggregation Subsystem

6. Rules Enforcement Engine

7. Dead Reckoning System

8. Area of Interest Management

9. Instant Messaging and Clients

a. Instant Messaging and Rules Enforcement

b. Python packets

c. Creating Python Scripts

d. Secure Requests, Dialogs, and Transactions

10. Session Management Subsystem

11. Daemon Controller

a. Enthralling Active Objects

b. Demultiplexing Daemon Packets

c. Daemon Events

d. NPC Logic

VII. Example System Operation

A. Gaming Example

B. Alternate Embodiments

VIII. Simultaneous Display Across Various Client Devices

A. Front-End Client Tier

B. Middle Tier

C. The Back-End Tier

IX. Environment

X. Conclusion

I. Overview

In embodiments of the present invention, the concept of object state, or simply “state” can be utilized to facilitate collaborative environments. State, as used herein, is an abstract quantity (or quality) that may include spatial, temporal, physical, or logical states. The states are aggregated, mediated, processed, and propagated based upon the values of these states and/or rules applied to these states into a shared, virtual environment. Note that the term “object state” does not refer to objects in the sense of object oriented programming, but refers to objects that represent entities (e.g., people, animals, castles, buildings, etc.).

The system of the present invention includes an application database that stores state information about the users, objects, and entities participating in the interactive, multi-user application. This state information includes both intrinsic values associated with the objects and environments, and also information about the types of client devices owned by each of the plurality of users. The system of the present invention also includes one or more Game Servers, each connected to the application database, for executing the interactive, multi-user applications of the system of the present invention. One or more Gateways, each connected to one of the Game Servers, are also included in the system of the present invention for supporting connections from the various types of client devices. The system further includes one or more transportation networks, each connected to one of the Gateways, for facilitating communications between the Gateways and the type of client devices supported by each of the Gateways. The term client device, as used here, includes both communication devices used by users, as well as devices that can input data into the environment in real time, but which need not be controlled or used by a user. As an example, a temperature sensor could communicate this a translator, which would communicate to the server to update the state of the object associated with that temperature. In one embodiment, the system also includes an orientationally-aware peripheral device within the client devices for tracking the locating and orientation of users within the system of the present invention.

The system of the present invention also includes a distributed software architecture to connect all client devices and servers to form a bridge between the real world and virtual environments or for extensibility, reliability, scalability and performance optimization.

The method and computer program product involve users registering with an application service provider (ASP) providing the system as described herein. This registration involves receiving a request for presence within the interactive, multi-user application from a first user and a second user. The method then establishes a presence within the application. That is, a computer-generated synthetic representation appropriate to the user's context is created for the first and second users within the application. Next, the system stores in the application database state information about one or more devices that the first user and the second user can use to gain access to the application. Each of the users, as part of the registration process, may also receive software updates of a multi-tier software framework, appropriate for their client device types, in order to facilitate messages and other interactions between them and the rest of the system (i.e., translators, servers, and application database).

The system, method and computer program product of the present invention accounts for both the physical and virtual location and context of the participating devices and people. The system, method and computer program product also provide for both synchronous and asynchronous communications between people, computers, other devices and computers for the purpose of coordinating activities in the real (i.e., physical) and virtual worlds.

One feature of the present invention is that it can combine both real (non-virtual) and virtual environments while facilitating user interaction.

Another feature of the present invention is that it allows “X2Y” communications and commerce, where X and Y can be any device, person or organization. That is, universal access to the shared environment is allowed via any device to which a client can be provided (e.g., mobile phones, video game consoles, personal computers, personal digital assistants (PDAs), retinal projection displays, ear pieces, etc.). This offers an advantage over previous Internet application offerings.

Another feature of the present invention is that, aside from personal computers, workstations and terminals connected to the Internet, it allows mobile phones, wireless data devices, PDAs and the like, which are commonly owned by today's consumers, to represent opportunities to where users can participate in multi-person, interactive applications.

Another feature of the present invention is that users' locations can be geographically tracked, via a Global Positioning Satellite (GPS) system, cell-based triangulation, dead-reckoning (i.e., inertial tracking) or the like as described herein, in order to provide more realistic content, more realistic interactive experience to users, or data which is more contextually relevant to the user.

The present invention is a distributed, platform-sensitive, location-based, contextual system, method and computer program product for bridging activities in real and virtual environments within the context of multi-user gaming, entertainment, simulation, collaborative, and e-commerce applications. In aggregate, it is referred to as the “Grid.”

An application service provider (ASP), using the present invention, would utilize an infrastructure of hardware components connected over wireless networks and the Internet, and an infrastructure of telemetry, metering, monitoring, remote control, signaling and visualization software to create immersive, compelling and ubiquitous interactive, multi-user applications for business, government and consumer markets. The present invention takes advantage of low-cost, mass-marketed electronic devices, public networks and readily available spectrum space to create new, powerful capabilities that have not previously been envisioned or deployed. That is, the ASP may utilize a combination of centralized data-processing capabilities, software, personal computers, laptops, workstations, and autonomous agents on mobile devices to create scenarios that bridge mobile and remote users of the service with contextually relevant interfaces.

In one particular embodiment of the present invention, an organization provides a server (or collection of servers) accessible via a Web site, that facilitates an interactive, multi-user shared environment application. That is, an ASP allows access, perhaps on a subscription or per-use basis, to a multi-user bridging tool via the global Internet. The ASP would provide the hardware (e.g., servers) and software (e.g., database) infrastructure, application software, content files, customer support, and billing mechanism to offer users (i.e., players) a new set of services and applications that bridge real-life (“physical”) entities, features, spaces and events with computer-generated (“synthetic”) environments, logic and processes based on relative position, motion and (real or virtual) orientation. Thus, the system of the present invention allows all entities to have a unique identity and stores synthetic entities in the same manner as physical entities.

In an embodiment of the present invention, an ASP may provide users with access to the multi-user bridging tool of the present invention and charge on a subscription or per-use basis.

In an alternate embodiment of the present invention, the multi-user bridging tool of the present invention, instead of being accessed via the global Internet, would run locally on proprietary equipment and be networked among the local or wide area network (e.g., over an Ethernet, intranet, or extranet) of an entity allowing multiple users (e.g., employees of a single company that owns proprietary equipment) to access and use the multi-user bridging tool of the present invention.

In an alternate embodiment of the present invention, each user device provides some or all of the functionality of the components of the multi-user bridging tool of the present invention as described herein. Such devices, as will be apparent to one skilled in the relevant art(s) after reading the description herein, would allow for distributed implementations of the present invention.

In an alternate embodiment of the present invention, the client devices provide some or all of the functionality of the components of the content experience management tool as described herein. In such an alternate embodiment, the client devices would maintain connectivity with a centrally-managed, multi-user bridging tool or alternatively the devices would share data, as described herein, among multiple devices (i.e., a “peer-to-peer” model).

The present invention is primarily described in terms of a gaming example. This is for convenience only and is not intended to limit the application of the present invention. After reading the following description, it will be apparent to one skilled in the relevant art(s) how to implement the following invention in alternative embodiments (e.g., multi-user interactive applications focused on entertainment, simulations, project management, e-commerce, collaborative engineering, etc.). For example, in an alternate embodiment, a computer-aided design (CAD) application program executes within the Grid while maintaining referential integrity between a real life (physical) environment (e.g., a field engineer) and a computer-generated (synthetic) environment (e.g., a remotely-located designer using a CAD program). This allows the creation of synthetic models based on physically-derived (or observed) data, the maintenance and enhancement of synthetic models as change occurs in the physical world, and most importantly, the real-time interaction between physical and synthetic entities (e.g., persons).

The term “event” shall refer to an occurrence in the real world (i.e., physical world), and the term “signal” shall refer to an occurrence or user stimulation that occurs in or originates from the virtual or synthetic world (e.g., from an interactive, multi-person application).

The term “gaming” shall refer to any activity performed by a user on a client device which provides some entertainment value. Such activity ranges from participating in a synthetic environment with structured rules and roles, to simply forwarding a content file to another for entertainment purposes.

The term “entity” shall refer to a physical user or any part of an synthetic environment that can be manipulated within an environment.

The terms “user,” “person,” “player,” “participant” and the plural form of these terms are used interchangeably to refer to those who would access, use, or benefit from the present invention.

In this description, the “host computer,” or simply “host”, refers to a physical machine on which a process, or multiple processes, is running. Each such process has a memory space, and possibly includes threads, which are sub-elements of the process. The threads run concurrently, and all share the same process memory space.

A Gateway Server (hereafter usually referred to as “Gateway”), a Hosting Environment (a “Game Server” in the case of a gaming application, an “Application Server” in more generic contexts, a “Collaborative Engineering Environment Server” in other contexts, or a “Context Server” if the application were to be thought of as a “context”), and a Daemon Controller (all discussed in detail below) are examples of processes, each of which may be multi-threaded, and each of which runs on a physical host. These processes, which collectively comprise a single application (e.g., a game) or multiple applications, may run on a single host, or may be distributed across multiple hosts. The discussion below is primarily framed in terms of game applications for convenience, and thus typically refers to “Game Servers”, but the invention is equally applicable to any number of distributed environments. Each of these processes may also be replicated across multiple hosts. Collectively, Game Servers, Daemon Controllers and Gateways may be referred to as “Process Servers.” It will be appreciated that collectively, Context Servers, Daemon Controllers and Gateways perform the function of a distributed operating system.

A Game Server has at least one, but frequently multiple Locale Threads. Each Locale Thread, or simply “Locale,” is part of the Game Server. Some of the Locale Threads accept messages, and some of the Locale Threads transmit messages. Thus, a Game Server is in a sense a superset of Locale Threads plus other maintenance activity needed to permit the Locale Threads and the objects within them to interact. The Game Server supports as many Locale Threads as there is memory and other resources allocated to it. The Locale Threads are bound to the Game Server in a dynamic fashion. For example, one Game Server can drop Locale Threads, or it may dynamically move them to another Game Server. An actual game includes at least one Locale, and possibly many Locales, where all the Locales together form a seamless “game world”, or simply “world”.

II. Example System Architecture

The Grid is a collection of hosts that decouples semantic and syntactic context in a packet that is exchanged between clients (and that relates to the game itself) from information that is in some sense “essential” to the Grid itself. In other words, the Grid can mediate the state of the object(s) without knowing what the states actually means. The Grid thus becomes a host for the context of the application (i.e., game) while being agnostic about the context itself.

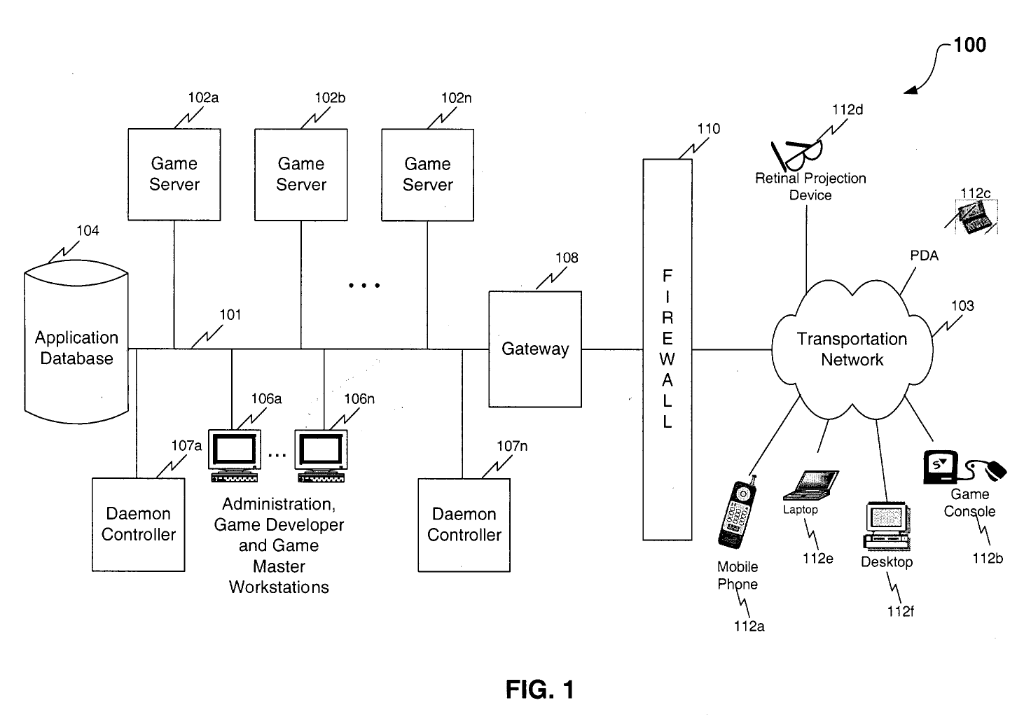

FIG. 1 shows a block diagram illustrating the physical architecture of a Grid system 100, according to an embodiment of the present invention. FIG. 1 also shows connectivity among the various components of Grid system 100. It should be understood that the particular Grid system 100 in FIG. 1 (i.e., a Grid system for an interactive, multi-player gaming application) is shown for illustrative purposes only and does not limit the invention. Other implementations for performing the functions described herein will be apparent to persons skilled in the relevant art(s) based on the teachings contained herein, and the invention is directed to such other implementations.

As will be apparent to one skilled in the relevant art(s), all of the components “inside” Grid system 100 are connected and communicate via a communication medium such as a local area network (LAN) or a wide area network (WAN) 101.

Grid system 100 includes a plurality of application servers 102 (shown as servers 102a-102n) that serve as the “middle-tier” (i.e., processing system) of the present invention. Servers 102, as explained in detail below, include the independent software components (e.g., rules enforcement, scripting, and state update subsystems) that implements the multi-user shared operation of Grid system 100. While a plurality of separate servers are shown in FIG. 1, it will be apparent to one skilled in the relevant art(s) that the Grid system 100 may utilize one or more servers in a distributed fashion (or possibly mirrored for fault tolerance) connected via LAN 101 or the Internet.

Also connected to LAN 101 is an application database 104. This database 104, as explained in more detail below, stores information related to the players utilizing Grid system 100 and information related to the state of the objects in the system. Such information includes player registration, permission, ownership, and location information, as well as game environments and rules.

Grid system 100 also includes a plurality of administrative workstations 106 (shown as workstations 106a-106n) that may be used by the Grid organization to update, maintain, monitor, and log statistics related to servers 102 and Multi-User Bridging system 100 in general. Also, administrative workstations 106 may be used “off-line” by ASP personnel in order to enter configuration data and gaming rules, as described below, in order to customize Grid system 100 performance.

Grid system 100 also includes a translator 108 (a type of Gateway) which acts as the interface between the servers 102 and the external (i.e., outside of the ASP's infrastructure) devices. Consequently, translator 108 is connected to a firewall 110. Generally speaking, a firewall, which is well-known in the relevant art(s), is a dedicated Gateway machine with special security precaution software. It is typically used, for example, to service connections and protect a cluster of more loosely-administered machines hidden behind it from an external invasion. Thus, firewall 110 serves as the connection and separation between the LAN 101, which includes the plurality of network elements (i.e., elements 102-108) “inside” of LAN 101, and a transportation network 103 (e.g., the global Internet) “outside” of LAN 101.

Grid system 100 also includes a Daemon Controller 108 which acts as a privileged client for managing the activities of elements of the application not directly controlled by users, such as artificial intelligence or aspects of a simulation that run on their own internal logic and react to other aspects of the simulation.

Connected to the transportation network (e.g., global Internet 103), outside of the LAN 101, includes a plurality of external client devices 112 that allow users (i.e., players) to remotely access and use Grid system 100. External client devices 112 would include, for example, a mobile phone 112a, a video game console (with Internet connection) 112b, a personal digital assistant 112c, a personal area network with retinal projection displays and/or ear piece 112d; a laptop 112e, and a desktop computer 112f.

While only one Gateway 108 is shown in FIG. 1, it will be apparent to one skilled in the relevant art(s) that Grid system 100 may utilize one or more Gateways in a distributed fashion (or possibly mirrored for fault tolerance) connected via LAN 101. In such an embodiment, as will be apparent to one skilled in the relevant art(s) after reading the description herein, each Gateway 108 may be dedicated to, and support connections from, a specific type of external client device 112 using a different transportation network 103, or one gateway could support connections from multiple client devices capable of producing similar communications protocols.

For example, in one embodiment of the present invention, translator 108 may be a Web server which sends out Web pages in response to Hypertext Transfer Protocol (HTTP) requests from remote browsers (e.g., desktop computers 112f). The Web server would provide the “front end” to the users of the present invention. That is, the Web server would provide the graphical user interface (GUI) to users of Grid system 100 in the form of Web pages. Such users may access the Web server at the Multi-User Bridging organization's site via the transportation network 103 (e.g., the Internet and thus, the World Wide Web).

Lastly, while one database 104 is shown in FIG. 1 for ease of explanation, it will be apparent to one skilled in the relevant art(s) that Grid system 100 may utilize databases physically located on one or more computers which may or may not be the same as any of servers 102.

More detailed descriptions of Grid system 100 components, as well as their functionality, are provided below.

III. Communications Flow

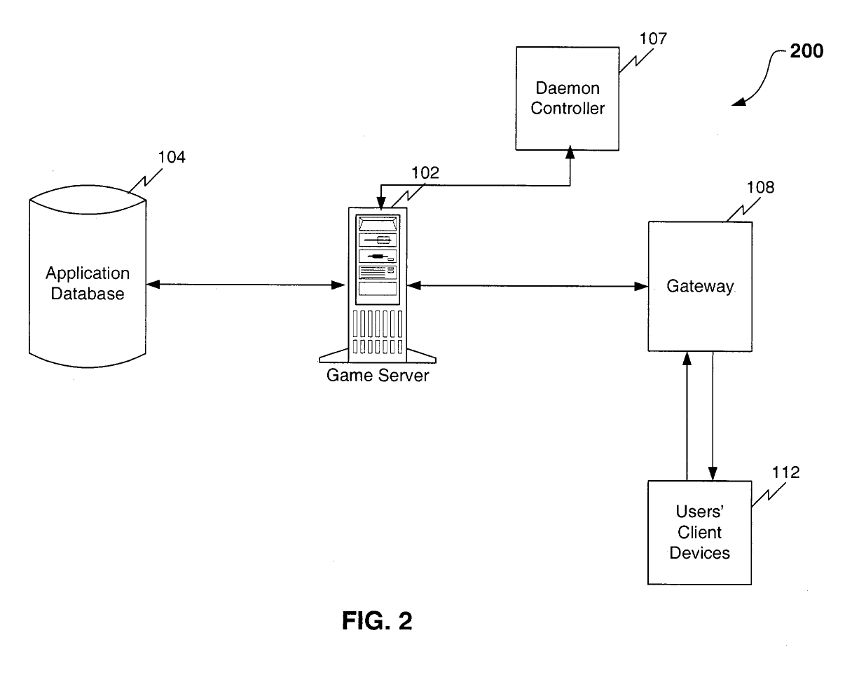

Referring to FIG. 2, a block diagram 200 further illustrating the physical architecture 100 according to an embodiment of Grid system 100 is shown. More specifically, FIG. 2 illustrates a more simplified version of Grid system 100 than that shown in FIG. 1 in order to highlight the communications flow of the present invention.

During operation of an instance of an interactive, multi-player game executing within Grid system 100, translator 108 acts as the interface between the players' client devices 112 (through transportation network 103 that is not shown in FIG. 2). That is, translator 108 facilitates communications between at least one of the servers 102 and the plurality of different client devices 112. Thus, translator 108 is responsible for translating (and thus bridging) between the game's signals and physical events into the protocol(s) being used by client devices 112 in order to communicate player movements, game rules, scene changes, player status, audio content, video displays, game score data, etc. Such player movements, scene changes, player status, audio content, video displays, etc. would be dictated by and/or stored in application database 104 in communication with servers 102.

As will be apparent to one skilled in the art(s) after reading the description herein, one or more translator(s) 108 would be needed to handle devices and software that do not natively communicate via (proprietary) protocols over TCP/IP. These include both existing first generation (1G) wireless data protocols such as Wireless Access Protocol (WAP), Cellular Digital Packet Data (CDPD) and Mobitex, as well as current generation technologies and standards (2.5G and 3G) such as General Packet Radio Service (GPRS), Enhanced Data rates for Global Evolution (EDGE), Universal Mobile Telecommunications System (UTMS), WiFi and Bluetooth. Translators are also needed for, Internet protocols such as Simple Mail Transfer Protocol (SMTP), HyperText Transfer Protocol (HTTP), Simple Object Access Protocol (SOAP), Jini, Instant Messaging (IM), etc., in order for servers 102 to communicate (via the appropriate protocol transportation network 103) with the different types of client devices 112 (e.g., mobile phones, video game consoles, personal data assistants, ear-pieces, retinal projection display devices, etc.) and for clients 112 to communicate in a P2P fashion within Grid system 100. IV. Location Awareness

Latitude, longitude and other sets of location data are often integral to the applications executed within Grid system 100. Such location awareness allows software agents to traverse physical terrains and physical entities such as people, buildings and vehicles to be represented in virtual worlds. Therefore, in addition to existing systems such as GPS and the like, inertial tracking can be used to track the location and orientation of players within system 100.

In an embodiment of the present invention, an orientationally-aware peripheral (OAP) device, described in detail below, may be included within Grid system 100 within each client device 112.

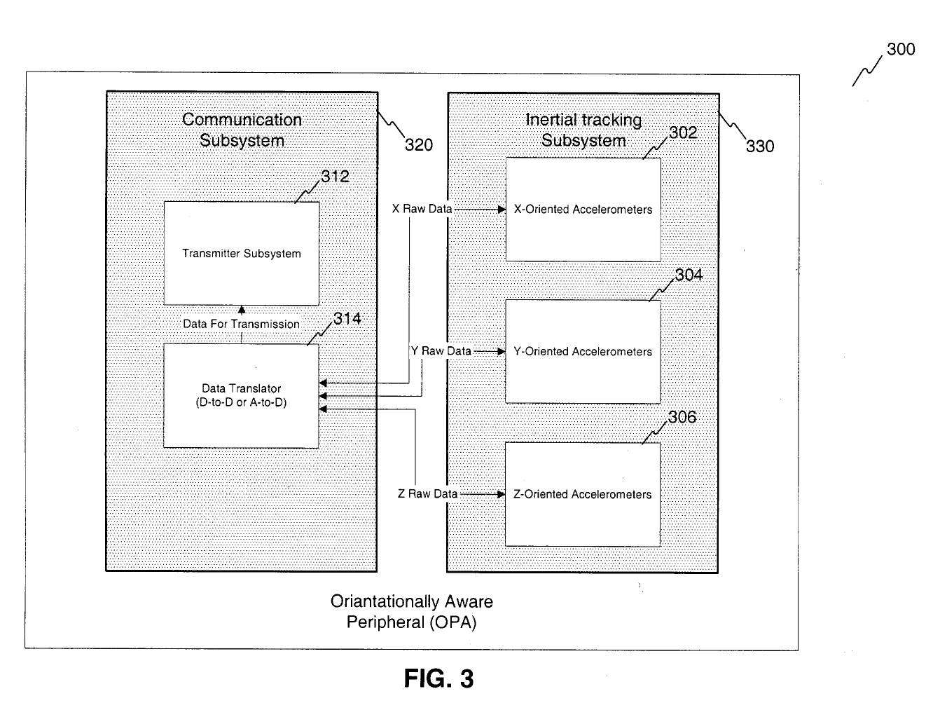

Referring to FIG. 3, a block diagram representing the architecture of an orientationally-aware peripheral (OAP) device 300 according to an embodiment of the present invention is shown. OAP device 300 includes an inertial tracking subsystem 330 and a communication subsystem 320. Inertial tracking subsystem 330 employs six accelerometers that will track the placement and orientation of the peripheral device in six degrees of freedom (“6-DOF”). Such a design eliminates the need for separate gyroscopic sensors to determine orientation information. The six accelerometers are divided into three groups of two sensors each (i.e., accelerometers pairs 302, 304 and 306) oriented along each of three perpendicular axes. Each pair of accelerometers is separated as far as is possible on the platform. By correctly integrating the acceleration of all six sensors, both position and angular orientation can easily be calculated.

The above-described arrangement of accelerometers allows for the simple orientation and integration of the OAP device 300 in the client device 112, but should not be taken as a limitation of the invention. That is, other possible arrangements exist for locating a client device (and thus, a player), as will be apparent to persons skilled in the relevant art(s) based on the teachings contained herein, and the invention is directed to such other implementations.

For example, in an alternate embodiment, the six accelerometers are placed along the vertices of a triangular pyramid. Such an embodiment would either be a closed- or open-pyramid, with the six accelerometers along the vertices of the pyramid.

Inertial trackers tend to “drift” from the reference frame in time (via systematic- or bias-errors). These errors are cumulative. They are also subject to random errors (noise). Therefore, synchronization is important in ensuring OAP device 300 works in a wide range of environments. Synchronization would occur when OAP device 300 is brought to a known location and the system 100 is made aware of this fact. With OAP device 300 in a known location, its position can be reset, while expunging any current positional errors. Importantly, such synchronization can be brought into the narrative context of the game, making it an integral part of the action (as opposed to a distinct interruption).

For the pyramidal embodiment described above, synchronization can be performed by placing OAP device 300 at a known location and in a known orientation. Software code logic included in OAP device 300, in an embodiment, would assume that it is synchronized when OAP device 300 has not moved over a certain pre-selected time period.

Also, for certain applications offered by the ASP where accurate orientation is needed but positional data is not essential, it is possible that OAP device 300 could be self-synchronizing. That is, whenever the device is stationary for a pre-selected time period, a correction is applied so that the normal vector of the downward-facing face is aligned with the current gravitation vector. As long as the device is placed on a flat surface fairly often in a random orientation, these corrections will be often in every direction; the net affect of these corrections would be a continual synchronization.

As mentioned above, OAP device 300 also includes communication subsystem 320, where the output of the inertial tracker is received by a data translator 314 and communicated to other client devices 112 participating in the same instance of the multi-player, interactive game. One embodiment of the communication subsystem 320 would employ wireless communication protocols (such as Bluetooth, IEEE 802.11 or the like) to communicate with a nearby computer or base-station (and thus with translator 108) via a transmitter 312.

V. Application Database

Database 104 stores the various types of information that Grid system 100 would need to store in order to provide the bridging of activities in real and virtual environments in the context of multi-user gaming, entertainment and e-commerce applications. Such information, includes user registration information (name, address, billing information, etc.), device 112 registrations, device 112 capabilities (e.g., polygon rendering capability, media formats, operating systems, available peripherals, color versus black-and-white display, etc.), user permissions (e.g., who is allowed to access portions of the bridged environment and what actions they may perform on those parts) and user ownership of synthetic entities and environment objects, entity location information, game environments, game rules, themes and roles, etc., as will be apparent to one skilled in the relevant art(s) after reading the teachings herein.

In an embodiment of the present invention, application database 104 is implemented using a relational database product (e.g., Microsoft® Access, Microsoft® SQL Server, IBM® DB2®, ORACLE®, INGRES®, or the like). As is well known in the relevant art(s), relational databases allow the definition of data structures, storage and retrieval operations, and integrity constraints, where data and relations between them are organized in tables. Further, tables are a collection of records and each record in a table possesses the same fields.

In an alternate embodiment of the present invention, application database 104 is implemented using an object database product (e.g., Ode available from Bell Laboratories of Murray Hill, N.J., POET available from the POET Software Corporation of San Mateo, Calif., ObjectStore available from Object Design, Inc. of Burlington, Mass., and the like). As is well known in the relevant art(s), data in object databases are stored as objects and can be interpreted only using the methods specified by each data object's class.

As will be appreciated by one skilled in the relevant art(s), whether application database 104 is an object, relational, and/or even flat-files depends on the character of the data being stored by the ASP which, in turn, is driven by the specific interactive, multi-user applications being offered by the ASP. Server 102 includes specific code logic to assemble components from any combination of these database models and to build the required answer to a query. In any event, translator 108, client devices 112, and/or administration workstation 106 are unaware of how, where, or in what format such data is stored.

A. Database

Thus, at the center of every persistent-state, massively multi-player game lies its database 104. The database 104 manages the persistence of object state across the game world: from login to login, session to session, Avatar to Avatar, property to property, it keeps a record of all significant state changes. When a player picks up a sword, the database 104 must record this fact and store it, otherwise the next time that player logs in they will wonder where they lost it. When the player spends a gold coin, the database 104 must debit their virtual bank account, so that the online economy can function without embezzlement. The database 104 is the final authority on the state of the world at any given moment.

The Grid preferably relies on the well-proven technology of the relational database, though it is not bound tightly to any proprietary database implementation. The database 104 may be created in a variety of professional database platforms (including Oracle and DB2 instantiations). An important element to successful Grid game design is the database schema: a blueprint for the relations that govern the basic tabular data underlying its relational database 104.

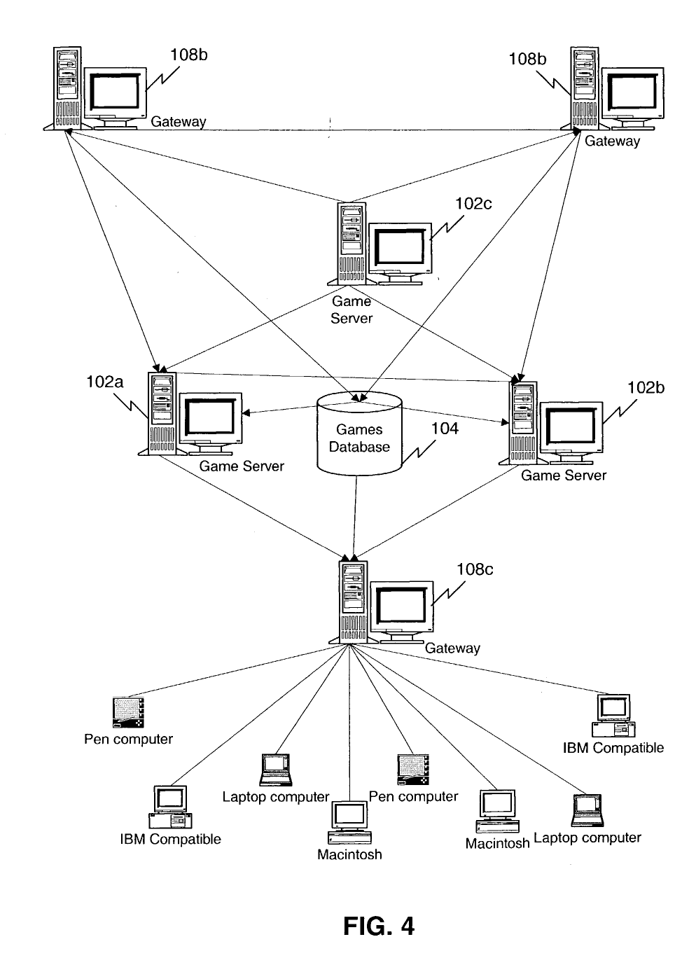

FIG. 4 represents the overall architecture of the Grid and the relationship of the various servers. As shown in FIG. 4, there are a number of Gateways 401a-401c (each a type of translator 108) through which users log into the Grid. The database 104 maintains track of the state of the game, the user logins, and the state of the objects playing the game. The Game Servers 405a, 405b, 405c (a type of server 102) are connected to the Gateway 401, and to the database 104. Each of the Game Servers 405 may have multiple Locale Threads (discussed in further detail below) running on it, as well as other processes (e.g., daemon processes, discussed in further detail below).

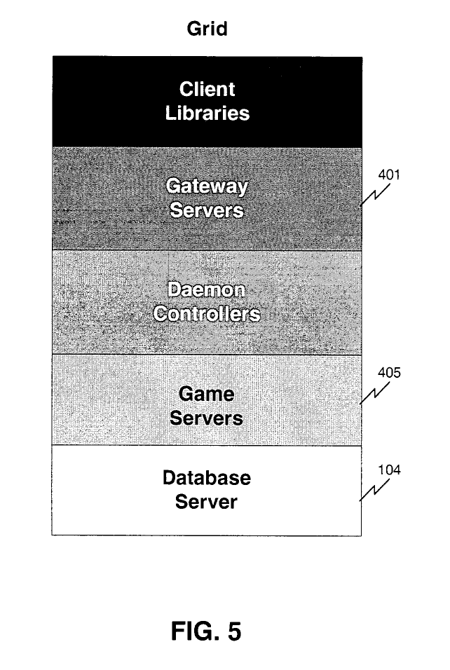

FIG. 5 illustrates the various components of the Grid, and shows a spectrum ranging from the back end (database servers 104), where the persistence storage resides, to a number of clients and client libraries at the top. Thus, as one moves upwards in the figure, there may be thousands of clients and client libraries, but only one database server 104.

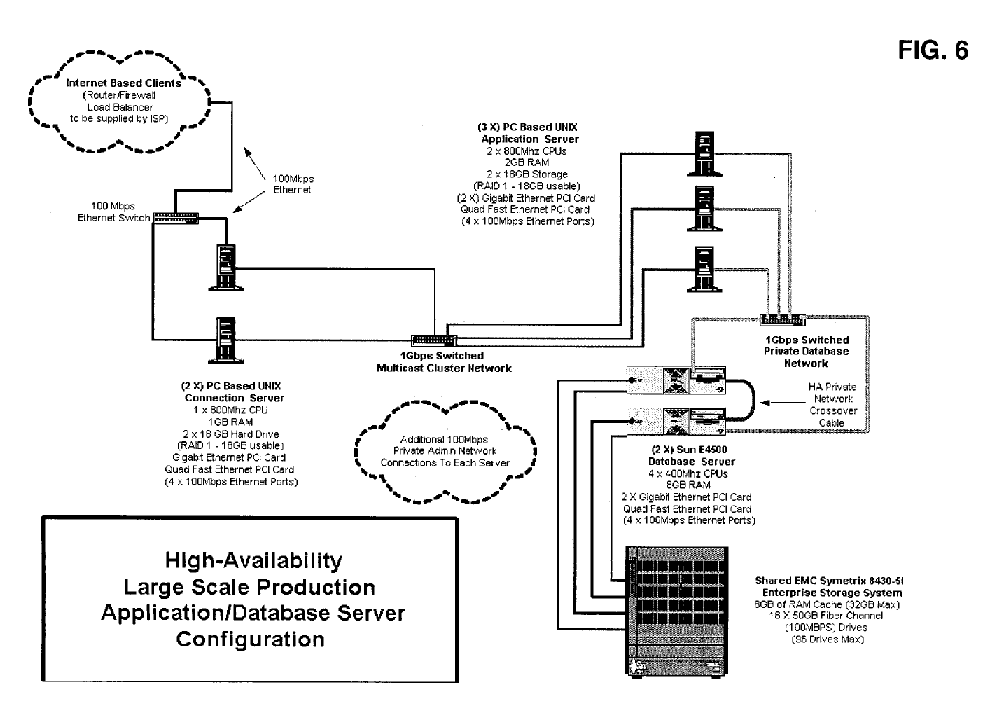

FIG. 6 is a diagram showing one particular embodiment of the hardware that may be used to embody the Grid, and the overall topology of the system. It will be appreciated that any number of hardware devices may be used, and the invention is not limited to the particular hardware illustrated in FIG. 6.

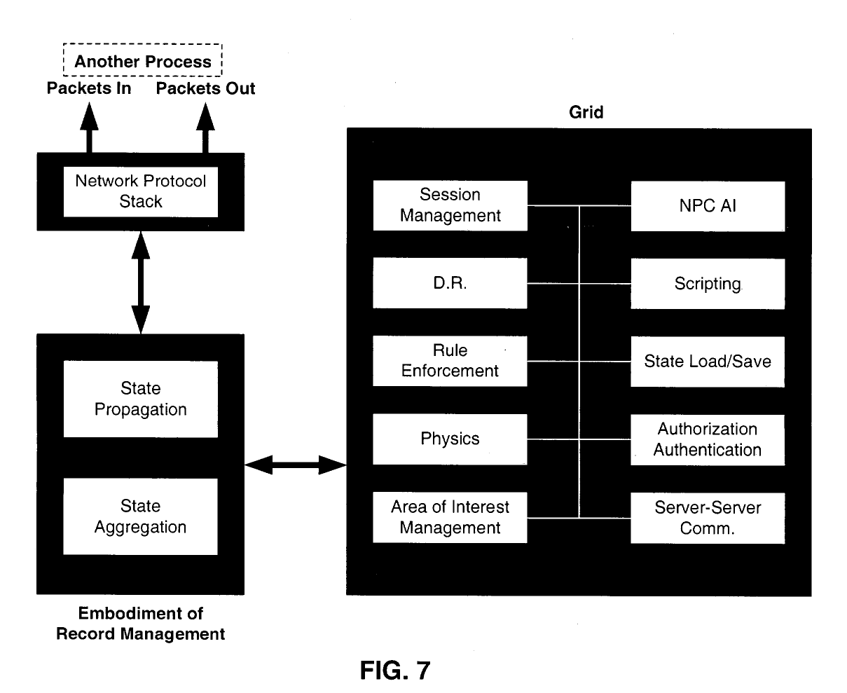

FIG. 7 is an abstract representation of the Grid. The “Grid” box on the right hand side of the figure represents all the various elements that are generally needed to play the game. On the left, the Network Protocol Stack (NPS, discussed further below) is a mediator for data that comes into the host, and data that goes out. Some of the packets coming into and out of the Network Protocol Stack are delivered to/from outside the Grid, for example, data exchanges with users. Other packets are exchanged within the Grid, and represent exchange of data/state information between elements and objects of the Grid. The State Propagation and State Aggregation blocks on the lower left represent the Embodiment of Record management, and function as an mediator between the Network Protocol Stack and the Game Servers 405 of the Grid.

B. Grid Schema

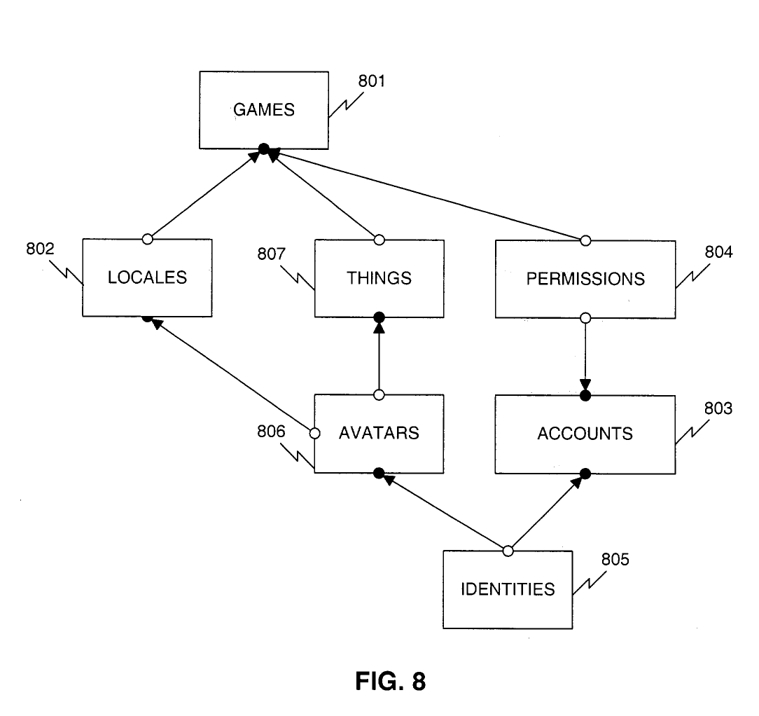

The Grid schema is divided into a variety of tables, each of which serves a particular purpose in defining what games are available to players with valid accounts, how those players are represented within the game, where they can go, and what they can do. An overview of the most important tables of database 104 follows, with the relationships among the major tables illustrated in FIG. 8:

a) Games 801—each game offered is named and numbered: the currently running version of the game is specified as well.

b) Locales 802—each geographical region of the game currently available to players is defined: the boundaries of the Locale 802 define when objects enter or leave each physical region.

c) Accounts 803—basic control information for logging in and out of the Grid: username and password information as well a uniquely generated public key to identify this account across the network.

d) Permissions 804—determines the scope of what an account is allowed to do, and what changes and account is authorized to make. Distinguishes daemon accounts from client accounts.

e) Identities 805—describes who the player can embody within each game: associates Accounts with Avatars 806.

f) Avatars 806—defines a role for the player within a specific game: associates a specific Thing representing the player with its most recent Locale 802.

g) Things 807—the basic description of an object in the game world. The Thing table distinguishes active objects from passive objects. Every Avatar 806 is a Thing 807, only some Things 807 are Avatars 806.

h) States (not shown in FIG. 8)—associated with each Thing 807, states embody actual persistent game properties.

i) State Templates (not shown in FIG. 8)—not associated with any actual Thing 807, state templates define which types of Thing 807 may possess which actual persistent properties. Associates States with State Definitions.

j) State Definitions (not shown in FIG. 8)—virtual definitions for each potential actual state: includes validation information, range limits, and default values for each State Template.

k) Sentinels (not shown FIG. 8)—special entities that patrol Locale 802 boundaries. Sentinels are responsible for forwarding object state information from one Locale 802 to another Locale 802.

l) Requests (not shown in FIG. 8)—a system-maintained list of outstanding, unsatisfied secure transactions. Each Request record has a limited lifespan.

C. Things

Each object in every game has an entry in the Thing table. The Thing table controls the behavior of objects across the Grid, and maintains their common basic states: position, orientation, range, presence, region of interest type, whether they are active or passive in nature. It includes definitions for the following properties:

a) Globally Unique ID (GUID)—a game specific identifier that distinguishes one particular object from another. Two blue whales may exist in the same game, but their Things will have different GUIDs.

b) Object Types—a game specific identifier that distinguishes one class of objects from another. Two blue whales may have the same object type, even if they possess different GUIDs.

c) Deleted Date—a marker that flags an object as having been “removed” from the game world. If this entry is NULL then the object is currently in existence.

d) Position—where this object is located in the game world. Also provided are Velocity and Acceleration for rectilinear motion.

e) Orientation—which way this object is pointed in the game world. Also provided are Angular Velocity and Angular Acceleration.

f) Range—how far this object can “see” or the extent of its region of interest.

g) Presence—how far this objects “extends” in space for collision detection.

h) Region Type—normal regions of interest are spherical, but more specialized boundary definitions are also possible.

i) Active vs. Passive Flag—whether this Thing responds to stimuli (determines which objects act as a packet sink for state messages).

D. States

When designing a networked game (or collaborative environment), it is usually necessary to define the states (or properties) that are initialized, modified, distributed and saved as part of game play. However, since the Grid is context agnostic (further discussed below), these object states must be represented abstractly, so that the Game Servers 405 can initialize, modify, distribute and save these properties without knowing directly what element they represent within the game world. Just as state marshalling (discussed below) allows an object state to be transmitted abstractly, the state tables in the database 104 allow properties to be stored abstractly and manipulated with standard methods for all game instances.

By way of example, suppose a client is logged into game #44, which is known by its name “Bootleggers”. This example game pits whisky smugglers against the F.B.I in a massive smuggling operation during Prohibition. The player's Avatar (represented by a Thing of type 1) is a character called “Sneaky666” and has the Globally Unique ID #666. In this game, each player starts out carrying $1,000 in bribe money around just in case they get stopped by the police.

Creating a new state for this character, the game designer assigns the number #257 to a property known to the game code as “bribe money” and gives it a type of PROPERTY_LONG (a long integer) and an initial value of 1000. The designer creates a state Template which associates every object of type 1 with the allowed state property #257.

When the Game Server 405 reads the database 104 for this Avatar, although the Game Server 405 does not know directly what property #257 represents, it can associate this property with Thing #666, set its type to long integer and initialize its value to 1000. Furthermore, using Grid packets (discussed below), it can serialize this information and marshal it out all players as a sub-block within a THING_NEW packet block. It is not required or necessary for the Game Server 405 to interpret the semantic meaning of the value 1000. As far as the Game Server 405 is concerned, the value might just as well represent 1000 elephants as $1,000. This process of systematic abstraction de-links the syntactic validation of each property from the semantic interpretation of that state, and is the mechanism that allows the Grid to remain game agnostic. In a broader sense (i.e., outside the game applications), game agnosticism may be referred to as “context agnosticism.”

In one particular implementation, position information is “hardwired” as being non-game-agnostic into the Grid, because in the game context, position information is usually of an “essential” nature and needs to be passed with minimal overhead, such that the Grid can resolve the conflicts/interference (see also discussion of Dead Reckoning below). However, other information, for example, bank account balance, may be “essential” in other context. Thus, position information is passed in a non-context agnostic manner, while other state information is passed in a context agnostic manner. Obviously, the “meaning” of “position” may be interpreted by the game itself in any manner it wants.

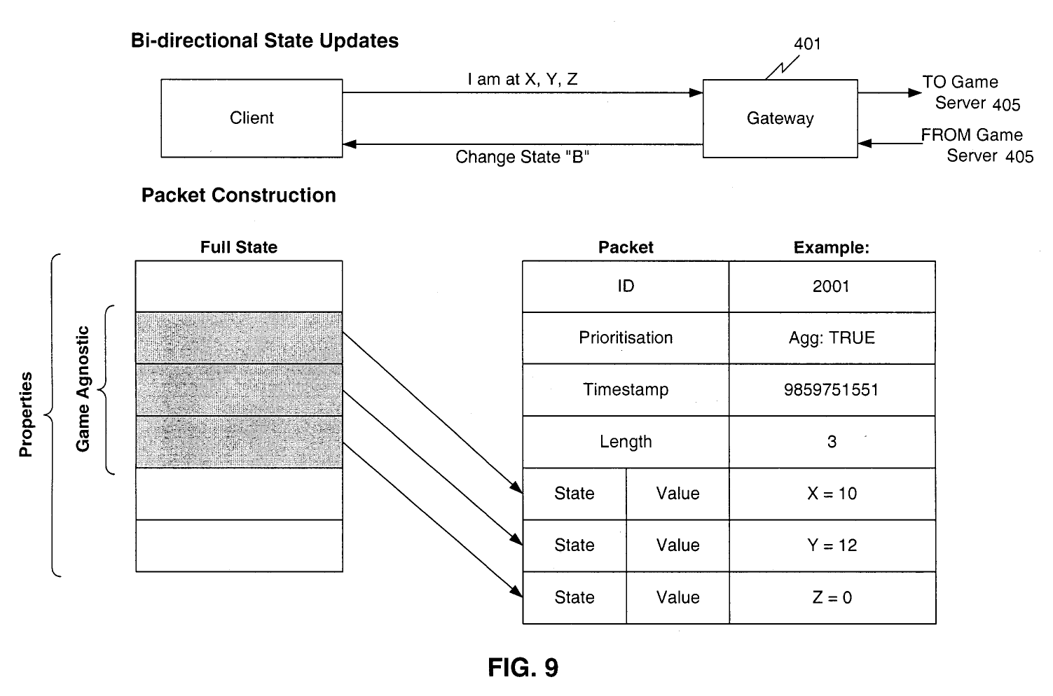

FIG. 9 is an illustration of the context agnostic aspect of the Grid. As shown in FIG. 9, top portion, the client updates its state by sending a signal to the Gateway 401 “I am at X, Y, Z”. The Gateway 401 responds with a “change state B” back to the client. The packet construction, illustrated in the bottom left of FIG. 9, has some properties of the full state that are context agnostic (shaded gray), and some that are not (shaded white). In this manner, information is “marshaled” from the client to the server (see discussion of marshaling state below). The context agnostic states are passed through the Gateway 401 and the Game Server 405 to the game itself, without regard to what exactly these values represent. Other information (e.g., position) is not context agnostic in this example, and is illustrated in white.

There is no requirement for the client itself to be context agnostic. When the client receives a THING_NEW message, it knows that property #257 represents the state “bribe money” and can display a graphical indication (e.g., a green bar chart) that this player is flush with cash.

In the same way, other object states can be abstractly represented:

A PROPERTY_FLOAT state could be a current percentage of blood alcohol.

A PROPERTY_VECTOR state could represent the direction in which a game character's gun is pointed.

A PROPERTY_ENUM state could hold the color of an Avatar's hat.

A PROPERTY_STRING state could hold the nickname of this player.

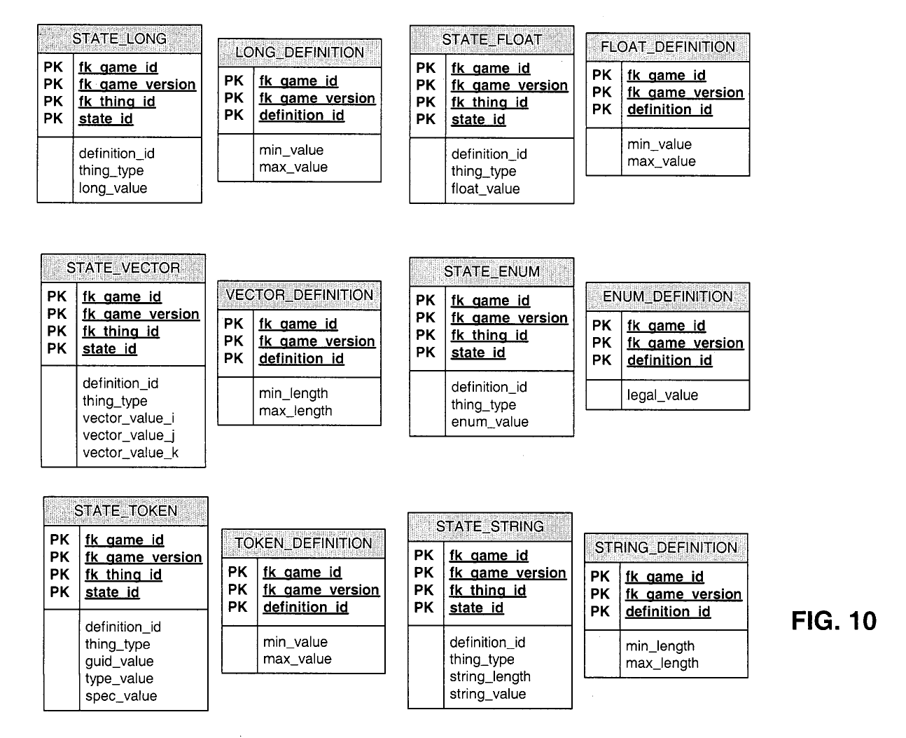

Some networked games, especially first-person shooters, may get by with only a handful of states, such as health, damage, and strength. Other, more strategic games, will require an extensive list of special powers, items, and abilities (the palette of choices available to the game designer is illustrated in FIG. 10).

E. State Definitions

Thus, the persistent state database 104 needs to represent a variety of state properties. It also needs to error check the values that are stored in order to keep them consistent with the rules of the game. For the Game Servers 405 to remain context agnostic, special procedures must be integrated with the database to perform these actions without excessive Game Server intervention:

a) Validation—values must remain of the correct type. A string value should not be placed in a vector field.

b) Range Checking—values should not become too big or too small. For example, the height of a character should never be negative.

c) Enumerated Types—legal values may be limited to a specific set of predefined choices. An example is a color that may be color #1 (RED), color #2 (GREEN) or color #3 (BLUE).

Associated with each State Template is a State Definition table that determines these special limitations for each game property. Without these definitions, the Game Server 405 would be unable to enforce the requirements for consistency upon the game world. Using the templates and definitions to filter good values from bad values, the Game Servers 405 can maintain database 104 integrity according to the requirements of the game designer.

F. State Lists

In addition to the individual state properties, game objects may require an associated set of states that has some larger sense of coherency. In this case, the properties provide support for lists of states, subject to the restriction that each individual list, when marshaled, may be no larger than the maximum packet size.

In general, this restriction allows for up to 64 individual elements per set that may be set, reset, and cleared individually. These list elements need not be indexed contiguously, in other words the list set may be sparse (i.e. indices 5, 7 and 9 may be set while all other index values are presumed to contain NULL).

The list types mimic their primitive element counterparts:

PROPERTY_LIST_LONG—a list of 32 bit integer values.

PROPERTY_LIST_FLOAT—a list of single precision IEEE floating point values.

PROPERTY_LIST_VECTOR—a list of single precision IEEE floating point types.

PROPERTY_LIST_ENUM—a list of 16 bit integer enumerated types.

PROPERTY_LIST_STRING—a list of UTF8 compatible variable length strings (aggregate length of all string data must not exceed MAXDATLEN).

PROPERTY_LIST_TOKEN—a list of TOKEN values (one 32 bit and two 32 bit data fields) useful for implementing inventory lists containing a GUID, Object Type, and Specification Type for each element in inventory.

VI. Software Architecture

A. General Considerations

In an embodiment of the present invention, servers 102 can be implemented using Intel® x86 or Pentium® hardware running Microsoft® Windows 2000 server platform or Linux, a Sun Ultra SPARC server running the Solaris operating system or any other server platform that can execute POSIX-compliant software. Servers 102 execute middle-tier software applications implemented in a high level programming language such as Java, C or the C++ programming languages. In an embodiment of the present invention, the software application communicates with database 104 using a Grid database handler implemented in C++, C or Java.

In an embodiment of the present invention, where transportation network 103 is the Internet and translator 108 is a Web sever, a secure GUI “front-end” for Multi-User Bridging system 100 is provided. The front-end may be implemented as a fully-rendered C++ environment, through a Web translator using the Active Server Pages (ASP), Visual BASIC (VB) script, and JavaScript server-side scripting environments that allow for the creation of dynamic Web pages, or through a translator to another client device.

A software framework for providing connectivity and maintaining referential integrity between physical and synthetic entities is crucial for Grid system 100 to support applications (e.g., interactive, multi-player games) that take advantage of external client devices 112 that are: (1) high-polygon-count hardware devices (e.g., game console 112b, etc.) to depict, navigate through, point at and interact with synthetic models of physical spaces and events; and (2) mobile, specialized devices for audio (e.g., MP3 player, etc.), video (e.g., digital video camera, videophone, etc.) and communications (e.g., mobile phone, PDAs, etc.).

B. Distributed Software Framework

This section provides a top-level overview of the software framework system.

To support on-line, multi-user shared environments, the system is conceptually divided into four main subsystems:

(1) Database 104

(2) Game Servers 405

(3) Gateways 401

(4) End-user Interfaces

While these components are treated as being physically separate, it is important to keep in mind that these are functional divisions, and (with the exception of the end-user device) this architecture makes no assumptions as to the division of physical machines. However, the architecture will scale well if these functional divisions are observed.

The database 104 provides persistence and constancy for all objects within an environment. It will also provide some state information which will be necessary for the operation of the application. The database 104 provides a place where objects are identified, stored, and instantiated. If also provides the front-end processing necessary to interface with the Process Servers.

Central to the operation of the database 104 is the concept of the object. An object is a “physical” item that is part of a shared environment. Along with generic data about the object (such as object type and attributes which are common to all objects of that type), the database 104 also captures data which are unique to a particular object's instantiating. Unique identifiers and descriptions are important in this context.

Because objects will be displayed different end-user platforms, each object may have a multiplicity of descriptions. What is appropriate for one platform may not be appropriate for another. For example, a geometric description of an object and associated texture maps may be required to display it on a high-resolution console platform. However, an SMS platform may require a simple textual description. Both describe the same object.

The database 104 will also store state information about a particular object. This will include all state information which is necessary to bring the object into the environment.

The Game Servers 405 provide many functions, including:

a) An interface to the object store which objects to be brought into the environment;

b) Communications between “peers,” i.e., end-users;

c) Computation and object manipulation in support of the application;

d) Aggregation and mediation of state information pertaining to the objects in the environment;

e) Application of rules pertaining to the objects and state of those objects within the environment; and

f) Distribution of control information.

In general terms, the Game Servers 405 is where the environment is manipulated, and the state information is processed. This state information is propagated to the end-users via the Gateways 401 (discussed below). The database 104 includes object descriptions, the end-user devices can perform rendering and provide a user an interface to the environment, but the Game Servers 405 are necessary to tie Things together into the context of the environment. It will interface with end-user devices in providing data streams necessary for participation. It will also interface with the database 104 both for the instantiating of objects (from the end-user perspective) and the updating of an objects state information when that state information changes as a result of changes to the internal environment or as a result of data entering the system from external sources. Positional state information (the location of objects within the environmental geometry) will be preferably tracked at the Game Server level.

The Gateway 401 provides an interface between the end-user device and other Game Servers 405. Note that in many cases this is not necessary; the Game Server 405 will work with generic UDP (User Datagram Protocol)/IP connections, and many client devices are capable of making and using these connections. In general, it is the lower-end platforms which will require a specialized version of the Gateway 401 to allow them to interoperate. A WAP phone, for example, needs two levels of translation to interoperate with network-connected devices: a WAP Gateway to translate its native protocol to TCP/IP, and a WML server to format requests and displays in a form which can be displayed by the device. Players can use their service provider's Gateway, but the WML requests may be translated into a more generic network protocol by which the process servers operate.

The Gateway 401 will only be necessary to provide service to devices that cannot make general UDP/IP connections. If such devices are to be supported in a given application, general design considerations typically necessitate placing this functionality in separate servers, and not trying to custom-code to each device API.

Users can use the system with a variety of end-user devices. These devices will be responsible for providing the users with an interface to the system, and to provide rendering which is applicable to the platform in question. For computer-based platforms (general-purpose computers and high-end console devices), three-dimensional, high-resolution rendering is required. Less powerful devices will require rendering that is consistent with their performance.

End-user devices will also be capable of passing general messages between one another. From the user's perspective this will be peer-to-peer, but in actuality the messages will be mediated by the Process Server.

1. Gateway

The function of the Gateway 401 is to act as a single point-of-entry to a section or region of the Grid. Since the Grid is protected behind a firewall, the Gateway 401 hides the internal structure of the game configuration from the clients outside the firewall. Gateway 401 interact with other system elements by sending and receiving information in marshaled form. Gateways 401 subscribe to the process of discovery that identifies other Gateways 401, other servers, and other related Grid resources. They dynamically redirect information, including telling the user to “go look at another Gateway”. The Gateway 401 identifies the Game Server 405 to which the user should be logged in, and then begins directing information to that Game Server 405 from the user and from the server to the user. Gateways 401 do not need to match users to users, they match users to Game Servers 405.

Many systems are built around the philosophy of the “trusted client”. In these systems, many of them on private networks or in a peer-to-peer configuration, assume that only valid or “vanilla” client software will be accessing the game and rely on the administrator to limit access to those players who exhibit goodwill by not cheating or otherwise causing system problems. In these games, it is not uncommon for players of an aggressive bent to program bots (automated game drivers) to bend or break the limitations embedded in the trusted client code as provided from the authorized developers.

The Grid, however, is a true multi-tiered client/server configuration that does not trust the client to enforce the rules in all cases, and, as such, the Gateways 401 provide the first defense against unscrupulous or crafty players whose goal is to bend or break the rules.

Clients are authenticated at the Gateway 401, their game session is managed at the Gateway 401, and their packets are validated and routed by the Gateway 401. In short, the Gateway 401 acts as a proxy for the client within the Grid.

a. Client Authentication and the Login Thread

Before the Gateway 401 agrees to host a session for any client, it first enforces a standard protocol for determining if the client is authentic. Every authentic client shares a password associated with that client's login name with the Gateway 401. But when the time comes for the client to prove that it knows the password, it would be insecure for a packet to be sent to the Gateway 401 that includes the password itself. A malicious user might sniff out the packet as is was routed around the Internet to the Gateway 401, and steal this that password.

Password thieves might also intercept packets from the Gateway 401 en route to the authentic user, and masquerade as the Gateway 401 itself (this is known as a man-in-the-middle attack), rendering many password encryption schemes useless. To foil unscrupulous third parties from obtaining any information about the password itself, the password can never be transmitted over the wire to or from the client, even in encrypted form.

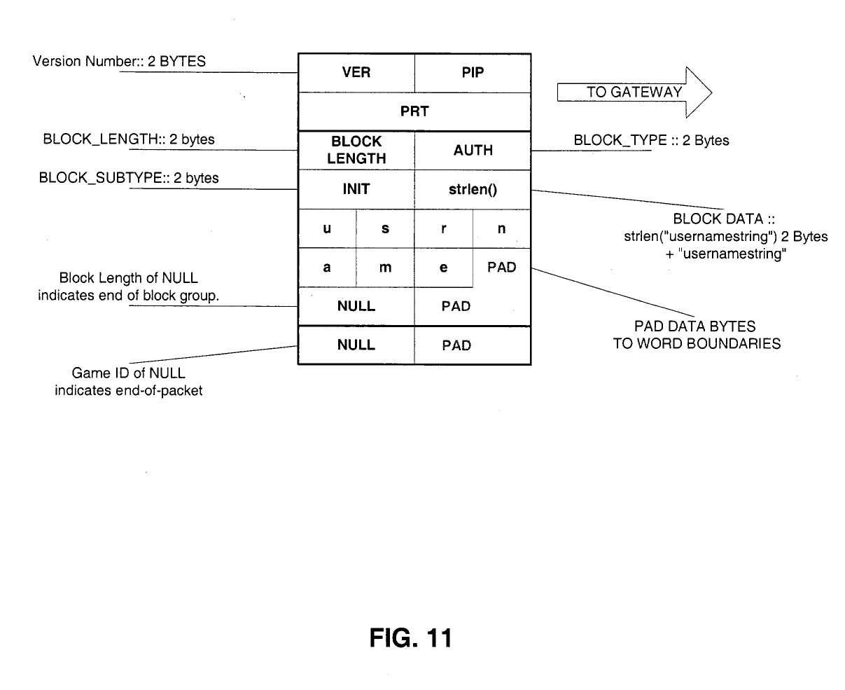

How can the authentic client prove that he/she knows the password (or some “secret”) without transmitting the password itself? To authenticate, the user initiates a Challenge/Response protocol with the Gateway Login Thread, by forwarding an AUTHENTICATE :: CHALLENGE_INIT packet to the login port published by the Grid as the point-of-entry to the firewall. The only significant information that this initialization packet passes is the client's login name and a return address to which network packets may pass back to the client as the protocol progresses (see FIG. 11).

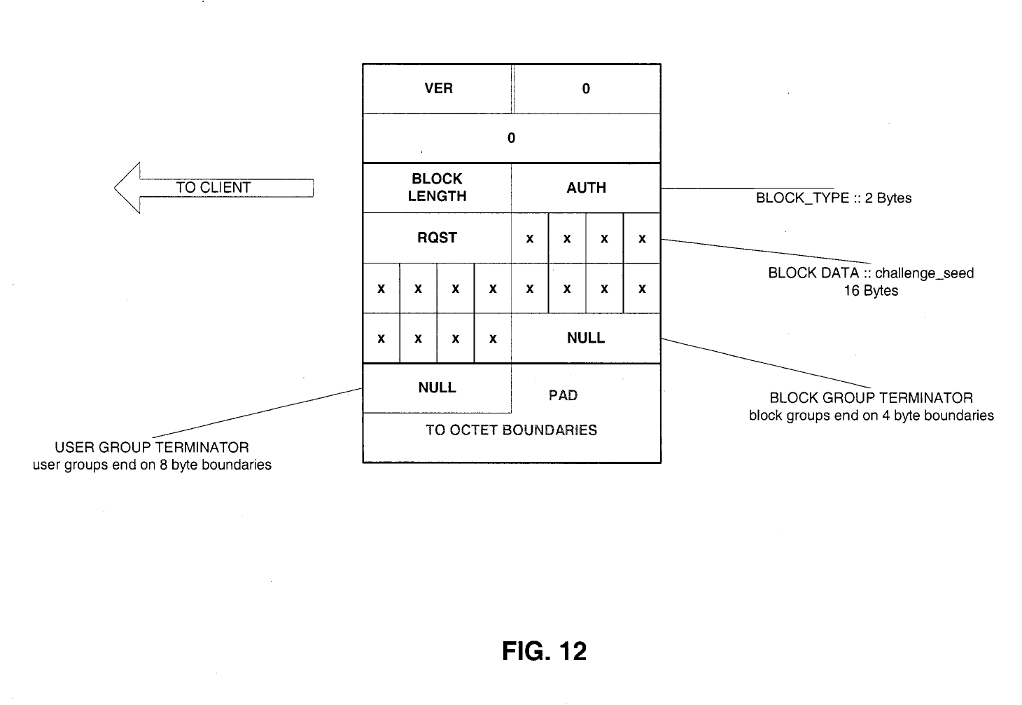

In response to this initial packet, the Gateway 401 passes the packet to its Login Thread for the purposed of client authentication. The Login Thread begins by creating a Challenge object to control the authentication protocol. A Challenge object has two basic parts: a seed of 16 pseudo-random bytes and a lifetime timeout that specifies the period within which this challenge is presumed to be valid. The 16 byte random seed value is formatted into an AUTHENTICATE :: CHALLENGE_RQST packet and the seed is transmitted back to the login client by the Gateway's Network Protocol Stack (see FIG. 12).

Now the login client has a random number to work with: of course, the rest of the world may have this number too, as the packet may have been intercepted as various points along its route. However, such a pseudo-random “seed” value is of little use to anyone intercepting it: the next login to come along will get a different seed value.

What can the client do with this value to prove that he/she knows the shared password? A technique known as hashing produces another 16 byte response that depends only upon the seed and the shared password. The hash value, to all intents and purposes, appears to be another pseudo-random value, and while it is easy to determine knowing the seed and the password, the function to calculate it is a one-way function and cannot be reversed easily to determine the password from the hash even if one knows the seed value used in its creation.

In one example, the method that the Grid uses to create such a strong hash value is known as the MD5 (or Message Digest 5) algorithm. This algorithm is described in the publicly available Internet specification RFC 1321. The algorithm takes as input a message of arbitrary length and produces as output a 128-bit “fingerprint” or “message digest” of the input. It is conjectured that it is computationally infeasible to produce two messages having the same message digest, or to produce any message having a given pre-specified target message digest. (Rivest, R., Request for Comments: 1321, MIT Laboratory for Computer Science and RSA Data Security, Inc., April 1992)

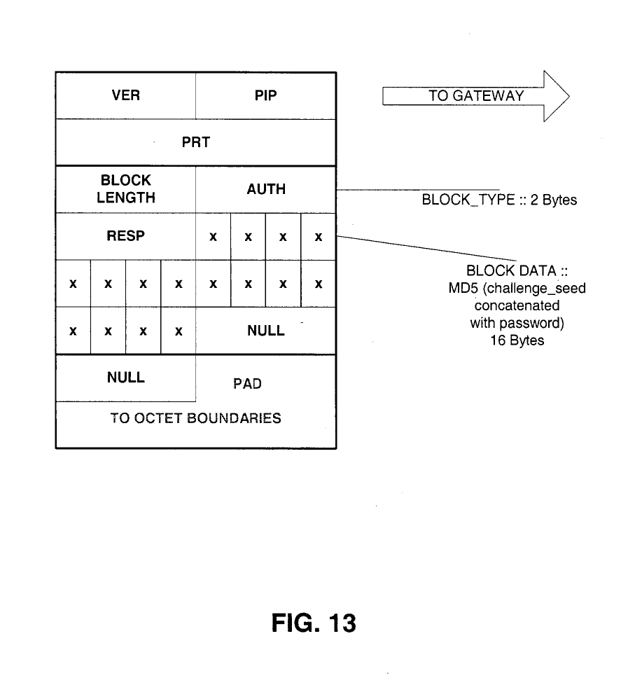

To generate an MD5 hash from the pseudo-random seed value, the client authentication code writes that seed to a buffer, concatenates the password value entered by the user, and calls the MD5 code to produce a 128-bit (16 byte) output value. By responding to the Gateway 401 with this one-way hash, the client can prove to the Gateway 401 that it knows the secret authentication value, even though that password is never transmitted over the wire at all in the AUTHENTICATE :: CHALLENGE_RESP packet (see FIG. 13).

A client that authenticates successfully receives a PASS message from the Gateway 401, those that provide an incorrect hash receive a FAIL message in return.

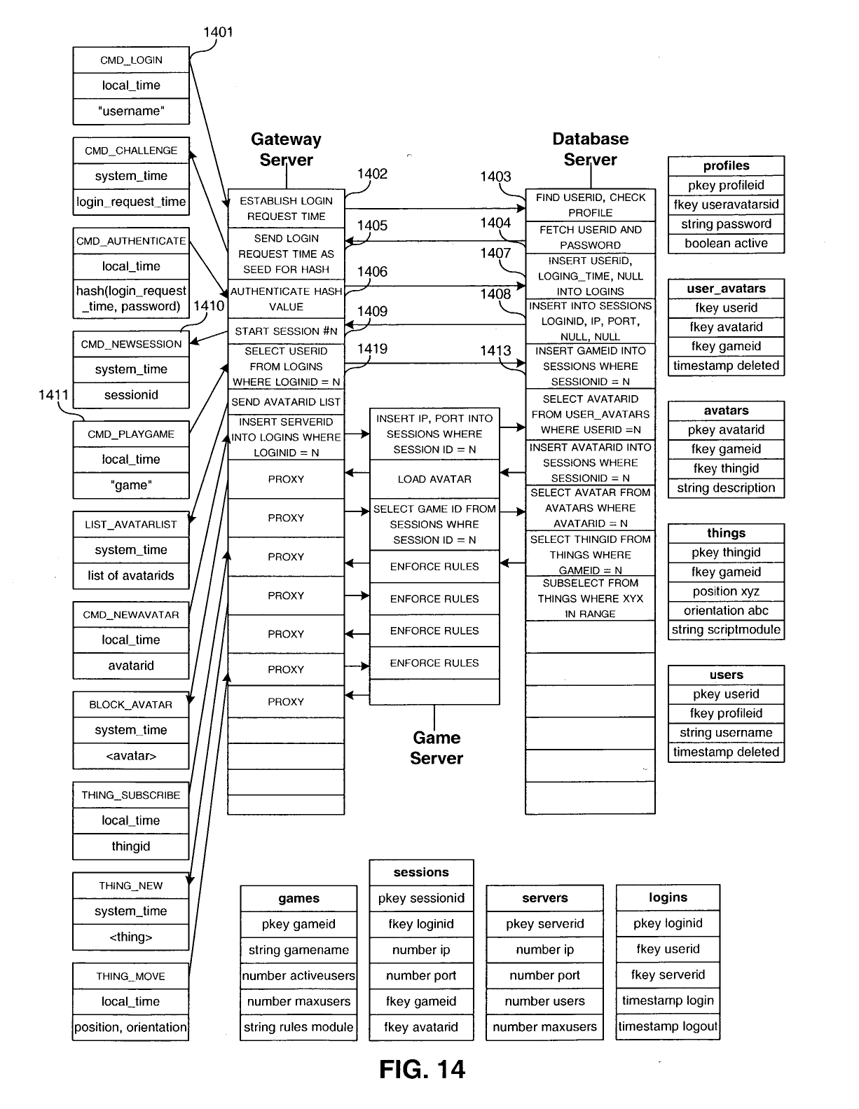

FIG. 14 illustrates the login process in flow chart form, with the arrows designating process flow, showing the process of logging in, authentication and embodying one's Avatar. FIG. 14 should also be viewed in conjunction with other figures describing the Gateway 401 and the figures illustrating the Game Server 405 (see description below).

b. Active Sessions and Session Management

With the client has successfully authenticated, the Gateway 401 creates a Session object to represent the client's current connection to the Grid and to mediate activity between the client and the game itself.

If the client is already logged in from a different access point (for example: what if a user is logged in from the office PC and leaves for lunch carrying my portable notebook computer to log in from a local coffee shop), it would be inconvenient to receive a message from the system saying “sorry, you have to go back to the office to log out before logging in from here”. If the client has not logged out of the previous session and logs in from another access point there could be duplicate sessions active for a single client (which would allow any number of customers to log in using the same account).

To prevent this, the login Gateway 401 initiates a multicast protocol across all the Gateway 401 currently processing incoming packets and sends an exit message designed to log out duplicate sessions before instantiating the current active session. Clients having previously left an active session open on another (or the same) Gateway 401, that Gateway 401 will save the previous state of the client to the persistent state database 104, and the old session can then exit gracefully.

Note that authenticated client processes are sessions, and not connections. The packet protocol underlying the Network Protocol Stack is UDP, and UDP is a connectionless protocol. Any number of clients may be simultaneously forwarding packets to and receiving packets from any particular Gateway 401 publicly accessible port: UDP is indiscriminate. However, transmitted as part of the packet is a session key to distinguish packets belonging to one client session from another. This key, multiplexed in the transmitter IP (TIP) field of the Packet Header and in conjunction with other packet information such as the Internet address of the sender, the serial number, and the inter-packet period of the packet itself are used by the Gateway Session Manager thread to validate incoming packets. Using this information the Session Manager can manage their lifetime and to route them to the remainder of the Grid quickly and efficiently.

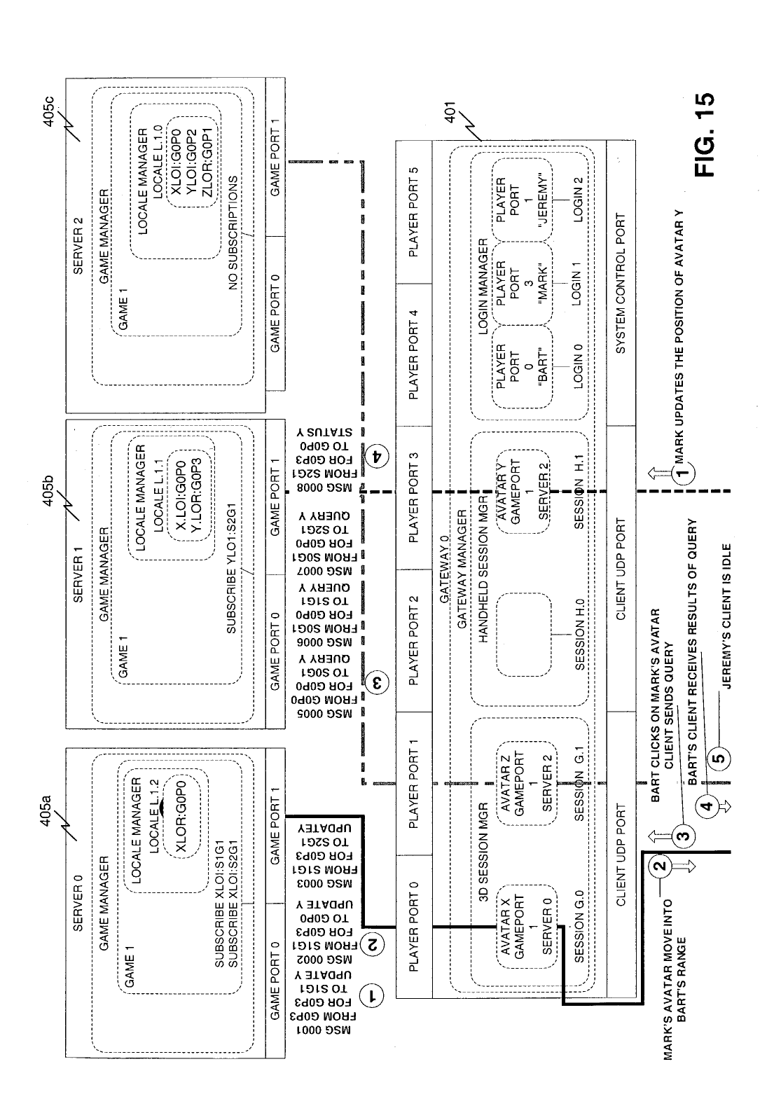

FIG. 15 illustrates how a single Gateway 401 dynamically routes packets to multiple Game Servers 405. The circled numbers (1, 2, 3, 4) represent messages that need to be routed. The message to Game 0 Player 3 (G0P3) is proxied for that player to Server 1 Game 1 (S1G1). In this case, the message is to update value Y, an abstract state that has meaning within the game itself, but not to the context agnostic Grid. The dark line on the left of the figure represents the path of the message through the Gateway 401 to Server 0. The clients themselves receives messages through client UDP ports on the Gateway 401.

On Game Server 0 there is a Locale 0, which is proxied on that Game Server, and which represents the portion of the space of the game defined by the boundaries of Locale 0. Note that the Locale numbering may be discontinuous, i.e., Game Server 0 may support, e.g., Locale 0, Locale 1, Locale 4 and Locale 7.

c. Game Avatar Selection

It is not enough for the Gateway 401 just to log the client into the Grid: it must take an active role in discovering which games are available for the client to enter and play, and which roles the client can assume in each game currently available. To accomplish this task, the Gateway 401 follows a multicast Embodiment Protocol.

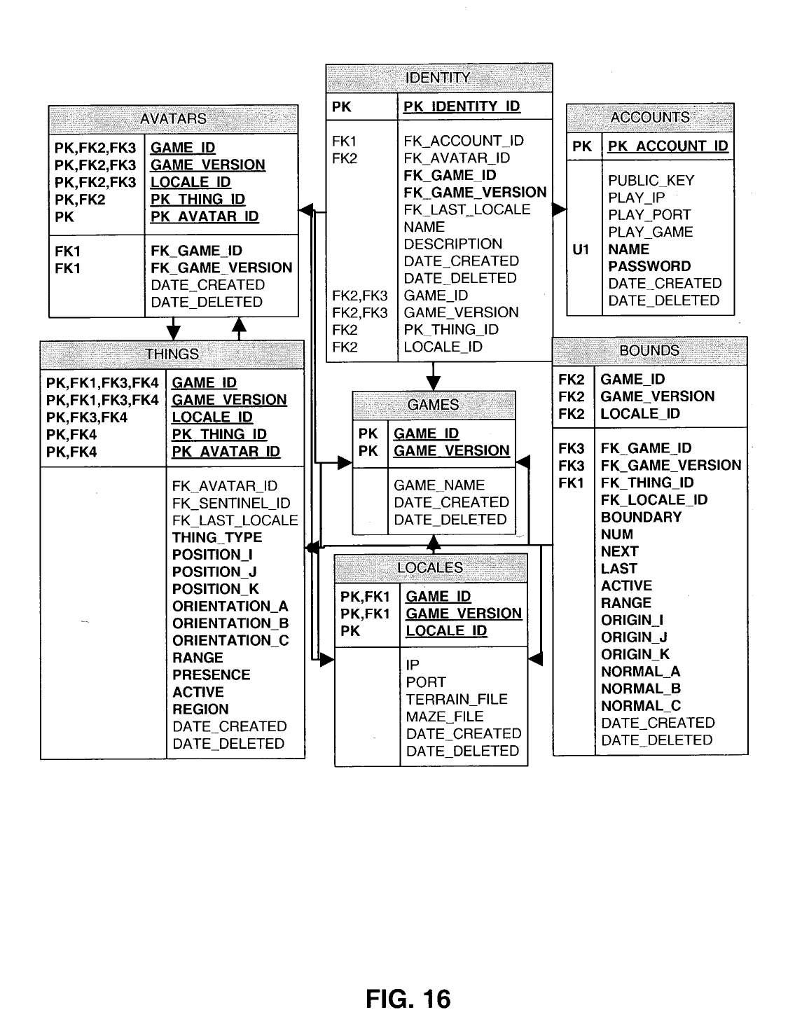

As soon as the client passes the authentication process, the Gateway 401 generates a SELECT :: IDENTITY_NULL packet to multicast among the Game Servers 405, telling them that this Session represents a user account that is not currently bound to any selected Identity and is looking for Games in which it can assume the role of some fully functioning user Avatar. An Identity is an attributed relationship between an Account, an Avatar, and a Game (see FIG. 16).

There may be several such attributed relationships currently available for each client. For example, the client under the Account “bart” may have the Identity “knight of the realm” for the Avatar “lancelot” available in the Game “medieval fantasies”; the Identity “rocketjockey” for the Avatar “spacey” in the Game “star quest”; and the Identity “bodhisattva” for the Avatar “r. rose selavy” in the Game of “enlightenment”.

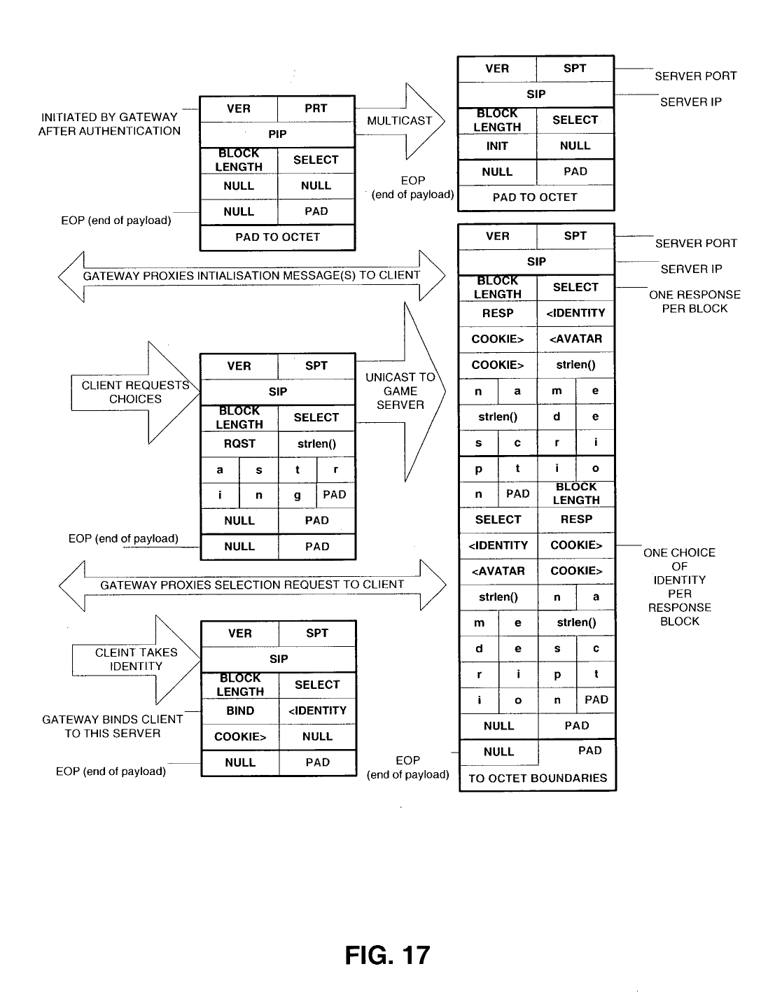

The Game Servers 405 that support individual Locales hosting each game are tasked with responding to the multicast discovery protocol with an SELECT :: IDENTITY_INIT packet that notifies the client code that that Game Server 405 can participate in the Avatar Selection Protocol. These packets are forwarded by the login Gateway 401 to the client, which can then issue SELECT :: IDENTITY_RQST packets through the proxy Gateway 401 (see FIG. 17).

When the client has decided on the user's choice of Game/Avatar combination (based on the SELECT :: IDENTITY_RESP packets received) for this Session, the client takes this Identity by issuing a SELECT :: IDENTITY_BIND packet to the Gateway 401. From this point on, the client is beginning the process of the embodiment of this specific Avatar in this particular Game.

d. Embodiments and Session Bindings

Each authenticated user selects an Identity (an attributed relationship between an Account, Game and Avatar) and then binds the Gateway Session to this specific Identity to begin Game play. Since the Gateway 401 acts as a proxy for the player within the Grid, it must become aware of at least two pieces of information: (a) where to forward messages from the client to the Game Server 405 servicing the Locale containing the Thing that embodies the chosen Avatar, and (b) the network address to which replies, transactions, and instant messages can be sent so that the client will receive feedback about the user's progress within the Game (i.e., “binding”).

In addition to this routing information, some useful measurements can also be associated with the Session at this time. In particular, an expiration time can be associated with the Session to automatically log the player out of the game after some specified period of inactivity, or if the flow of data is interrupted by unexpected loss of network support services. Additionally, quotas can be established for this Session to prevent unethical users from flooding the Grid with an intentional or unintentional barrage of packets, or performing a denial-of-service attack. Statistics may be maintained on the number of packets forwarded on behalf of this client and/or, on the volume of replies returned. Lastly, the session provides a means to control the checkpoint of the user's Avatar to the persistent state database on a periodic basis so that object state will not be lost if the Session is closed prematurely.

For other users to interact with the user's Avatar on the Grid, however, an instantiation or embodiment of a specific type of game Thing must be performed. The Gateway 401 forwards an EMBODY :: AVATAR_INIT message to the Game Server of Record for this Identity to begin the Embodiment Protocol.

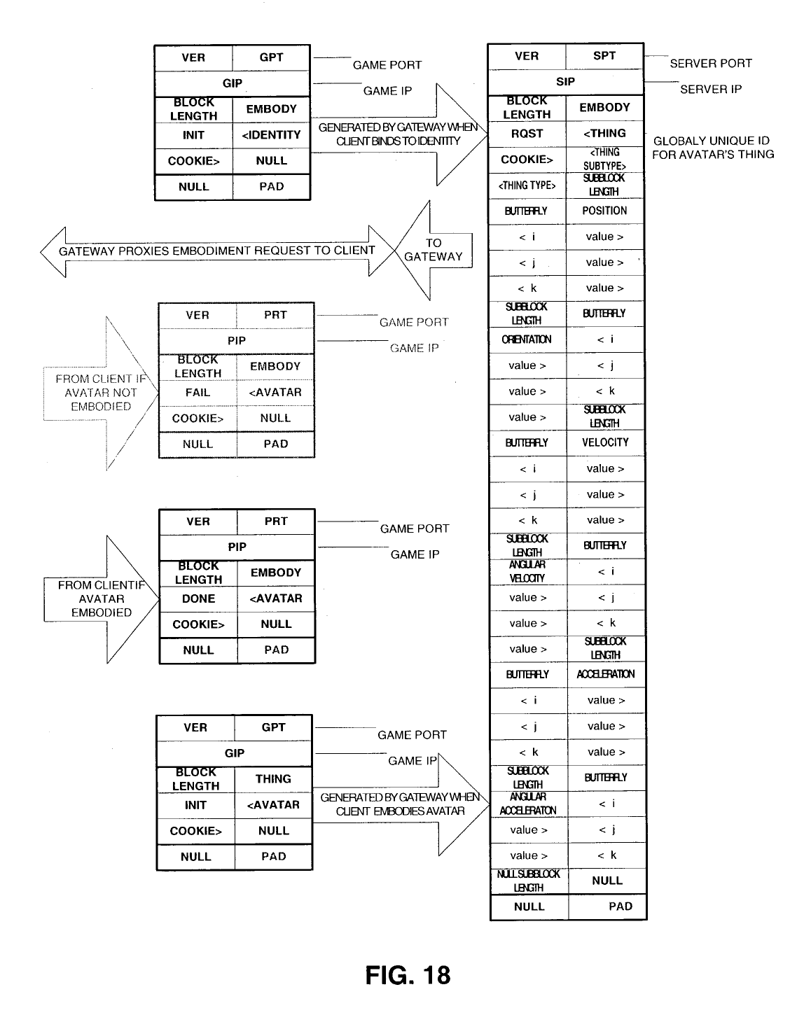

A reply is generated by the specific Game Server 405 that is currently able to service this particular Avatar, and is routed back to the client by the Gateway Session as an EMBODY:: AVATAR_REQUEST packet that details the initial state of this Avatar for the client—where it is located, what direction it is facing, what the Avatar's range of interest should be, whether the Avatar is active, and all the game specific properties for this Avatar at the instant of its embodiment. A representation of this Avatar is kept ready and waiting in a staging area of the Grid until the client finalizes the instantiation of this Avatar with one of two messages to the Gateway 401 (see FIG. 18):

EMBODY :: AVATAR_DONE—the Avatar exists on the client and is ready to take part in the game, OR

EMBODY :: AVATAR_FAIL—the Avatar could not be created on the client and cannot participate in the game at this time.

If and only if the Gateway 401 receives an AVATAR_DONE packet from the client does it forward a message to the Game Server 405 that the Server Thing (discussed further below) that embodies this Avatar in the world can be moved from the temporary staging area and into the world at large. At this point, the player has entered the game and is visible to all the other players in the Locale(s) where this embodiment is “in range”. From here on, the primary responsibility of the Gateway Session is to validate and route packets from the client as expeditiously as possible throughout the Grid.

e. Validation, Filtering and Packet Routing

In addition to the basic structural validation enforced on incoming packets by the Network Protocol Stack (NPS) (which guarantees that received packets are “well formed” before being passed on to the Grid, see discussion of the NPS below), the Gateway 401 performs an important role in validating, filtering and routing packets both to and from the client.

Validation of packets takes place at the Game Manager level. Incoming packets are first sorted by game into first-in/first-out (FIFO) game queues, which are associated with their most current game revision level (e.g. version); each game queue is then processed concurrently by an individual Game Manager thread. The Game Manager inspects each packet's key value, which was submitted at the time the packet was processed by the source NPS and has been demultiplexed and provided by the local Network Protocol Stack. By matching this key value against a hash table containing all the currently authenticated sessions, the Game Manager can quickly retrieve the Internet address and port number of the client for this session from the session's login_token. If the address and port combination of the incoming packet matches that of the token (or matches that of some internally generated secure Grid port) then the packet is placed in the session buffer for further asynchronous processing.

Filtering the game packets occurs at the level of the Game Manager threads. After checking the ratio of incoming packets to a dynamically generated quota to avoid overloading the system and prevent denial-of-service attacks, each session manager inspects a packet's user headers and determines if the version field of each user header matches the current revision level of the game. Any packet payload whose version does not match can be immediately discarded. Only clients who are at the current revision level of the game are allowed to play. Next, the message level of the packet payload is determined, based on the block type of each payload message block. Some block types can be processed locally on the Gateway 401 (such as LOGIN or LOGOUT); others must be proxied by the Gateway 401 to the Game Server 405 that is currently bound to this particular session (ACTIVATE commands), still others are required to be multicast across the Grid as a whole (e.g., some SELECT messages). This filtering and categorizing of packets provides a flow-of-control for the session manager to follow in routing the packets on to their final destination.

Routing of packets is primarily controlled by the host_token bound to this user session. This token represents the current Grid instance running the current game and supporting the current Locale for the client's Avatar. Note that this Game Server 405 is not a fixed destination. Depending upon geography, game-play and load of the client's Avatar can be handed off from one Game Server 405 to another on a dynamic basis over time. Nonetheless, the most current Game Server 405 is referenced by the session's host_token and provides the game ID, Internet address, and port number needed to connect this session to its Grid enabled counterpart. On the return trip, reply packets are routed along the reverse path: validating that they have arrived consistently with the session's host_token and ending up at the destination specified by the user's login_token.

f. Instant Messaging

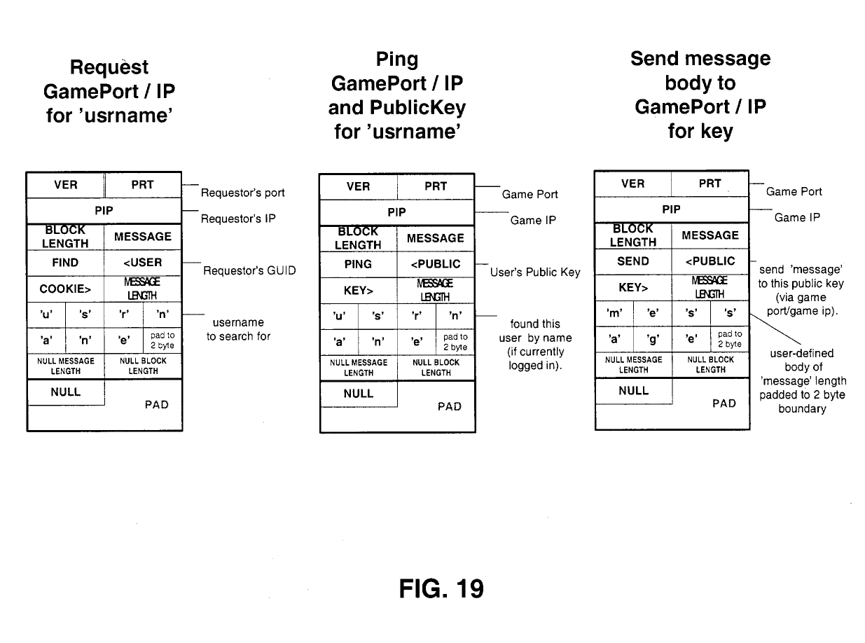

Instant Messages are one particular class of Grid packets, and a subclass of packets whose block type is that of MESSAGE (see FIG. 19), and whose block subtypes are as follows:

MESSAGE_FIND—Request game port/IP address for ‘usmame’; provide the GUID of the client who is asking the Gateway 401 to find the user by name, and receive a MESSAGE_PING packet in return if the usrname can be found, containing the public_key of the user.

MESSAGE_PING—Ping game port/IP address and public key for ‘usmame’; provide the game port/ip address and public_key of a user to test their online status, and receive a MESSAGE_PING in return if the user for that key is currently logged into the Grid; otherwise receive a MESSAGE_NULL from the Gateway 401 in response.

MESSAGE_SEND—Send message body to game port/IP address for public key; send an instant message the user currently associated with this address and key. Provides a mechanism for mediated peer-to-peer transport of arbitrary packet data of variable length, subject to overall packet size constraints.

Instant Messages may be used in the Grid for several purposes. They allow one user to ‘chat’ with any other user playing the same game within the Grid. The Instant Message protocol allows discovery of which of the player's friends are currently online. Game rules can automatically generate Instant Messages for distribution to clients representing transient events or one-shots (such as an explosion), or to trigger audio cues when the client's Avatar approaches a particular location. Instant Messages can also be used to pass URL (universal resource locator) information about new resources available for download from a central repository.

g. Secure Messages and Distributed Transactions

Instant Messages are also flexible and extensible. Built on top of the Instant Message framework is support for a fourth type of message: a secure Protocol that provides the basis for distributed transaction management. Using a special form of Instant Message (MESSAGE_SECURE), the interactions among a group of users are guaranteed to be safely and reliably distributed across the virtual network.

As noted above, the Grid provides a means to distribute object state among a community of users in a reliable way. The object state updates represent the changes that occur as the result of a user's actions or choices. The clients interact with each other based on their own and the other player's object states. This is enforced by a set of rules determined by the game designer and implemented across the hosts in a context agnostic manner. Often these interactions are also interrelated. That is, the rules say that one change cannot occur without the other. When the changes must succeed or fail as a set, they are known as a transaction.

A simple example of a transaction is a “buy a duck” example. Player 1 has two ducks, and Player 2 offers to buy a healthy duck for two gold coins. Players 1 and 2 wish to engage in a transaction. This proposed transaction involves Player 1 and his object state and Player 2 and his object state. Players 1 and 2 desire to get to the final object state where they each have one duck and two coins. However, this proposed transaction may have a few problems in practice.

If Player 1 asks Player 2 to give him the two gold coins first, Player 2 might be concerned that Player 1 will take the coins and run without relinquishing the duck. If, on the other hand, Player 2 asks Player 1 to give him the duck first, Player 1 may wonder if he can trust Player 2 to pay the full amount (perhaps Player 2 will only give one coin, or none at all).

Also, since Players 1 and 2 are in a distributed environment, Player 1 may not be able to examine Player 2's purse to see if he actually has two gold coins. Player 2 may not know that Player 1 sold his healthy duck last week, and all he has right now are two sick ducks. For the transaction to remain secure and honest, some sort of “honest broker” has to guarantee the results.

The Grid itself becomes such an honest broker. Since the object state is distributed across the Grid, a Grid transaction is a distributed transaction. And since cheating is not allowed, these interrelated changes of state become a form of secure distributed transaction. The Grid validates that (a) the transaction has been approved by both parties, (b) that the object states in question really exist, and (c) that the final results are consistent with the intent of the original proposal. Thus, distributed transaction management becomes possible.

The interdependent actions, choices and changes comprising a secure distributed transaction must preserve four essential qualities:

a) Atomicity—they must take place among a group of players either simultaneously or not at all.

b) Consistency—nothing can be lost afterwards that was not accounted for beforehand.

c) Isolation—and no outside influences should affect the predictability of the results.

d) Durability—the changes must have a lasting effect on the world.

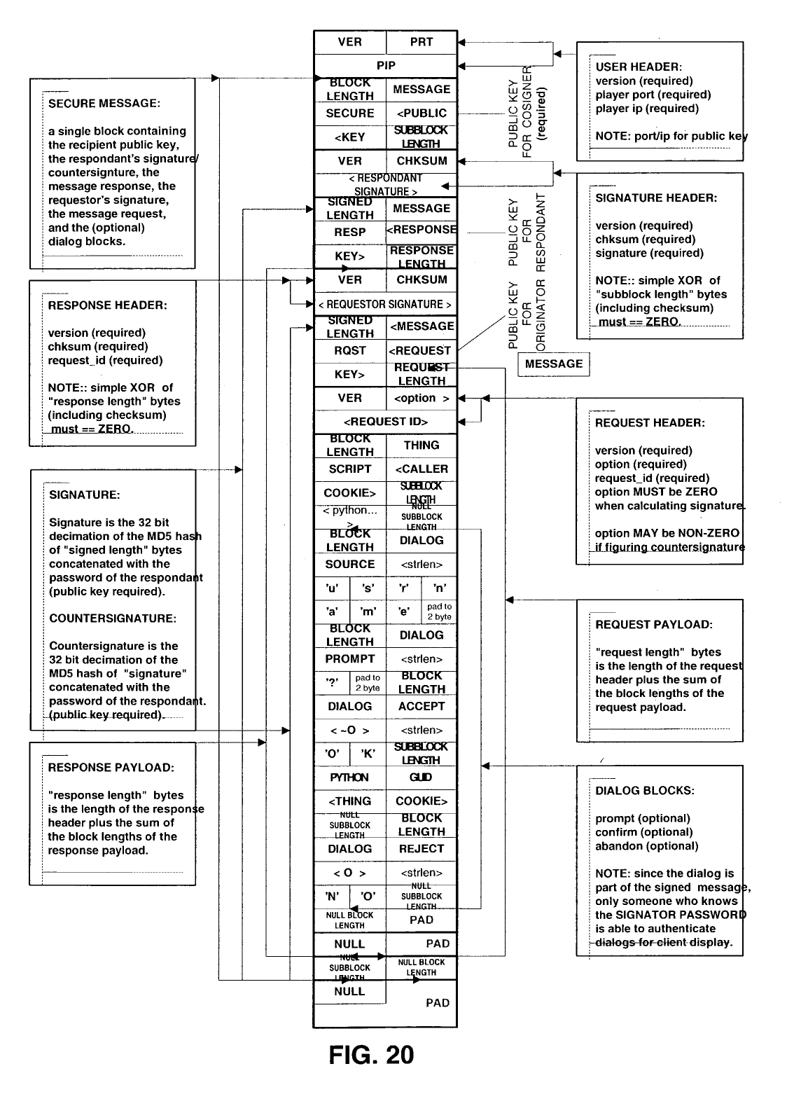

Normally, any transaction protocol as described above should be approved in advance by the parties whose states may be effected by this set of proposed changes. Also, the protocol must prevent unauthorized changes to the proposed transaction after approval and before execution (that is, if Player 1 agrees to sell a duck for 2 coins, then Player 2 can't change the contract after Player 2 has signed it so that Player 2 only has to pay one coin). This is the function of the packet MESSAGE_SECURE. The MESSAGE_SECURE packet type includes several interrelated elements, which are illustrated in FIG. 20.

The secure messaging protocol is built on, and embeds within, a PYTHON_SCRIPT protocol, which is the mechanism by which remote actions are invoked on objects in the Grid. While the Python scripting protocol will be discussed in detail in the Game Server section and the Area of Interest Management section below, invoking a Python script is one means of rules enforcement in a context agnostic manner. By embedding a Python script inside a secure message, and digitally signing it, the Grid guarantees that the actions that the script represents have been authorized by the system and that nobody has tampered with the terms of a proposed transaction.

In addition, the secure message includes a DIALOG or user prompts to present the proposed transaction to the user in a succinct way, and a digital signature and countersignature to prevent packet tampering.

When the client receives such a message, the client is presented the dialog, and agrees to approve this transaction, then the transaction is countersigned the secure message. This guarantees that if any third party tampers with this transaction, the Gateway 401 will be able to detect the modifications and abort the transaction before it commits the transaction to the persistent state world.

h. Handling Denial-Of-Service Attacks

Besides validation, filtering and packet routing, each Gateway 401 fulfills an important other purpose—protecting the Grid against malicious clients, hackers and infiltrators. One of the simplest and most effective techniques for compromising system integrity is the denial-of-service attack where a flood of incoming requests swamps the capability of an Internet server to keep up, bringing the system to its knees.

The Gateway 401 is in an ideal position to defend against such attacks. Functioning as a gatekeeper to the Grid, the session management software can establish packet quotas for individual clients, dynamically redirect packets or ignore them altogether, and throttle and regulate the flow of data among the various hosts. Thus, the Gateways 401 can present a unified defense against the malicious client.

2. Game Server

The Game Servers 405 are at the core of command and control, the middle of the multi-player model, and the geographic center of the Grid. In short, the Game Server 405 provide clients with a truly believable entertainment experience. As part of a fully distributed system, the Game Servers 405 maintain the illusion of “no boundaries” and bind the broken “shards” (Locales) of the online universe into a single apparently unlimited domain. Within the Grid, a user can always get there from here.

a. Initializing Locales

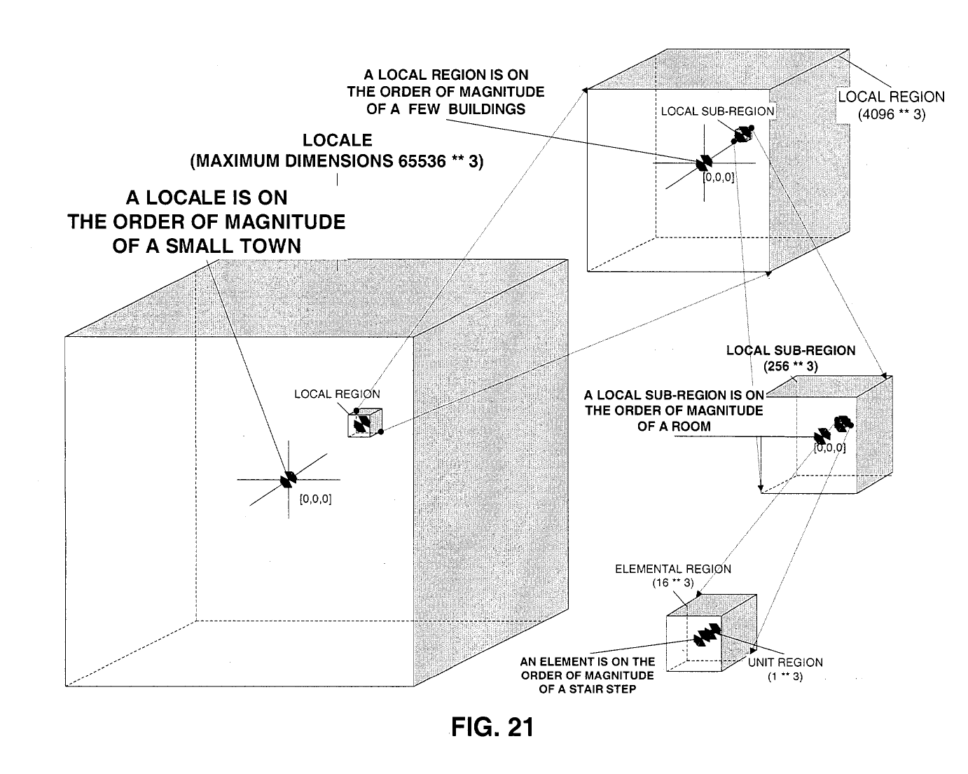

A Locale is a convex region in three dimensional space, that provides a stage or environment that supports the interactions of one or more Server Things. A Locale represents a place to establish a specific presence as part of the larger game universe. Although a Locale does not have to be rectangular in boundary, in one embodiment, discussed below, it has to fit within a region with the maximum dimension of 65536*65536*65536, as shown in FIG. 21.

The Locale is the atomic unit of geography in the game world, and is defined in terms of world coordinates. These values correspond to the POSITION state values transmitted in packets as part of object state (see also discussion of Network Protocol Stack below).

World coordinates are expressed as single precision floating point numbers, as defined according to IEEE Standard 754 and can convey values approximately ±10^{38.53}. The value NaN (Not a Number) is used to represent a value that does not represent a real number (such numbers may be generated with a divide-by-zero for example). It is important to remember that although a Locale can be positioned anywhere in world space, in one embodiment, in this embodiment, the range of a Locale cannot span a region larger than 65536 integer units in any direction.

The range of a Locale is specified by the game designer as part of the game design process. The designer is free to size his or her Locales appropriately to the needs of the specific game world in which it resides. The shape of the Locale is also up to the game designer, as long as the region which it defines is convex in shape. However, in order to balance packet overhead and Game Server load, a Locale should be on the order of magnitude of a small town or village in maximum dimension, and its boundaries should not be designed to run through any major thoroughfares or other high-traffic areas. For example, a small tropical Island would make a good Locale, as would a walled Castle with a moat around it.

It is preferable to avoid designing Locales that are too small (room sized), too large (metropolitan sized) or too congested about the periphery (such as a park bounded by city streets). Care taken in intelligent design will go a long way to make the player's experience more enjoyable, with less lag and more rapid response times. Preferably, the Locale should be designed on the model of the “Locale region,” on the order of magnitude of a few buildings or a city block with limitations on the ways in which traffic can logically enter or leave the region, as shown in FIG. 21. These recommendations should only be taken as a general guideline.

The Grid universe consists of many Locales, each belonging to a specific game. At initialization time, a configuration file apportions each Locale to one and only one Game Server 405, though each Game Server 405 may host many Locales within one or across several games. These Locales are regions defined by planar boundaries (or hyperplanes) in three dimensional space and must be convex. That is, they cannot contain holes or other concavities and they must be simply connected. Locales do not have to be contiguous to one another, but if they are then they should never overlap. Most game designers will want to tile their universe with Locales in a more or less regular fashion. These worlds might look like a honeycomb of hexagonal regions, for instance. In a tiled world, the first order of business when a client logs into the Grid is to discover which host for which Game Server 405 is currently servicing the Locale tile into which the new Avatar will initially be placed.

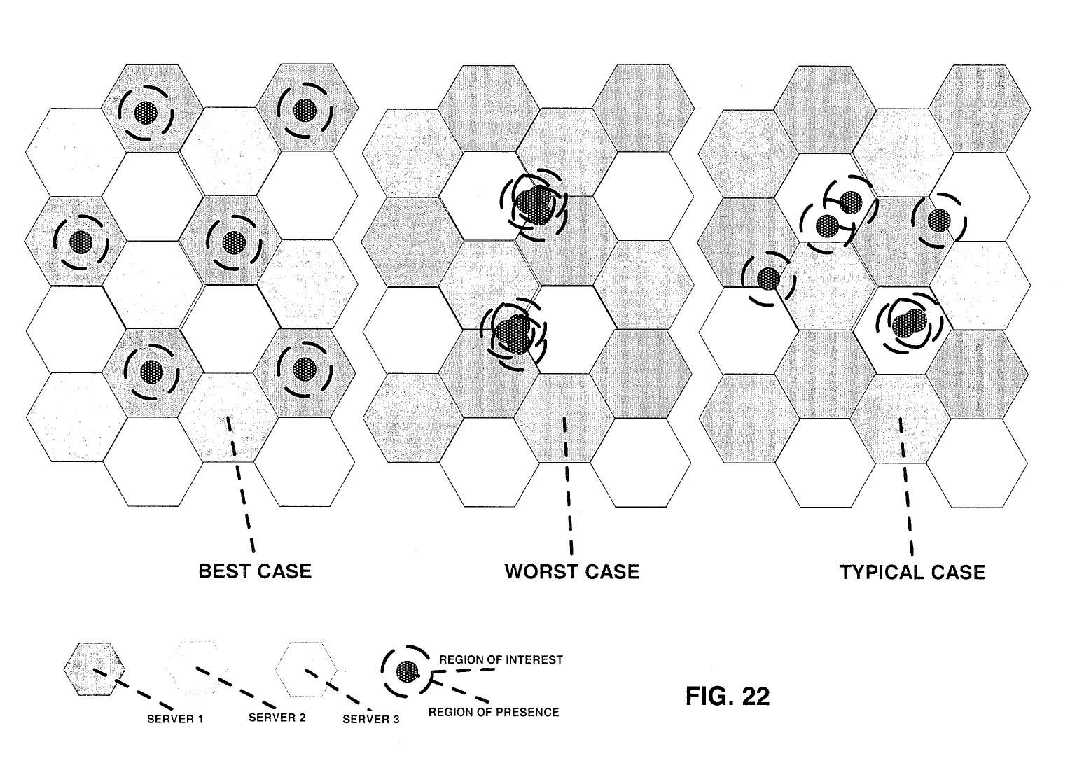

FIG. 22 is an illustration of intelligent Locale design. If the Locales are hexagonal in shape, the best case scenario is on the left of the figure, where each player has his own Locale. In other words, all of the Avatars are on the same physical host, but have their own Locales. This requires the least overhead. The typical case shown on the right, where some players are in their own Locales, others are at the boundaries between Locales, and still others have regions of presence that intersect. With this Locale design, unless the designer puts walls between the Locales, there is no control over what happens to the Avatars. Thus, adding walls around some Locales may be a more intelligent choice, to minimize cross-server overhead.

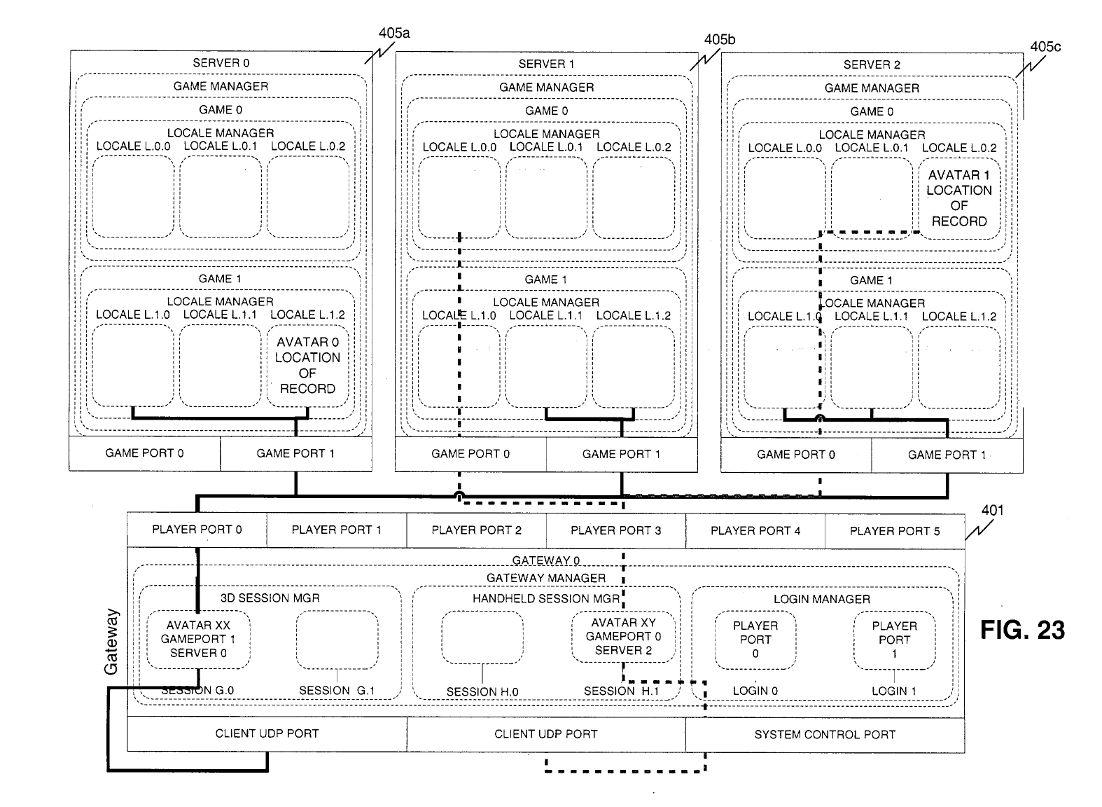

FIG. 15, discussed previously, illustrates additional detail of how Locale Threads are hosted on Game Servers. For example, in the upper left-hand corner of FIG. 15, Server 0 is illustrated, which has a Game Manager process running within it. The Game Manager manages Game 1, which has within it a Locale manager with a thread for Locale 1.2. FIG. 23 is an illustration of how each Game Server 405 may have a Game Manager that in turn manages multiple games (i.e., multiple processes corresponding to multiple games). It will be appreciated that there could be a number of games, and a number of Locales within each game. The processes running on Server 0 communicate with other processes through game ports (game port 0, game port 1 in the case of FIG. 23). In one embodiment, a network socket layer may be used as game ports 0 and 1 to connect through a particular process on the Server 0. The bottom half of FIG. 23 represents the Gateway 401.

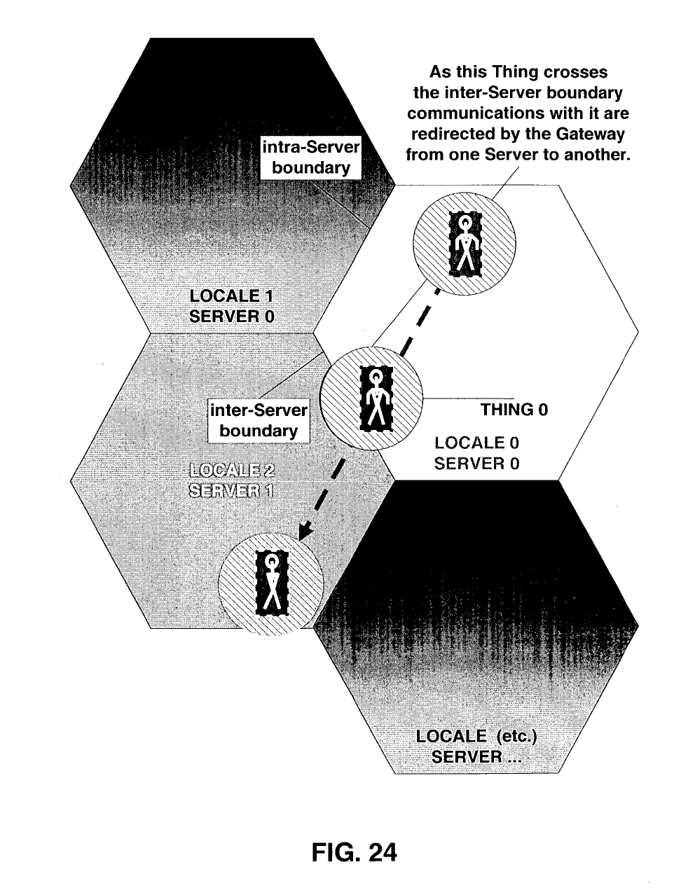

When a client's Avatar is embodied, it is assigned (or bound) to whichever Locale its region of presence is positioned in, that is, the Locale within whose boundary hyperplanes it is completely contained. After discovery of the host location, the Gateway 401 directs (or proxies) client communications to this Game Server of Record. In turn, the Game Server of Record creates an Embodiment-of-Record (called a Server Thing) in the specified Locale and which represents the Avatar within its current context. This binding of the client to Server Thing is dynamic, and as the client roams throughout the Grid, its embodiment can move out of one Locale and into another, as shown in FIG. 24.

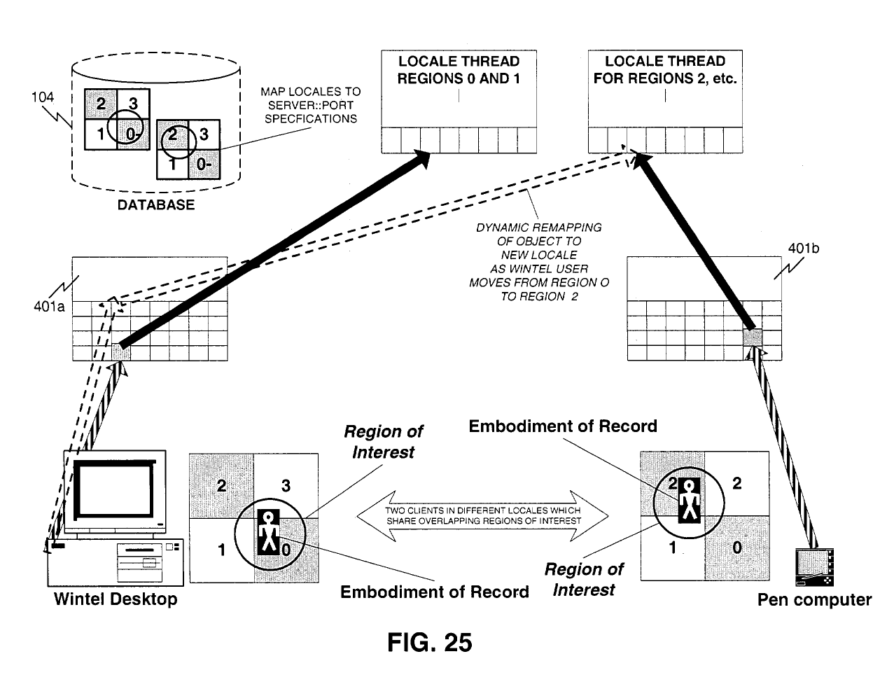

Sometimes the client will move another Locale on the same host (across an intra-Server boundary), and at other times their embodiment will transition to a different Locale distributed to a physically distinct host, or across an inter-Server boundary, as shown in FIG. 25.

As the client moves across Game Servers, his/her embodiment-of-record is removed from the old host and is re-created on the new host. A new Server Thing is instantiated on the new Game Server of Record. From this point on, all data packets that target their embodiment-of-record are proxied by the Gateway 401 to and from the new Game Server of Record across the Grid.

Since Locales are 3-dimensional in extent, and since they are delimited by hyperplanes, they do not have to be closed regions. If desired, they can extend to the sky.

b. Embodiments of Record

Important to distributed state management is the concept of the embodiment-of-record. This is the authoritative object that represents the current state of the Avatar, as long as he or she is logged onto the system. There may be other copies of this state distributed across the Grid and over the network to many clients, but those objects are not authoratitive ones. At any given instant, there is only one (or none, if the user is not logged in) embodiment-of-record for any Server Thing in the Grid. It is initialized from the persistent state database 104 when it is created, and flushed from the database 104 when it is destroyed. While it exists, it is the one true copy of any Server Thing.

Some Server Things, like Avatars, are fully active and serve as a source of packets for propagating state to many others. Some are defined instead as passive objects that only funnel incoming information back to a single client. All are embodiments-of-record.

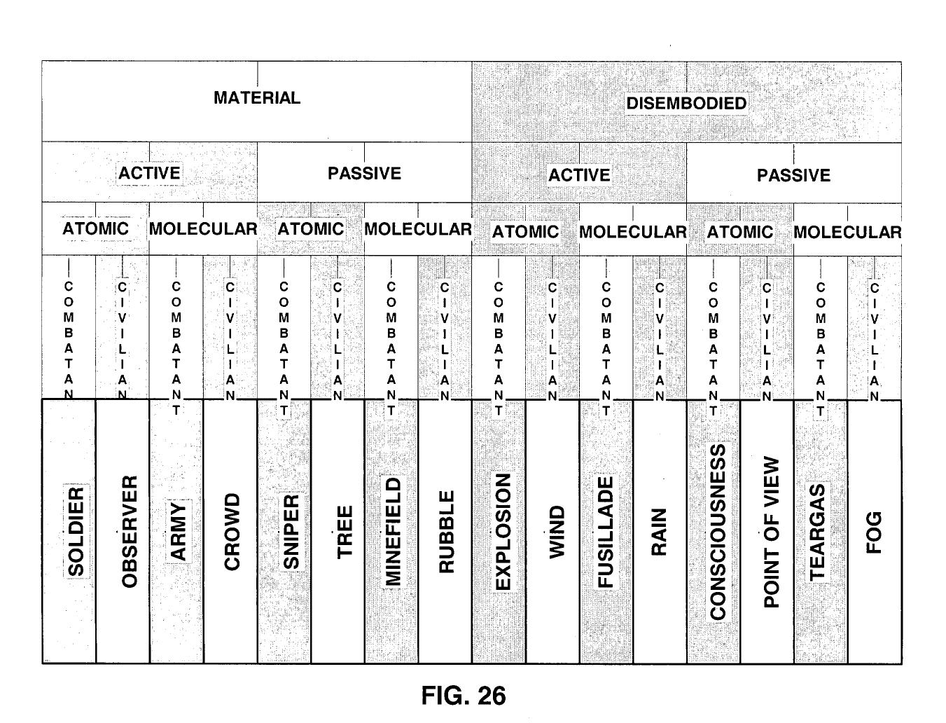

FIG. 26 illustrates the taxonomy of object classification that may be present in the game, in this case, a war game. An example of an atomic active material object is a soldier, a type of combatant. An example of an atomic active material object is civilian, which may be an observer. A group of soldiers may form a molecular type of combatant called the army. A group of civilians may form a molecular type of civilian called a crowd. Other objects may be purely passive, such as trees or rubble. Yet other objects may be disembodied objects, relating to events, for example explosions, fusillades, rain, consciousness, etc.

c. Propagating State

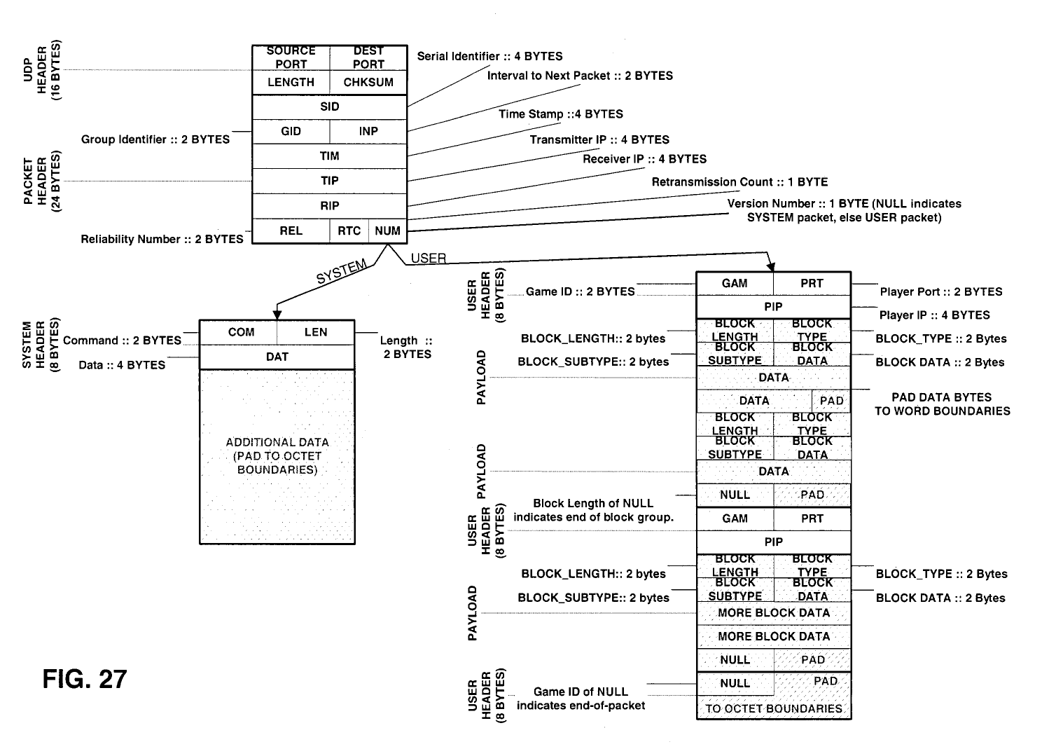

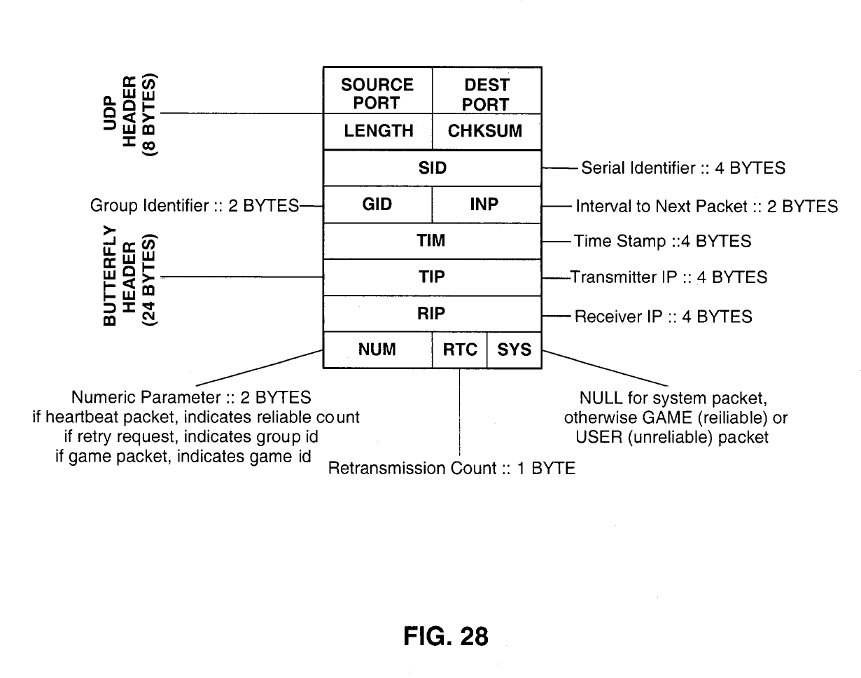

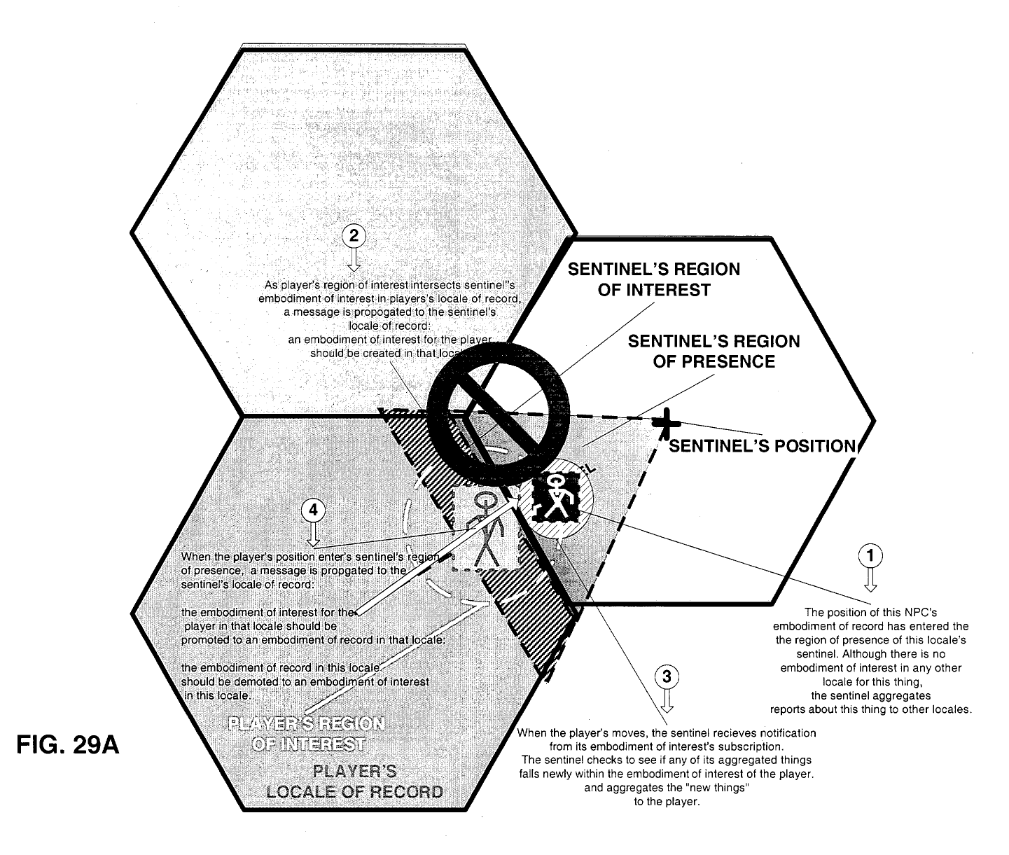

Each Locale is controlled by a single Locale Thread in the Game Server 405. Packets forwarded by the Gateway 401 are routed by a proxy session on the Locale Thread of Record to the Locale Thread itself. This session represents the current binding of the client to a specific Locale on this particular Game Server 405, and takes a role in validating, filtering and routing packets based on the session key embedded in each packet. FIG. 27 illustrates a taxonomy of a packet. At the top left is a representation of the Packet Header, also shown in FIG. 28. At the bottom right of FIG. 27 is an illustration of how clients send information to the Game Server 405. At the bottom left of FIG. 27 is an illustration of how system information may be added to the packet.

In addition to validating, filtering and routing packets, the Locale Thread plays a central role in propagating client state by duplicating and distributing packets to other clients. The producer of these duplicated packets is referred to as a packet source, and the consumer of the distributed packets is called a packet sink.

As game packets arrive at the Game Server 405, they are sorted by the Session Manager and forwarded to the appropriate Locale Thread for processing, where their proxy object (the Server Thing acting as their embodiment-of-record) functions as a packet source with a region-of-presence that controls the flow of information about this object to other objects within range. Each object nearby represents an embodiment-of-record for some other Server Thing, and functions as a packet sink for outgoing messages to other clients. Information about the changing state of the client is transmitted to all others Server Things whose area-of-interest overlaps the client's region-of-presence. In this way, the client state (i.e., object state) is propagated throughout the Grid.

d. Server Things

There are four major types of Server Things involved in propagating object state across the Grid:

a) Avatars—client controlled objects that operate as a single source of packets to others and provide a single sink for packets from others. The originator of Avatar packets is the client itself. As the client operates the game controls, packets flow through the Gateway 401 to the Game Server 405, and thence to their Locale Thread and their embodiment-of-record. Their Server Thing provides a single source of packets to other clients. Any object ultimately connected to a real human player is an Avatar.

b) Active Objects (NPCs)—non-player controlled objects that operate as multiple sources of packets to others and provide a single sink for packets from others. The originator of NPC packets is the daemon (discussed below), a computer controller login account for each Locale with special privileges. The daemon manipulates active objects within a specific Locale, and their embodiments-of-record provides a multiple sources of packets to other clients. An example of an active object might be a Dragon or a Troll.

c) Passive Objects—non-controlled objects that operate as multiple sinks of packets to the Locale daemon and do not provide packets to others. The daemon listens to passive objects within a specific Locale. The embodiments-of-record of passive objects provide multiple sinks of packets for the daemon client. An example of a passive object might be an Enchanted Castle.

d) Sentinels—a sentinel is a software construct within the server process that allows the seamless one world implementation. The sentinel acts as a proxy for Server A on another server B. Server A will create sentinels on other (for example, adjacent) servers (B and C), and those sentinels will become conduits for messages. Thus, the sentinels will feed information back to server A that created them. Server A will in turn redistribute the messages/information to the Things that live on Server A, e.g., the players logged into Server A.

Thus, the sentinel becomes the “eyes and ears” of a particular Locale, when it is placed on another server (including the case where the other server is on a different physical host). Phrased another way, the sentinel sends information back to server A that launched it, about the state of the objects on server B where the sentinel is located. If server A launches a sentinel into server B, the sentinel will send information back to server A about the state of the objects on server B. The communication between server A that launches the sentinel and the sentinel itself is an example of inter-process communication, and occurs through the Network Protocol Stack. This also includes the case where a communication is remote, for example, over a LAN, WAN or the Internet. The system allows for considerable flexibility, especially in the case of distributed physical resources.

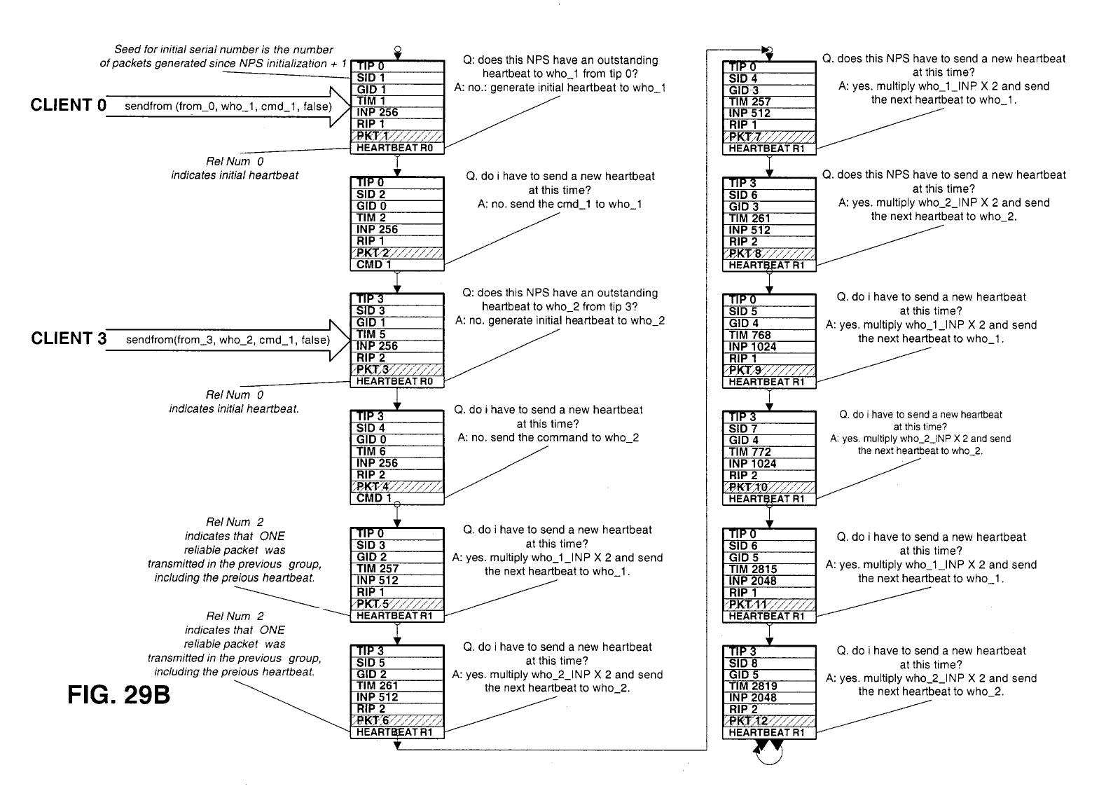

FIG. 29A illustrates how players and sentinels interact across Locale boundaries. Note that the Game Servers 405 that support the Locale Threads are behind a firewall, and as such are trusted. Thus, it is assumed that they cannot launch a malicious sentinel into another Game Server 405. Sentinels are proxy objects that operate as a stub sink and proxy source of packets across Locale boundaries. Sentinels are akin to windows that allow players in one Locale on one Game Server 405 to “see” players in another Locale on a different Game Server 405. Sentinels come in matched sets, with a single sentinel-of-record known as the master (proxy_source) sentinel. Multiple sentinels-of-interest are known as slaves (stub sinks). They are typically positioned on or near Locale boundaries.

Because object data distributed across multiple Game Servers 405 and multiple hosts, and possibly across large-scale networks, the process of discovery is used to bind the proxies to the stub. The proxy sentinel and the stub sentinel communicate in a unicast manner, but only after a multicast process of discovery takes place, to identify the relevant participants in the communication. The discovery process is how the Grid finds out on which physical machine (host) a particular sentinel is on. In other words, each Game Server 405 using the discovery mechanism, has to figure out where each sentinel is, and where the messages should be directed to (i.e., which physical host). The remote sentinel (proxy sentinel) and the local sentinel (stub sentinel) have to find each other, using a matchmaker. The matchmaking process is also distributed.

Consider two players, one in Cambodia, and one in the United States. The sentinel in Cambodia is, in effect, a trip wire. The other end of the trip wire is in the United States. When something touches the trip wire in Cambodia, a signal is sent back to the United States, and the end of the trip wire in the United States “vibrates”. The proxy sentinel is in Cambodia. The proxy sentinel is the transmitter of state information, and the stub sentinel is the receiver of the information.

The proxy sentinel in Cambodia thus acts as a proxy for all the objects in Cambodia. The stub sentinel in the U.S. is a master proxy for all the objects that touch the trip wire in Cambodia. At the receiver (stub sentinel) many “ghost” objects are created to correspond to the objects in Cambodia, and the ghosts in turn become proxies. Having established minimum necessary information for the ghost to interact with other objects on the stub sentinel, the ghost can now send the information further up the chain (e.g., to the client) without interpreting it. Phrased another way, the object state information of objects in Cambodia that touch the tripwire is passed in a context agnostic manner to a player “located” in the United States.

Note that client objects (which reside on the client itself, outside the Grid) are fundamentally different than any Server Thing. Since client objects are controlled directly on the player's computer (e.g., a Wintel computer, a handheld digital assistant, or a game console), they may be implemented in a heterogeneous fashion with a priori knowledge about their specific game. Server Things must interoperate in a context agnostic manner, and must provide a general mechanism for representing object state without any such limitations.

3. The Network Protocol Stack

The preferred embodiment employs a transmission protocol designed to be reliable, while mitigating the latencies associated with many protocols.

At a basic level, data communications are usually carried out with TCP/IP or UDP/IP as the data level protocol. Unfortunately, both of these protocols have inherent weaknesses. TCP/IP, for example, guarantees reliable and ordered delivery, but at the expense of potentially large latencies. UDP/IP, on the other hand, does not hold packets for delivery, but also does not guarantee packet delivery.

To obviate these problems, the preferred embodiment employs its own network protocol that is layered upon UDP/IP and allows packets to be flagged for reliable transmission.

The Network Protocol Stack (NPS) employed in this embodiment uses a protocol such that most state information needed by the system is deduced by the receiving end. In other words, the transmitter is more-or-less stateless. This is accomplished through the transmission of heartbeat packets. The NPS is thus a thin layer on top of the UDP protocol. The Network Protocol Stack is implemented in one embodiment that allows some packets to be sent reliably, and others to be sent unreliably.

In normal transmission, packets that are flagged as reliable are stored in an output buffer by the transmission NPS as they are transmitted. Furthermore, Packet Header information in the heartbeat packets gives the receiver the number of reliable packets transmitted since the last heartbeat. As the receiver can deduce the timing of heartbeats, it will either receive the heartbeat packets, or ask for the re-transmission of these packets if one is overdue. The receiver will also know (by examining the heartbeats) if reliable packets have been missed. If this is the case, a re-transmission request will be made, and the transmitter will pull packets from the buffer and re-transmit them in the next heartbeat group. The size of the buffer, the timing of heartbeat packets, and other parameters can be adjusted to maximize performance for a given transmission media.

By employing such a system, a reliable transmission channel can be established between the transmitter and the receiver without the need for positive acknowledgment from the transmitter (as is common for the case of the transmission of reliable packets). This has the advantage of keeping overhead low when the media of transmission is performing reliably, but still affording the retransmission of packets when the upper level protocols require the delivery of packets. It has a further advantage in that the state-machine of the transmitter is simplified and easy to implement, which is an important consideration when the client devices may have limited resources.

a. Principles of Operation

If the Grid is the embodiment of a distributed game system, the Network Protocol Stack is its circulatory system. At its core, the NPS provides the system its heartbeat, pumping messages out to different parts of the Grid and pooling messages received in return.

The flow of messages changes in response to the level of system activity. When the state of many players is changing rapidly, a multitude of packets are pumped out to transmit the changes in the state to the Game Servers 405. After the race, only the NPS system heartbeat remains to keep the channels of communication flowing freely. As time goes by and activity slows, this heartbeat slows down too until only a faint pulse remains.

This dynamically adaptive quality is an important element of the NPS. Unlike the mechanical transmission of a fixed heartbeat every 0.8 seconds or so (which might be likened to a pacemaker set to a fixed rhythm), the Grid transmits heartbeat packets as are generated dynamically on demand. These heartbeat packets contain special information that the system requires to provide a thin reliability layer on top of the underlying networking protocol (e.g., RFC 768).

The principles of the Network Protocol Stack are as follows:

a) Essentially stateless protocol, packets are processed independently of each other.

b) No positive acknowledgment of successfully received data.

c) Serial numbering provides unique identifier for each bit of data.

d) Lazy heartbeat generation tries to maximize the time between heartbeats.

e) Maintaining group counts provides a way to know what has already arrived.

f) Receiver reliable protocol puts burden of checking for missing data on receiver.

g) Retransmission requests contain only the knowledge of which the receive is sure

Since the network protocol underlying the Network Protocol Stack is that of the User Datagram Protocol (UDP), there are a few restrictions on the NPS. In one embodiment, the UDP packet size cannot be larger than 512 bytes, including all headers as well as the game data payload itself. Most routing hardware on the Internet can only guarantee that packets up to 512 bytes in total size will NOT be fragmented or broken up into smaller pieces along the way to delivery. Obviously, once routing hardware can guarantee that larger packets will not be fragmented, larger packets can be transmitted.

Since UDP packets are not guaranteed reliable, some may be lost due to network congestion and may need to be resent. In addition, the order of packet delivery is not guaranteed, so some means of determining the order in which received packets were originally sent is desirable.

FIGS. 29B-35 provide an overview of NPS operation as follows:

FIG. 29B illustrates the NPS transmission protocol, and more specifically, a sequence of packets being sent from clients 0 and 3 to Game Server 405. In this case, both packets were unreliable, i.e., “false”. This figure illustrates the protocol of how packets are divided into heartbeats, when heartbeats are sent, and how the heartbeats slow down when no additional packets are sent.

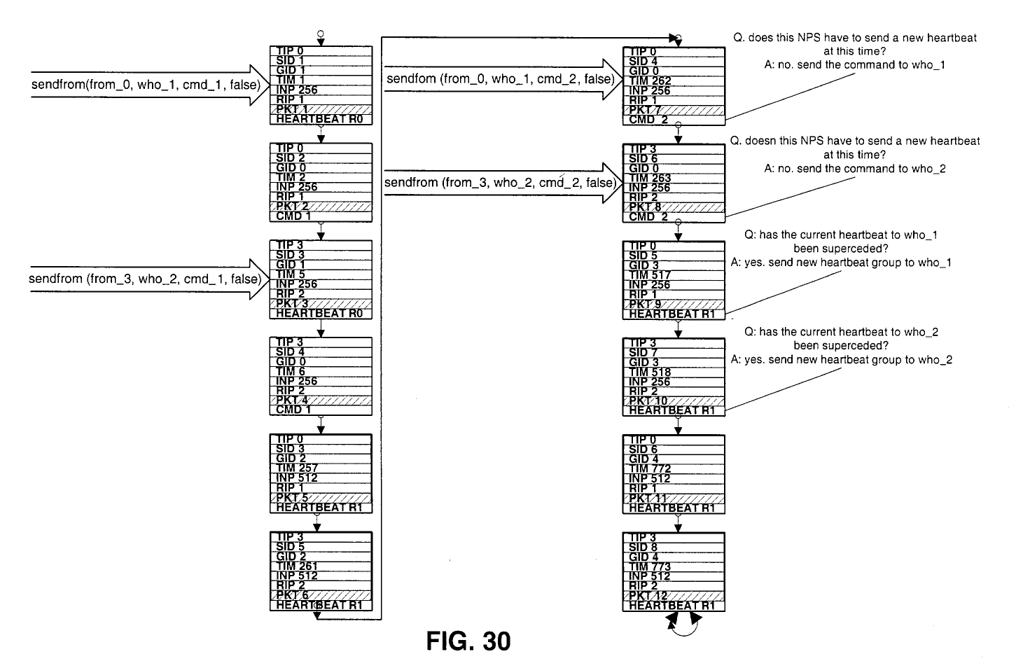

FIG. 30 illustrates the situation of what happens when more packets are sent after an interval. In FIG. 29B, the heartbeats were slowing down, since no packets were sent. With new packets being sent, the heartbeat interval drops back down to the smallest increment of time.

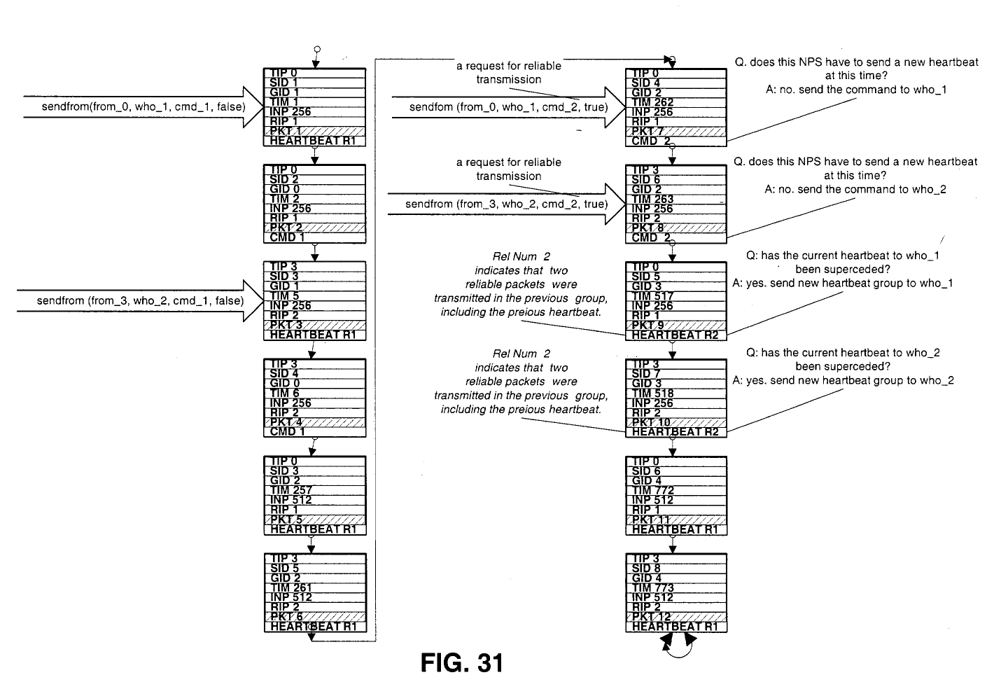

FIG. 31 shows the situation of two unreliable packets being sent (on the left of the figure) followed by two reliable packets being sent (center of the figure). In other words, FIG. 31 illustrates the case of reliable transmission of packets.

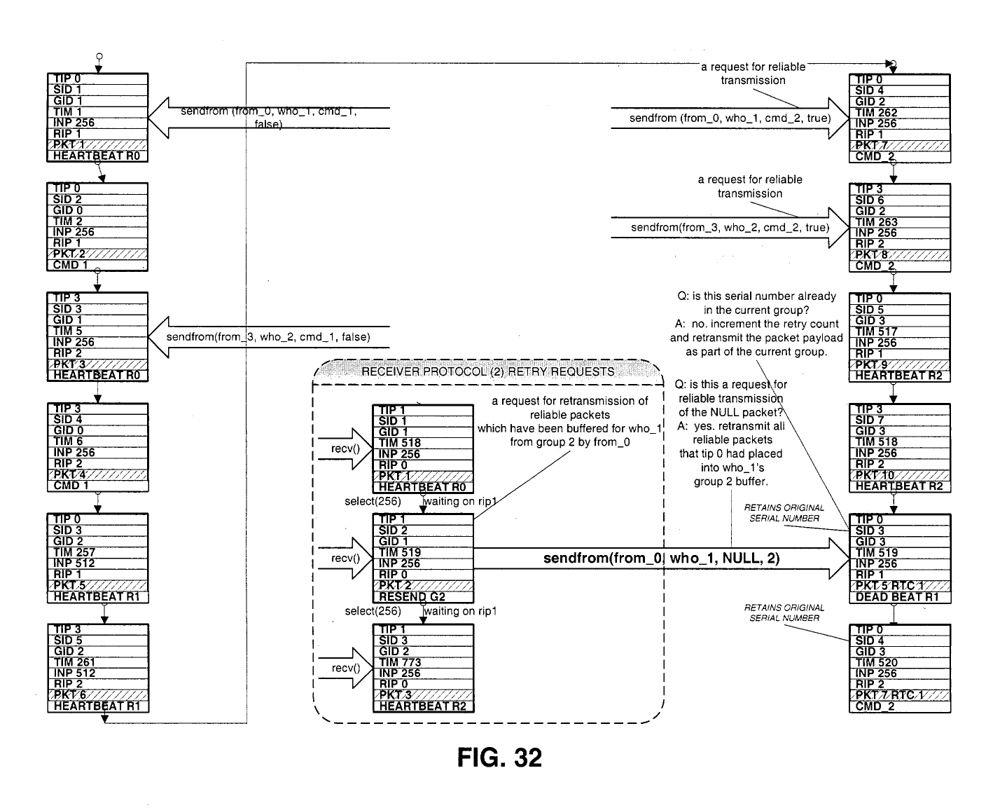

FIG. 32 illustrates packet transmission from the receiver's perspective. The first two packets received are unreliable, and the second two packets are reliable. In other words, FIG. 32 shows the receiver being notified of the existence of a lost packet, and the receiver therefore placing the request for that packet into the queue to be sent to the client, requesting that the packet be sent again.

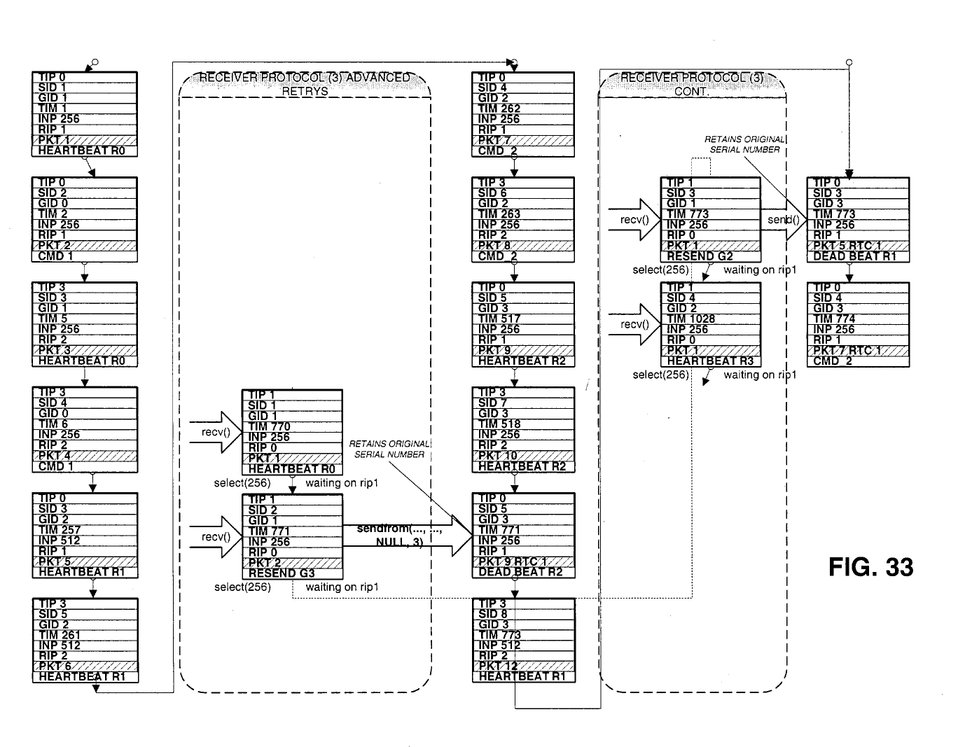

FIG. 33 illustrates the situation where a heartbeat was “dropped” by the system, and needs to be regenerated.

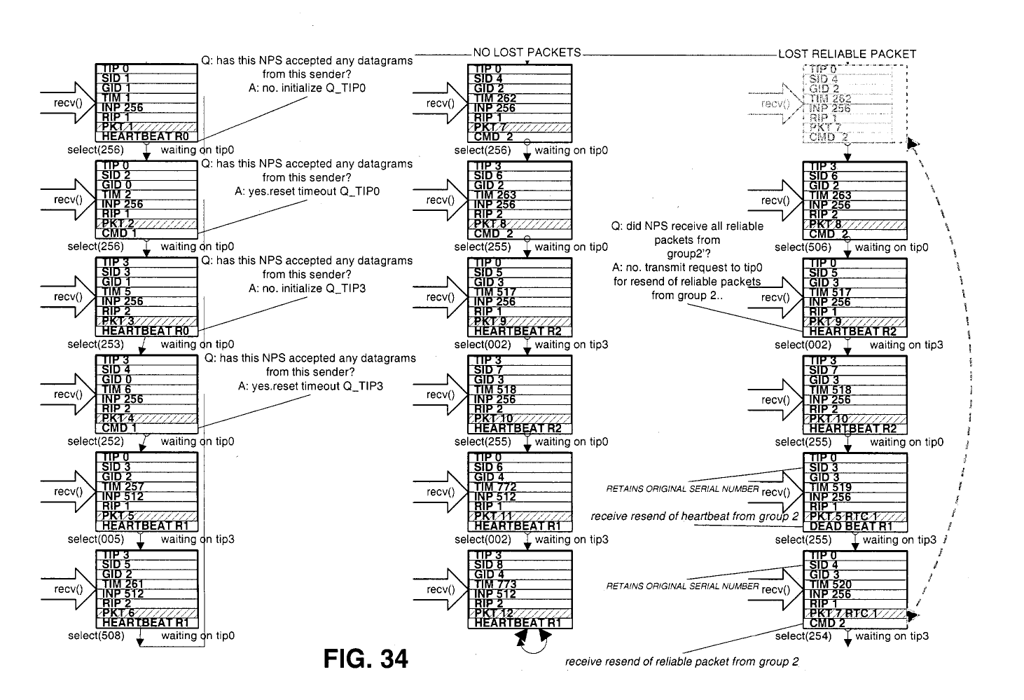

FIG. 34 illustrates the basic receiver protocol for receiving packets from clients. The left portion of FIG. 34 represents the conventional case of packet transmission. The center portion of the figure represents the case of no lost packets (here, no lost reliable packets). The right portion of the figure shows what happens in the case of a lost reliable packet. See also FIG. 32 for additional illustration.

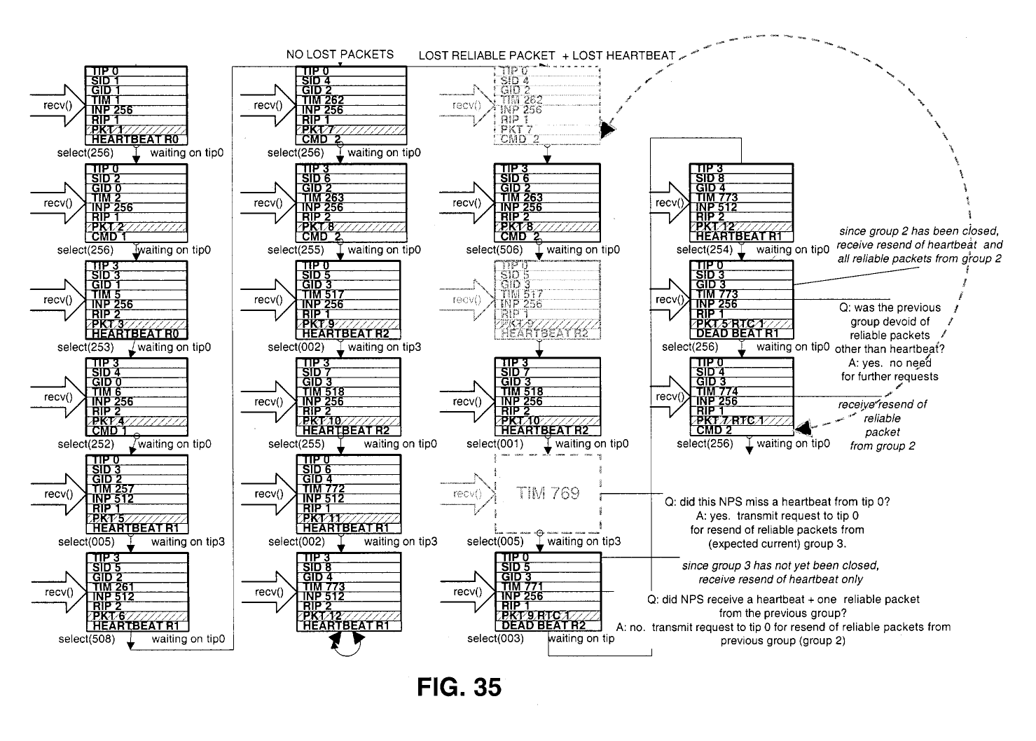

FIG. 35 is a illustration of a variation on the scenario of FIG. 31, with the addition of a lost heartbeat packet in addition to lost reliable packets.

b. The Packet Header

In one embodiment, every Grid packet is a UDP packet, and begins with a standard UDP header of 8 bytes containing the port from which it was sent, the port to which it was directed, the length of the packet in OCTETS (multiples of 8 bytes) and a checksum to validate that the contents of the packet have not been intentionally changes or otherwise modified en route. User Datagram Packets do not restrict the remaining data contained within the packet in any way other than length. However, in order to structure and interpret the game packets, and to distinguish them from any other UDP data, Packet Headers are used.

To build a more robust protocol on top of UDP, the Grid adds 24 bytes of overhead to each packet sent, containing just data required to maintain reliability on demand. These 24 bytes define the Packet Header, a data structure particularly useful in distributed online gaming.

Immediately following the standard UDP header, every packet therefore maintains a Packet Header with the following fields (see FIG. 28):

SID (serial identifier): a monotonically increasing 32 bit serial number uniquely identifying this packet.

GID (group identifier): a monotonically increasing 16 bit serial number identifying the heartbeat group to which this packet belongs.

INP (interval to next packet): a 16 bit field that indicates the maximum number of milliseconds remaining until the next data or heartbeat packet is expected to arrive. When the system is quiescent and no game packets have been generated since the last heartbeat, this inter-packet period is doubled each time another heartbeat is sent, up to a fixed maximum, further reducing the average overhead associated with system traffic.

TIM (time stamp): this 32 bit field specifies which millisecond of the current week this packet was initially transmitted. Legal values for this field range from 0 to 604,799,999 decimal (from 0x0 to 0x240C83FF hexadecimal).

TIP (transmitter IP address): 32 bit IP address of the sender of the packet. Together with the 16 bit source port from the UDP header, uniquely identifies where to send replies to this packet, if necessary.

RIP (receiver IP address): 32 bit IP address of the receiver of the packet. Together with the 16 bit destination port from the UDP header, uniquely identifies the intended route by which the packet was directed to this receiver (note that multicast packets will have a class D IP address 224.0.0.1 rather than the actual IP address).

SYS (system control): an 8 bit field that indicates the type of packet. This field is NULL for a system packet (which includes heartbeats). Some other values include PACKET_GAME (for reliable packets) and PACKET_USER (for unreliable transmission).

NUM (multipurpose count): a 16 bit field that is used for various counts. For heartbeat (SYS==NULL) packets this is the number of reliable packets that were transmitted in the previous heartbeat group, including the previous heartbeat itself. For retransmission requests, this count is the group identifier of the requested re-send. For normal, everyday game packets, this field includes the game identifier (a non-zero number assigned by butterfly.net that uniquely identifies the current game to which this Packet is being directed.

RTC (retry count): an 8 bit field that is only non-zero when this packet represents the retransmission of a packet that had been previously lost.

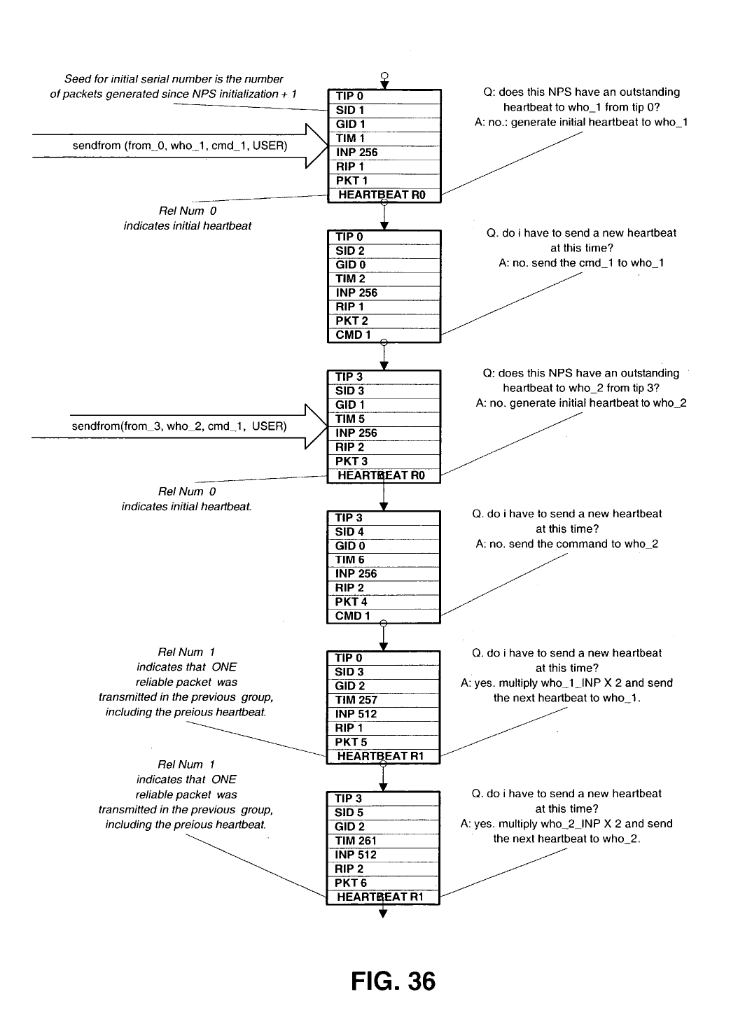

The inter-packet period thus determines how much system overhead must be devoted to transmitting heartbeat packets relative to game (reliable) and user (unreliable) packets. Every time a game or user (data) packet is received, its inter-packet period field signifies how long the system can safely wait without hearing from the sender (see FIG. 36).

The system expects either another data packet within INP milliseconds or else a heartbeat packet within the same period. Recording the serial numbers (SIDs) of the game and heartbeat packets as they arrive, the system can keep a count of how many reliable packets were received within the current group (GID). As long as the time gap between data packets is less than INP and the current group is not full, no heartbeat packets need to be received at all. Only when there is no additional data for INP milliseconds is a heartbeat packet generated and transmitted by the sending NPS process, thus to be received by the NPS listening at the destination port.

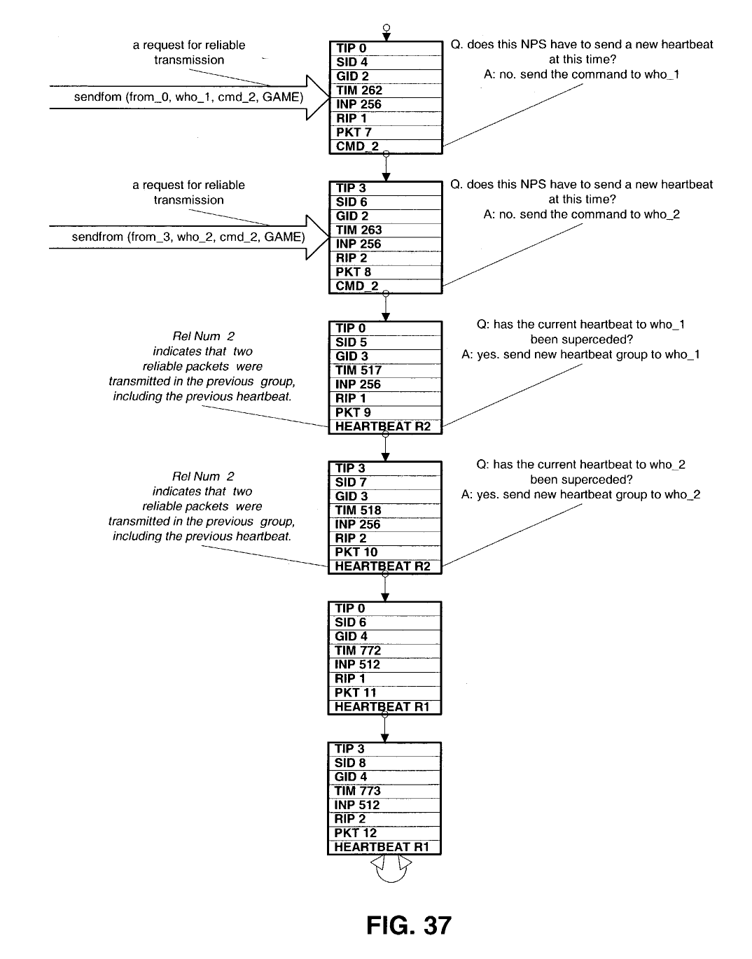

This leads directly to a method to determine when packets have been dropped or lost in transit and for the receiver NPS process to request retransmission of lost packets. For every heartbeat packet that arrives, the NPS first determines how many reliable packets were transmitted in the previous heartbeat group (see FIG. 37). This information is provided in the NUM field of each heartbeat packet. Next, the NPS compares its running count of how many reliable packets were received for that group. If the two counts are the same, no packets have been lost.

If the NPS recorded the serial numbers of fewer packets than indicated for the preceding group, it can send a retransmission request (a special type of system packet) back to the original transmitter's IP and PORT combination. The body of this retransmission request is just a list of serial numbers of the packet that were successfully received. Those serial numbers that are not in this list were either those of one of the unreliable transmitted packets (user packets) or are those of reliably transmitted packets that were dropped in transit. The receiver has no way of determining the serial numbers of which packets were dropped, only those that made it through all right.

However, the sender NPS is quite capable of discriminating between accidentally lost and intentionally unreliable packets. When it gets a retransmission request, it can and does send the missing serial numbered packets again, as part of the first new outgoing group available, incrementing the retransmit field (RTC) as it does so. It can preserve the original serial number of the retransmitted packets as long as the retransmission field is set to a non-zero value, allowing the NPS client at the final destination to insert the missing packet into the original data-stream as required.

This demand based heartbeat group generation and packet retransmission protocol overcomes one of the basic limitations of any positive acknowledgment scheme. By selectively generating retransmission requests at the receiver, the “nominal” case generates the least overhead: only when retransmission is required is additional burden incurred. In other words, only when additional heartbeats are required are they generated at all. And the longer the system maintains a quiet state, the quieter system traffic becomes.

As long as the receiver is satisfied that everything important has arrived satisfactorily, it keeps quiet. As soon as it determines that something is missing, it gives the transmitter useful feedback in summary form. When the receiver has done what it can to provoke the retransmission of the missing information, it is free to forget totally about the retransmission request until either the missing information appears in the next data group or until the sender requests a re-send of the retransmission request itself.

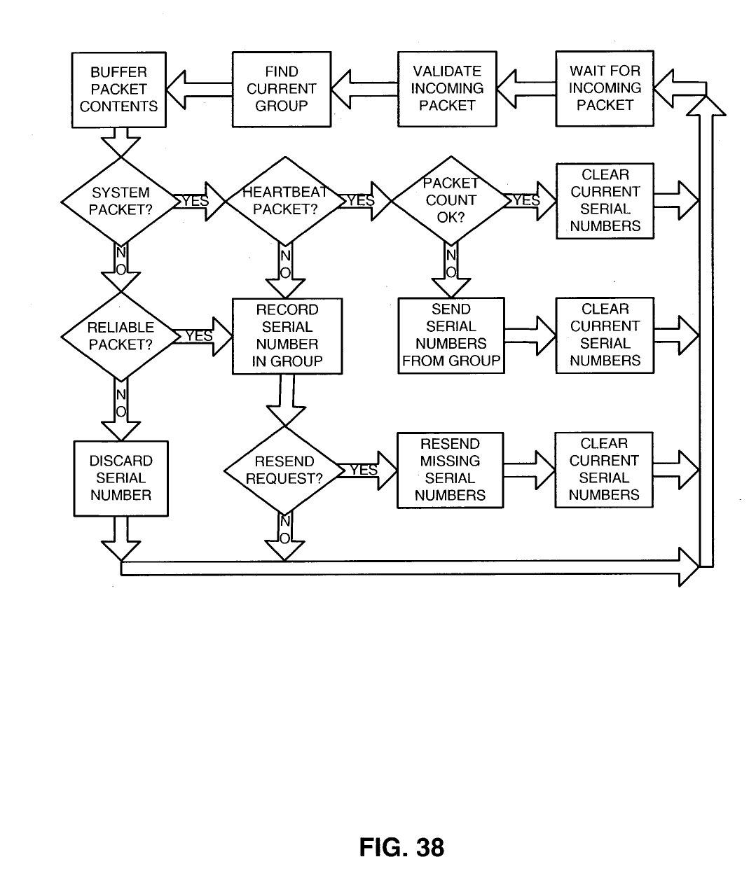

With this process, except for simple housekeeping, the protocol is essentially stateless. As each incoming packet arrives, the receiver checks whether it is a data packet, a heartbeat, or a retransmission request. If the packet is reliable, its serial number is entered into the current group. If the packet is a heartbeat, the current group count is compared against the reliable count provided. If they don't match, the serial numbers are formatted as a retransmission request and sent right back to the original sender. Then the NPS goes back to waiting for the next incoming packet, and processing starts again (see FIG. 38).

By allowing selected individual packets to be marked reliable, the NPS strikes a balance between overhead (both in usage of buffer memory and in maintaining state) and overall reliability: packets that make a substantial difference to the object state (‘bang bang you're dead’) are guaranteed delivery, while those that are superficial (‘it's only a flesh wound’) can be sacrificed if need be in the name of bandwidth mitigation.

The game designer decides which packets are non-essential for game-play purposes under circumstances of high load or network lag. The Network Protocol Stack is context agnostic, and does not impose a restriction on how many reliable packets may be sent, or in what order. Game developers who wish to make every detail of their world essentially reliable at all times will obviously incur more overhead that those who are willing to sacrifice a step or two along the way, as long as any errors along the way cancel themselves out in the end. The key elements to consider here are the timeliness and priority of the message.

c. Packet Payloads

Thus, every packet includes a Packet Header, as discussed above with reference to FIG. 28. In order to pass game data (properties, commands, messages, etc.) through the Network Protocol Stack each data packet requires one or more payloads as well. A payload is a “wrapper” around actual game data itself.

The payload is game data formatted in a particular way. The Network Protocol Stack is able to validate the format of individual packet payload without knowing or caring what the contents actually represent. The invariant properties of packets are the means that allow the syntactic validation (is the data “well-formed”?) of packet payload without requiring semantic validation (is the data meaningful?) below the level of the game itself.

As long as the packet meets the invariant criteria for being well-formed, it can carry any message whatever: whatever the game designer can imagine, whatever the game developer can code, whatever the user can enter at the keyboard. The first invariant property has already been discussed: packets should not be more that 512 bytes in length, until the next iteration of the Internet (Ipv6) becomes a reality.

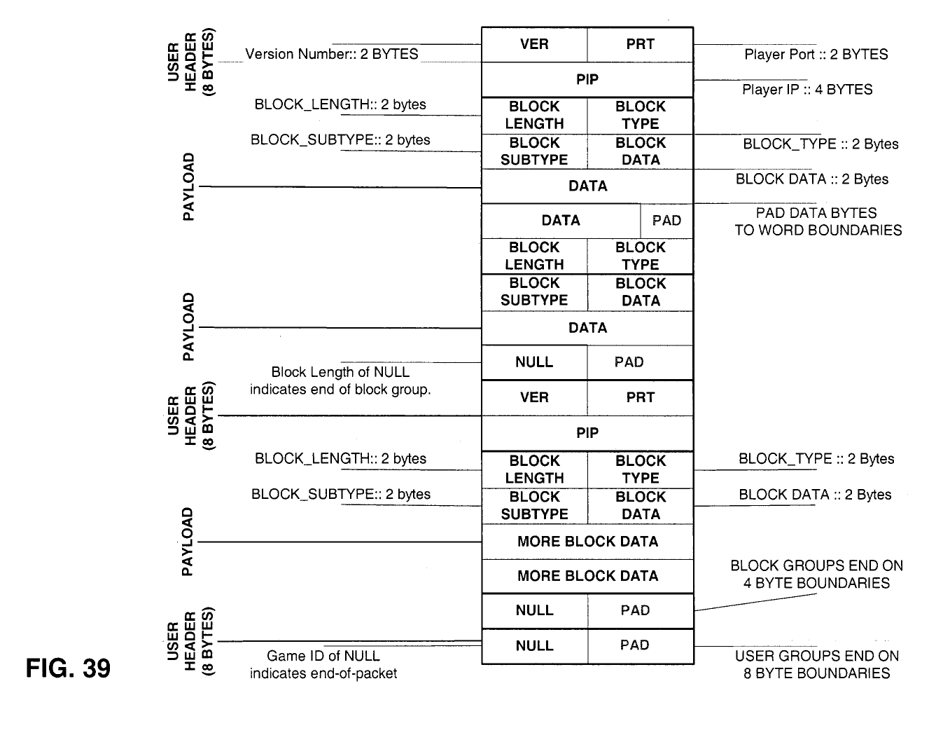

A payload begins and ends with a User Header and continues with one or more blocks of data (see FIG. 39).

The User Header itself server two purposes: versioning and routing. The validation mechanism in a User Header uses a non-zero 16 bit “version” field in each User Header. This version field indicates the revision level of the payload itself. Unless this version number exactly matches the run-time (currently executing) version of the game at the time it was launched on the Game Server 405, this payload will be considered “out-of-date”. If the payload version passes this validation test, the remainder of the User Header includes routing information (an IP address and port number) relating to the data contained within the payload itself. Replies regarding the data in this particular payload can be sent via this route back to the originator of the data.

The User Header doesn't say how many data blocks the payload includes, but merely tells the Network Protocol Stack to expect one or more data blocks (conforming to a particular game version) immediately following this header.

The data blocks contained within the payload are self-describing: each block BEGINS with a block-length field stating how many bytes of data are contained within the block itself, including the block-length field.

The last block in each payload begins with a special length of 0, indicating that it is “empty”. Thus, without knowing in advance the type of data contained within each block or even how many blocks are contained within this payload as a whole, the NPS can scan through the payload, validating that the data blocks are “well-formed” without any a priori knowledge of their meaning within the context of a specific game. If the sum of all the headers and the individual block lengths found in this packet exceed 512 bytes, something is wrong and the packet is not well-formed. The likelihood of random, or garbage data being recognized as “well-formed” by mistake becomes exponentially small the larger the number of blocks in the payload becomes.

If the NPS has well-formed User Headers and well-formed data blocks, the NPS accepts the packet as a valid packet and passes it on to the game itself, which can then perform the more rigorous work of semantic validation at its leisure.

d. Block Formatting

As indicated above, the Network Protocol Stack does not need to interpret the contents of the actual blocks of payload data as they are circulated through the system: it performs basic syntactic validation (is the data the right size? does it conform to the current version?) without needing to know what object state the packet data represents. This is necessary to maintain the state of being context agnostic.

However, even though proper packet syntax is necessary, it is not sufficient from the standpoint of a useful game system. After all, the purpose of the payload is to carry information from client to Gateway 401, Game Server 405 to Game Server 405, Game Server 405 to client, and so forth.

If the Grid were not context agnostic, it might be reasonable to assume that the format of the data blocks could be left completely free and unrestricted. However, at a game system level, it is important to recognize the need for interoperability and extensibility. Thus, the Block Data is used to marshal object state throughout the Grid.

Referring again to FIG. 39, the format of a data block may include:

a) Block Length (2 bytes): a field specifying how many bytes of packet space this block occupies. This field is an even value, and includes itself when specifying the block extent. A block length of 0 indicates that this is the NULL (or terminal) block in a list of consecutive data blocks. This is the only part of the block data that the NPS is actually concerned with. It assumes that if the Block Length conforms to all other packet size and alignment restrictions, then the remaining block data can be safely buffered and passed on to the client, who is expected to semantically validate and interpret that following fields.

b) Block Type (2 bytes): a field indicating the main category of this block data. Examples are AUTHENTICATE, SELECT, EMBODY, ACTIVATE, SYNCHRONISE, and LOG data block types. A block type of BLOCK_NULL indicates that this is the NULL (or empty) data block and can be safely dropped or ignored.

c) Block Subtype (2 bytes); a field describing the particular purpose of this block data. For example, if the Block Type of this block was [EMBODY], the Block Subtype might be AVATAR_INIT, AVATAR_SAVE or AVATAR_EXIT. A block subtype of AVATAR_NULL is provided to round out the choices.

d) Block Data (from a minimum of 0 to a maximum of MAXBLKLEN bytes): This field is the actual Block Data itself and its meaning will vary based on the combination of Block Type and Block Subtype specified above. For example, in the case of [EMBODY::AVATAR_SAVE] the Block Data is the globally unique identifier (GUID) of the Avatar needs to be saved in the persistent-state database.

With these additional restrictions on the format of the payload block data, the Network Protocol Stack can perform its job quickly and efficiently. The NPS can receive, transmit, and validate packets. It can discriminate between essential and non-essential data; it can request retransmission of data that has become lost or corrupted in transit. It can guarantee that only properly versioned and formatted packets are forwarded to the game itself. It can do all this in a context agnostic manner, leaving the interpretation of the actual object state to the specific games that are up and running in the current environment.

e. Game Buffers and the NPS Game List

The Network Protocol Stack also needs to pass incoming packets to the game itself. The NPS Game List provides this mechanism to clients.

The NPS buffers the packets in a CGameBuffer object for the client to process as soon as it has the time. Since the Network Protocol Stack operates asynchronously to the client code itself, this buffering mechanism provides a way for incoming messages to be stored until they are no longer needed and may be deleted to free additional memory space in the system.

/**********************************************************/

*An example of interfacing with the Network Protocol Stack via the

CGameBuffer
***********************************************************/

| | |
|---|---|
| #define THIS_GAME_NUMBER 1 | // my first |
| game | |

| | |
|---|---|
| CNPS *nps = new CNPS(“mothGrid.butterfly.net”, “9632”); | // create |
| the NPS | |

| | |
|---|---|
| CGameBuffer *game_p = new CGameBuffer(nps); | // get |
| GameBuffer | |

| | |
|---|---|
| game_p−>setID (THIS_GAME_NUMBER); | // mark |
| for my game | |
| nps−>game_list_p−>addTail(game_p); | // add it |
| to the nps list | |
| game_p−>bufferOn( ); | // allow |
| it to fill up. . . | |

/**********************************************************/

The CGameBuffer forms a first-in first-out (FIFO) queue of packets, which are stored in a SafeList structure for multi-threaded safe list processing. The SafeList is a doubly linked list that includes internally buffered ListNodes and that allows recursive locking by a single thread at a time. Access to nodes in the list is arbitrated by creating a SafeList Iterator (listIter) and processing the nodes in order until calling nextNode on the listIter returns NULL.

/**********************************************************/
* An example of processing the GameBuffer list in a multi-threaded
environment
***********************************************************/
while (!nps−>abort_flag)
{

| | |
|---|---|
| CGameBufferListIter *game_list_iter; | // multi-threaded SafeList |
| | iterator |

```
  if ((game_list_iter = nps−>game_list_p−>listIter( )) != NULL)
// list locked here
  {
    while ((game_p = game_list_iter−>nextNode( )) != NULL)
    {
```

if(game_p−>getID ( ) == THIS_GAME_NUMBER)
{
game_p−>drain(process_packet); // call process on each packet

drained

}

}

| | |
|---|---|
| delete game_list_iter | // deleting the listIter unlocks the |

list
}

| | |
|---|---|
| sleep (100); | // wait a bit before trying |

again. . .
}
/**********************************************************/

The CGameBuffer mechanism adheres to the classical producer/consumer model for handling messages between threads. The NPS asynchronously receives packets as they arrive at the system port; by definition the arrival of new packet data is unpredictable (while a heartbeat is guaranteed within the expiration of the current inter-packet period, new packet data may arrive at any time). By placing the incoming messages in a FIFO queue, the Network Protocol Stack assumes the role of data producer.

The client, on the other hand, is the ultimate consumer of packet data. By draining the GameBuffer packet queue periodically, the processed packets are removed from the message queue freeing space for more data to arrive. While there is no hard limit on how many packets may be stored in the queue at any one time, the more packets are maintained on the internally buffered queue lists, the more high-water memory allocation for this process requires. For that reason, it preferred that the client thread drains the NPS packet buffers on a regular basis and discards the processed messages as soon as possible.

4. The Object State Propagation Subsystem

The transmission and mediation of object state is an important sub-system in establishing a shared, high-performance environment.

In one embodiment of this invention, the object state can be gathered from users of the system, from monitoring devices, etc., and will need to be re-transmitted to other subscribers of the system. To support this in a scalable way, the embodiment described herein uses the Gateway 401 to act as “intelligent routers” of object state information.

As a client connects to the grid, they can connect to any Gateway 401 that is in service. After authentication and authorization, the Gateway 401 acts as proxy for the client to the Game Servers 405. There can be a plurality of Game Servers 405, each of which are responsible for the management of a segment of the environment. If, in the course of using the Grid, the participant's state changes in such a way that they need to be served from a different Game Server 405, a MOVE request can be transmitted to the Gateway 401 (from the current Game Server 405), at which point the Gateway 401 will begin its proxied communications to the new Game Server 405. This process is transparent to the client device or user. As the NPS in this embodiment employs a UDP-based protocol, the overhead associated with the termination of a session with one Game Server 405 and the establishment of a session with another Game Server 405 is negligible. On the back channel, communications between the Game Servers 405 can prepare the Game Server 405 that is to take over communications with a given client, so that it is ready (and expects) the transmissions from the client when the change takes place.

This embodiment partitions the environment, and allows a plurality of Game Servers 405 to manage and mediate the problem space, but the object state propagation system makes this segmentation transparent to the end user. Object state information can be transmitted between the Game Servers 405 when object state resident on one Game Server 405 is needed by a client that is proxied to another Game Server 405. To better explain this, an example based upon geography will be presented.

If the environment is partitioned geographically, different geographical regions can be assigned to different Game Servers 405. In this embodiment, space is partitioned into convex polyhedra, as it is computationally easy to determine whether an object lies within such a polyhedra. One need only determine that the object in question lies on the correct side of each bounding plane to determine that the object lies within the bounding region. It should be apparent to those skilled in the relevant arts that the constraint of keeping the polyhedra convex is a computational nicety (because such a containment test is not true for an arbitrary polytope) and can aid in scalability of the system, but such a constraint is not a limitation of the present invention.

Furthermore, in the embodiment, adjacent Game Servers 405 will create “sentries” (sentinels) along the border between adjacent bounding regions. The sentinels act as message sinks for object state information that is relevant to the geographical area. The sentinels allow the object state information to flow from Game Server 405 to Game Server 405 across what could otherwise be an arbitrary partition. For performance reasons, the implementer of such a system would choose bounding regions to minimize cross-server communications, but by allowing this flow of object state information, the Game Servers 405 act in concert to form a system that is seamless and arbitrarily extensible.

The sentinels (i.e., message sinks) can be extended to end-clients, and are herein described as “Embodiments of Interest.” A user has a communication port into the Game Server 405 that is controlling the portion of the environment that includes the representation of the user (which is referent to as their “Embodiments of Record”), but these Embodiments of Interest act as channels for the transmission of object state to users from Game Servers 405 to which they are not directly proxied. To extend the geographical example, as a user moves within a virtual environment, he approaches the sentries of servers that control adjacent regions. If the application logic dictates, the Game Servers 405 will create an Embodiment of Interest for the user on themselves, and these embodiment will be utilized to send object state from the Game Server 405 in question to the client device or user. If the user crosses into the bounding region of the Game Server, the embodiments are swapped: the Embodiment of Record now becomes the embodiment on the new Game Server 405, and the Gateway 401 is instructed to now proxy to the new Game Server 405.

While a geographical example is presented above, it should be apparent to those skilled in the relevant arts, that this concept can be applied to an abstract state-space. For performance and partitioning reasons, this abstract space should preferably have the following attributes: 1) a distance metric should be available or constructed, and 2) the propagation of object state should be in some way dependent upon rules applied to this metric. If these criteria cannot be met, cross-server communication will adversely affect the scalability of the system.

a. Marshalling Object State

When clients' states are widely dispersed, the object state of objects needs to be transmitted and maintained over the network while respecting the requirement that their essential identities are carefully preserved. The end result is that the appearance and behavior of the object at the receiving end is the same as that at the transmitting end. Thus, each game character or object can play the same role and obey the same rules for every client, no matter how remote they are distributed in space.

To achieve this, objects themselves need not be transported. Rather it is their state (the individual values that measure and describe their appearance or behavior) that must be transmitted across the wire. However, there is a conflict between the Grid remaining context agnostic and yet not trusting the client to transmit legal object state, that is, not trusting the client to enforce the rules. The Game Server 405 cannot restrict the appearance or limit the behavior of any particular game. At the same time, it must validate that the values that represent object state are limited, and legal values are restricted to an acceptable range.

Every “Thing” is defined to be an assemblage of basic building blocks, and every block is numbered and labeled with its essential “type” (out of a small list of basic types). Thus its essential configuration is cataloged at the transmitting end. This catalog is divided into reasonable chunks and is then stuffed into individual packages (packets) that in a sense carry the “identity” of the object. Somewhere at the receiving end, the reconstituted catalog may be followed as a recipe for creating up a new object. Since the building blocks that make up the reassembled object are identical to those that constituted the original “Thing,” its appearance and behavior should conform to that of its model. At the same time, the number and base type of each building block may validated for authenticity against the small list of basic types mentioned above. This is divide-and-conquer strategy in action.

b. Passing Values as Data Sub-Blocks

Values that describe the appearance or behavior of individual game objects are marshaled in the Grid as data blocks, typically within packets of block type:

ACTIVATE::THING_NEW (for newly instantiated objects) or

ACTIVATE::THING_SET (to modify the properties of existing objects).

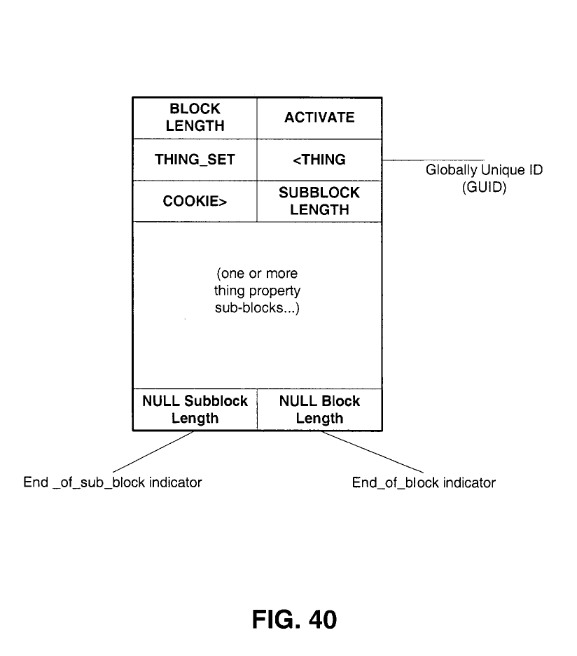

Each block of sub-type THING_SET begins with a 32-bit “cookie” with a Globally Unique Identifier (GUID) for the Thing to which the following property sub-blocks apply, as shown in FIG. 40.

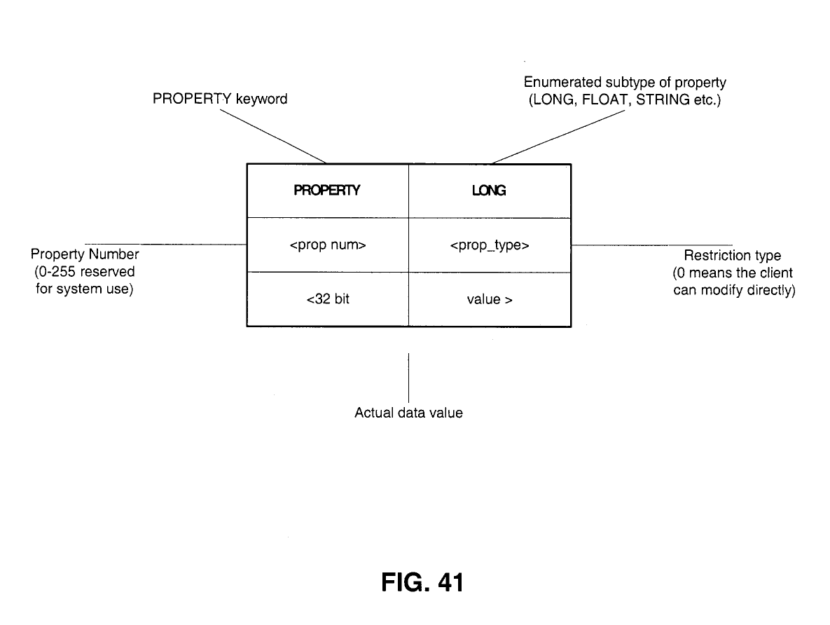

Following the Thing GUID are one or more data sub-blocks, each beginning with a sub-block length and continuing with the PROPERTY keyword and the sub-block type, as shown in FIG. 41. The building blocks for the Grid data sub-blocks are these basic sub-types:

PROPERTY LONG (32 bits)—a signed integer value

PROPERTY_FLOAT (32 bits)—IEEE single precision floating point number.

PROPERTY_VECTOR—an ordered triplet of IEEE single precision floating point numbers.

PROPERTY_ENUM (16 bits)—an unsigned short integer value.

PROPERTY_STRING (variably sized)—UTF8 compatible, non-null terminated counted string value.

PROPERTY_TOKEN (64 bits)—two 16 bit and one 32 bit data field (special purpose).

In addition to the basic data types, other lists of basic types are also supported:

PROPERTY_LIST_LONG—a list of property_long

PROPERTY_LIST_FLOAT—a list of property_float

PROPERTY_LIST_VECTOR—a list of property_vector

PROPERTY_LIST_ENUM—a list of property_enum

PROPERTY_LIST_STRING—a list of property_string

PROPERTY_LIST_TOKEN—a list of property_token

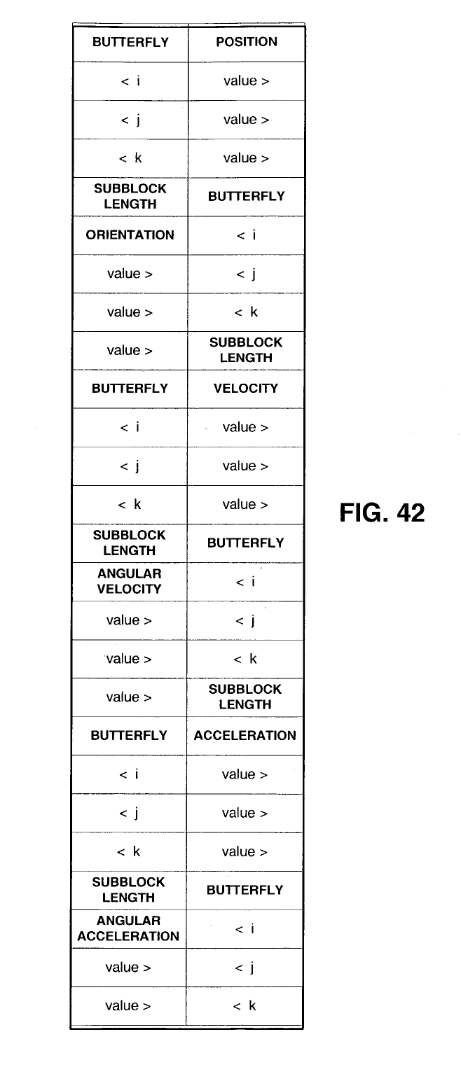

Furthermore, in addition to game properties specified by the game designer, every Thing additionally subscribes to specific properties that are common to every Grid game object, as shown in FIG. 42:

POSITION (vector)—Euclidian position for this object.

ORIENTATION (vector)—rotation for this object.

VELOCITY (vector)—linear motion for this object.

ANGULAR VELOCITY (vector)—rate of roll.

ACCELERATION (vector)—rate of change in velocity.

ANGULAR_ACCELERATION (vector)—change of rate of roll.

RANGE (float)—perceptive extent of this object.

PRESENCE (float)—bodily extent of this object.

ACTIVE (long)—sensitivity to the environment (does this object receive messages and act upon them independently)

REGION_TYPE (enum)—shape of extent (by default, a spherical region centered on the object itself).

Note that these properties, while possible for every Grid object in every Grid game, are not present in every packet transmitted. Only those properties that are “dirty” (or have changed) since the last state update are scheduled for serialization and transmission to clients. This process of transmitting a primarily “dirty” object state is one of several mechanisms used to minimize the number of bytes in each packet and the number of packets sent overall in the interest of minimizing network bandwidth requirements.

c. Passing References in Packets

Objects within a game have their own unique identifying number known as a GUID, or Globally Unique Identifier. The GUID value, 32 bits in length, is sufficient to distinguish one Thing from another. Every different instance of a type Thing has its own GUID assigned to it, which is invariant for the lifetime of the game world. Every sword has its own GUID, every dragon has its own GUID, even every tree (as long as it is a game object, even if it never moves or performs any particular action) has its own GUID. All these GUIDs are distinct from one another. Thus, with 32 bits, there can never be more than about 4 billion game objects (232) within a given game.

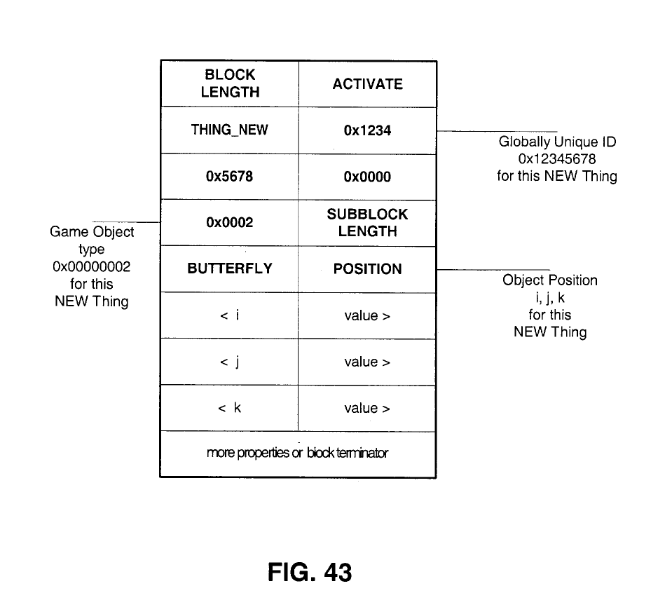

FIG. 43 shows an example of a game object of type 2. Being context agnostic, this Thing reference doesn't make any assumptions about what type 2 might represent in this game world. It might be a rabbit, or it might be a carrot, or it might be the earth that the carrot is growing in. The Grid framework doesn't know and doesn't care what the semantics of a type 2 game object are—it only cares about the properties of this object and that its GUID is 0x12345678.

The client, on the other hand, knows everything there is to know about type 2 objects in general and can display a picture of such a Thing at the given position with which the user may interact by clicking the mouse, angling the joystick, or pressing the trigger button. In other words, while the Grid is context agnostic, the client was designed to handle Things for this particular game, and it can evaluate the marshaled information in the game packet and respond appropriately. Every packet referring to GUID 0x12345678 can be assumed to carry state update information for this particular Thing and this object alone.

5. The State Aggregation Subsystem

The needs for state update between participants in an environment vary based of logical, geographical, or other considerations. For example, a human participant in a shared environment may need frequent state updates on objects in his or her immediate environment, but could get less frequent updates on objects that are more distant. In an abstract state-space, these considerations could be logical in nature, or they could be based on different distance metrics, but either way, object state should not be transmitted helter-skelter.

This embodiment employs a state aggregation subsystem to alleviate bandwidth and other performance considerations. Rules are applied based upon logical and distance metrics, and object states are aggregated for transmission when they meet these rules. This lowers per-packet overhead without adversely affecting the performance of the system. While this embodiment employs such a system for performance considerations, it should be apparent to those skilled in the art that object states need not be aggregated, provided that overall system performance can still achieve acceptable levels.

6. Rules Enforcement Engine

“Rules enforcement” is a term that is applied to the mediation and transmission of object state based upon logic (rules) as applied to object states and identities of the participants of the grid. Not all participants (be they human or machine) need or should be allowed to subscribe to all object states. Furthermore, rules enforcement can be used to constrain the object state of participants within the virtual environment.

The present embodiment uses a general scripting engine that has access to state of all objects on a Game Server 405, and can filter or constrain the transmission of object state based upon these values. An important function of rules enforcement is the prevention of a client from reporting their object state to be disallowed values. In an environment where the clients cannot be trusted (for example within a game or a security system), these rules become even more important.

As an example (which is meant to be illustrative and should not be taken to be a limitation of the present invention), a virtual environment can contain a terrain in which the participants move. This terrain can constrain the altitude of a virtual participant based upon their geographical location.

This embodiment takes this terrain and recursively subdivides it into smaller and smaller areas. For each subdivision, a minimum value of the terrain's altitude is calculated, as well as the equation of the best-fitting plane that describes the data-points within the region. If the error associated with the best-fitting plane is within acceptable bounds, the sub-area is not further divided. If it is not within acceptable bounds, the area is recursively divided until each area is acceptable.

The data thus generated are placed in a Quad-space Partitioning tree (which should be familiar to those versed in the relevant arts) and is in turn placed into a memory structure that allows efficient traversal. Thus, the tree can be traversed to find if an altitude reported by a client is acceptable. The described system has the advantage of graceful degradation: if server load prevents a full traversal, the tree can be descended as far as load allows. The further the traversal, the more accurate the answer as deduced by the Rules Enforcement Engine.

While the above example is presented in terms of a terrain, it will be apparent to those skilled in the relevant arts that this system can be applied to any scalar or non-scalar field. Provided that the field is sufficiently analytic or continuous, such a subsystem could provide great performance and scalability benefits.

Another example can be taken from the movement within a physical structure in a virtual environment (for example, walking within the representation of a building). The rooms of the building are decomposed into convex polyhedra (again, for a performance consideration and not as a limitation of the invention), and the location of these polyhedra are placed into a Binary Space Partition (BSP) tree. The tree can be constructed such that any partition of space has an acceptably small number of resident polyhedra. Thus is becomes computationally tractable to determine the containment relation for any participant (the containment of thousands of users is not difficult to manage with such a system using modem hardware). If the client reports a state update that changes their containment, the Rules Enforcement Engine can see if the transition is allowable. For example, if the client moves into a new room, the Rules Enforcement Engine can insure that they have sufficient authorization to be in that room, or even if there is a passageway connecting the room with their previous location.

From the above discussion, it should be apparent to those skilled in the relevant arts that the Rules Enforcement Engine described herein is flexible, high-performance, and useful in the mediation of state for a variety of problem domains.

Thus, the role of the Rules Enforcement Engine is to determine legal versus illegal client behavior. The rule might be as simple as “you can't have your dessert until you finish your dinner” or as complex as “unless you pay us a protection fee every month your next-of-kin can kiss their toenails goodbye,” but unless the Game Server 405 says it's so, it isn't so.

The client cannot decide the rules, since he can only be trusted to be untrustworthy when potential adversaries or hackers are at the controls. The Grid itself also cannot decide the rules, because that would make the rules of the game part of the Grid itself (i.e., non-context agnostic), and every time a rule changed, the Grid would have to be stopped, rebuilt, and restarted. Another mechanism is required to decide rules that modify the Server Things, while being flexible for testing and development, and bound at run-time rather than compiled into the Grid itself.

As one embodiment, the Grid has embedded the Python interpreter (see discussion below) as the core technology for the Rules Enforcement Engine. Python is an interpreted, interactive and object-oriented programming language, similar to Java. Python is powerful, portable, and flexible. Being an interpreted language, it meets the requirements for run-time binding of method invocations. Interactivity provides the means to be as flexible in the process of game development. Object-oriented programming means that Python is easy to access and powerful in performance.

Additionally, software development tools such as SWIG (a software interface generator) are available to connect programs written in C and C++ with scripting languages including Python. SWIG works by taking the declarations found in the header files of the Butterfly system, and using them generates wrappers that allow Python to access the underlying C/C++ code. Using such development tools allows embedding the core Python interpreter within the Grid.

Methods in Python are invoked according to a regular pattern:

module function (arg0, arg1, . . . )

Here are some examples:

utilities.grab ( . . . )—invoke the grab function in the utilities module to pick up an object and transfer it into your inventory.

butterfly.buy_a_duck ( . . . )—invoke the buy_a_duck function in the butterfly module to create a secure distributed transaction between buyer and seller.

These methods are bound dynamically to script files of the form module.py that reside on the Game Server 405 in a run-time Python directory. Each time the modulefunction( . . . ) is invoked, the Python interpreter checks the run-time directory to see if the definition of the function has changed. This allows the game developer to edit, test, or tune the Rules Enforcement Engine without recompiling any game code whatever.

7. Dead Reckoning System

The dead reckoning system is used to mitigate bandwidth needs in the transmission of object state. Each participant knows their current object state at any time, but they also maintain a model of themselves that mirrors models maintained by other participants. At any time, they not only know their own object state, but they also can deduce the perception of themselves by others. If at some point their true object state deviates sufficiently from the perceived object state, they will transmit a object state update that will in turn be re-transmitted by the Game Servers 405 to the appropriate subscribers. The model that describes the change in state in time for a given object class is the same for all participants. Thus, synchronization is assured.

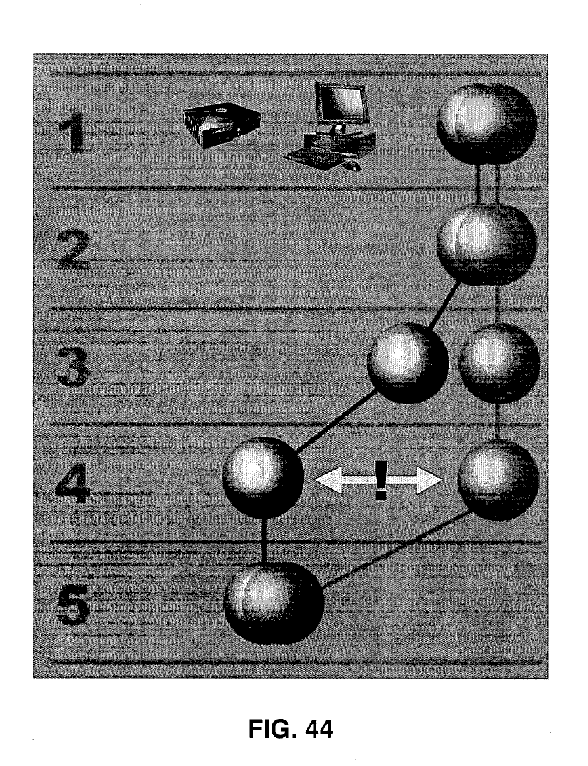

FIG. 44 conceptually illustrates a timeline for the dead reckoning model. The right-most four balls in FIG. 44 represent the assumption of first user about a second user's motion (i.e., the assumption is that the motion is in a straight line). When the second user starts to diverge from the predicted straight line motion, and the difference between the predicted position and actual position diverges by more than some epsilon (see region 4 in FIG. 44), then a packet is sent to the first user, informing the first user that the second user is really at position 5. For regions 2, 3 and 4, no message is needed to be sent, because the deviation (epsilon) as small enough. This allows conserving bandwidth, and minimizing message traffic.

As other examples of dead reckoning, a temperature sensor could be modeled as having a constant reading, or a mobile robot could be modeled as having a constant velocity. If the temperature changes or the robot turns, these will be dissonance between true state and perception, so that the sensor or robot will transmit its updated state, and other participants will begin reckoning based upon this new state. The temperature sensor need not constantly transmit data which is unchanging, and the occasional heartbeat packet from the NPS will assure the Game Servers 405 that the sensor is still functional and on-line.

It should be apparent that the dead reckoning system of this example embodiment is useful in conserving the bandwidth needed for communication to client devices and helps to reduce server load, but it is not a limitation of the present invention.

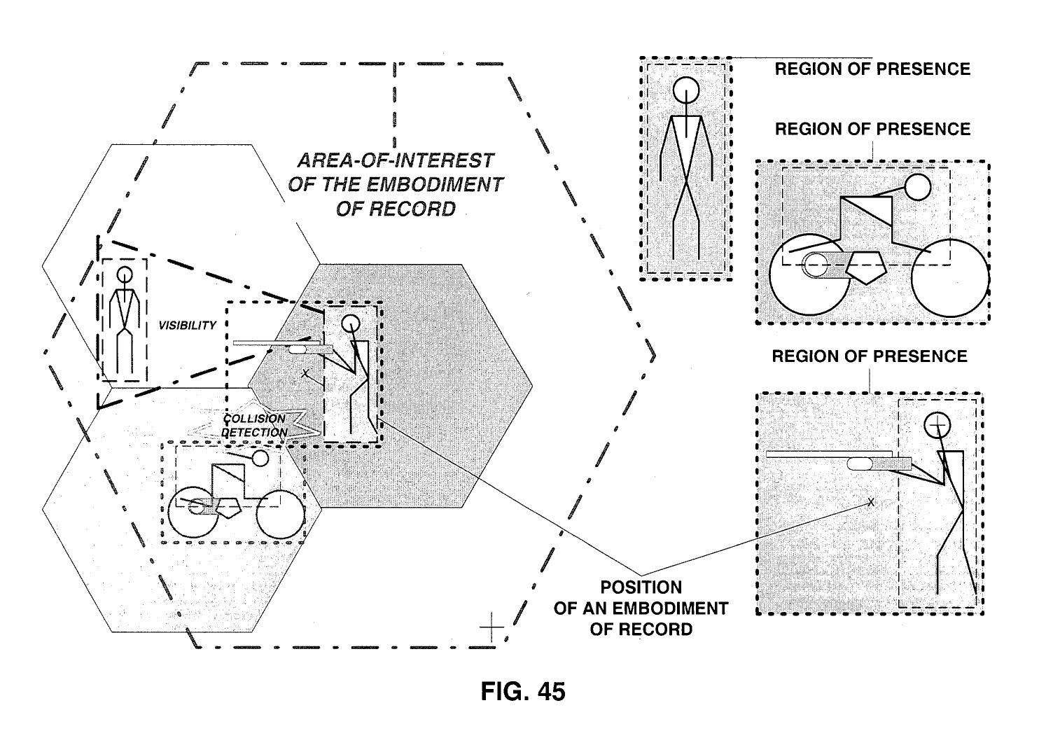

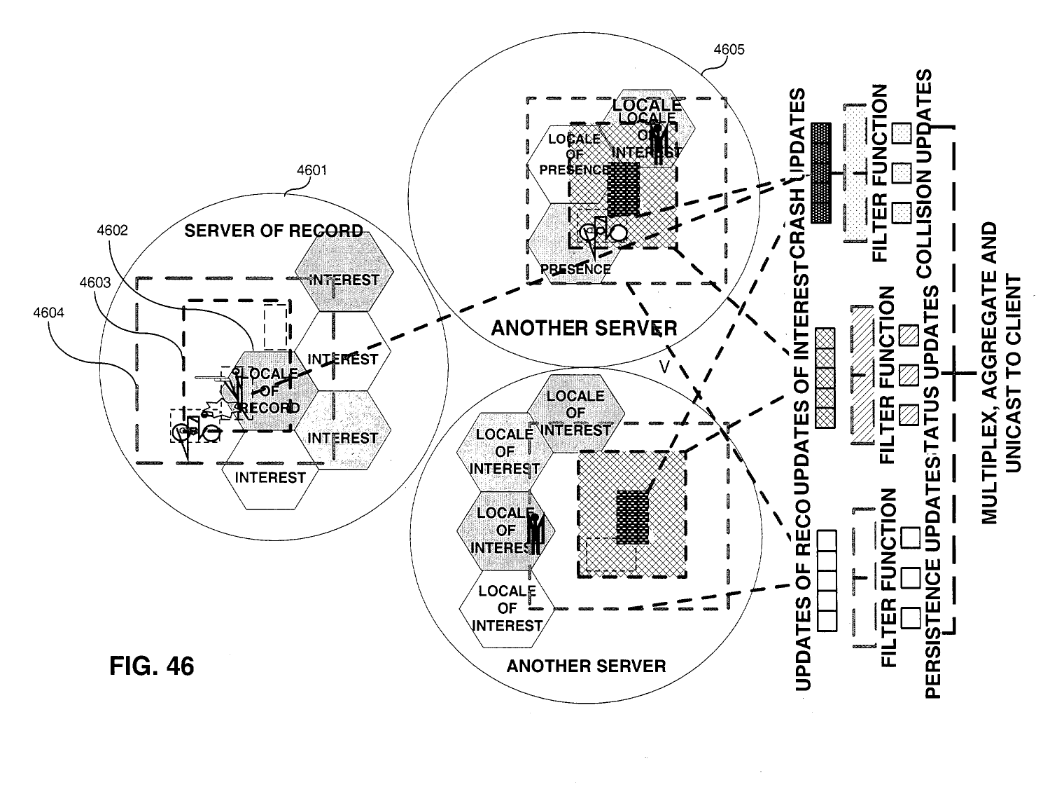

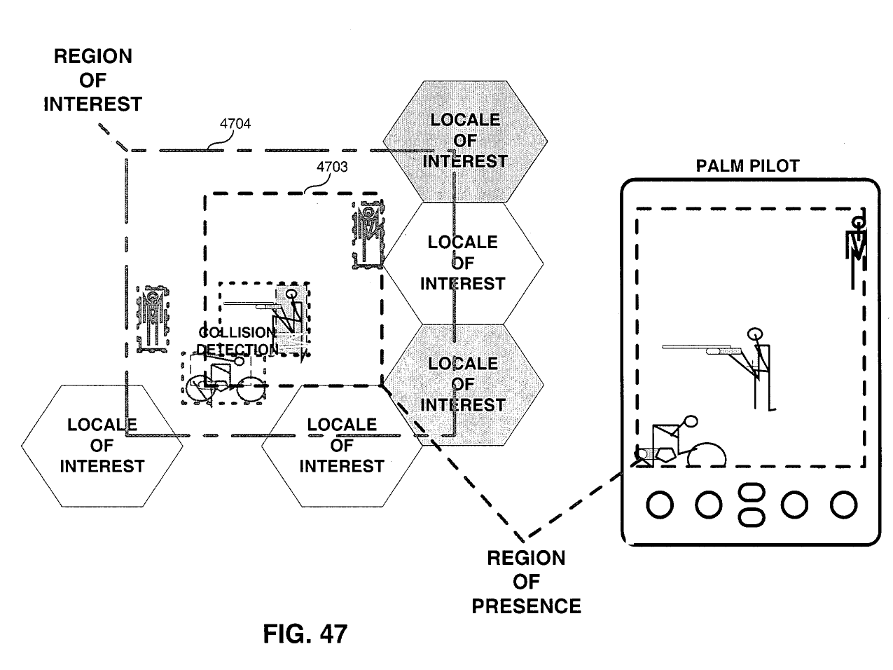

FIG. 45 is an illustration of how the terms “region of interest”, “region of presence,” “personal space”, etc. are used throughout this discussion and in particular as they relate to Dead Reckoning. FIG. 45 should be viewed in conjunction with FIGS. 46 and 47, and is also discussed below in the Area-of-Interest Management section.

FIG. 46 shows a Game Server of Record 4601 that includes a Locale of Record 4602 with a sniper standing inside the Locale of Record 4602. Box 4603 represents the sniper's region of presence, and box 4604 represents the sniper's region of interest. In other words, it is analogous to the sniper being as big as box 4603, and being able to see as far out as the boundaries of box 4604. The bicyclist seen in the lower left of 4604 is actually hosted on another host, on server 4605. The bicyclist is touching the region of presence 4603 of the sniper. Messages are routed about the bicyclist colliding with the sniper. In this figure, “updates of record” refer to a new user logging in. “Updates of interest” refer to one user “seeing” another user. “Updates of presence” illustrate collision events. Thus, FIG. 46 illustrates how packets are prioritized and routed based on interaction of Embodiments of Record that are on two different Game Servers 4601, 4605.

FIG. 47 is an alternative representation of FIG. 46, focusing on how a user may be playing a game using a Palm Pilot, and what the user will see on his Palm Pilot.

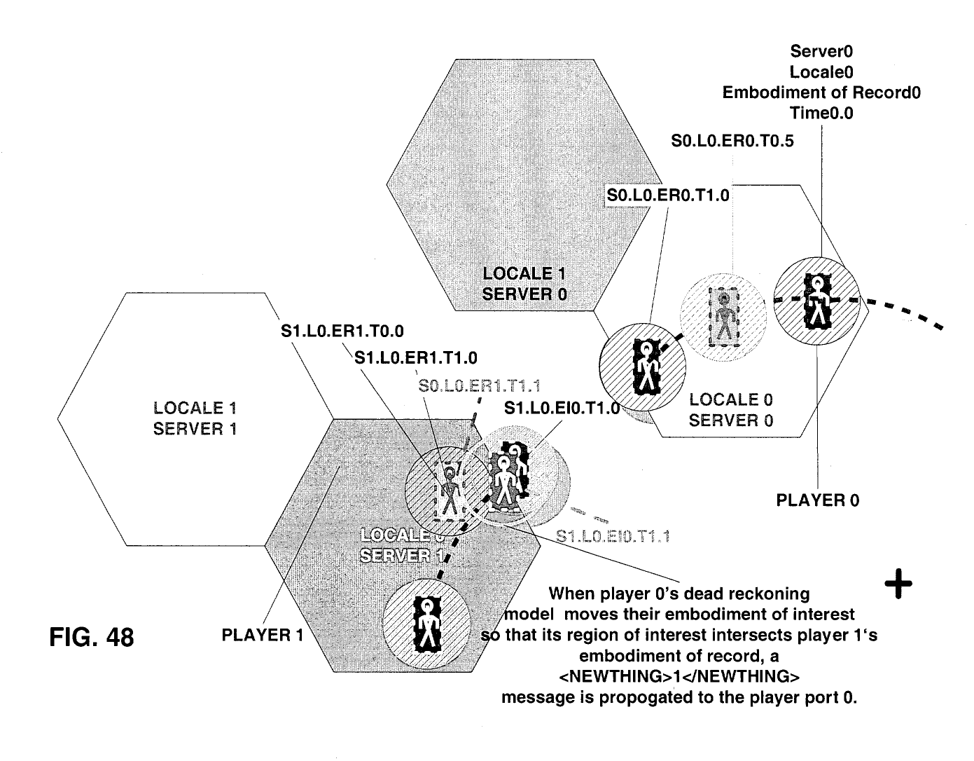

FIG. 48 illustrates the dynamic interaction between two players located on different Locales and/or different Game Servers 405. In FIG. 48, Player 0 moves from right to left, as shown by the dotted line. The tag S0.L0.ER0.T0.0 in the figure refers to the following: S0 refers to Game Server 0, L0 refers to Locale Thread 0, ER0 refers to Embodiment of Record 0, and T0.0 refers Time0.0. The other tags in FIG. 48 have a similar format. Player 1 is a “white figure against a black background”, and Player 2 is a “black figure against a white background”, initially at Locale 0, Server 1. The two Embodiments of Record gradually approach each other such that their regions of interest intersect. The circle around Player 0, for example, is the region of interest around the Embodiment of Record 0 of Player 0. When the Embodiment of Record 0 moves to a point where its region of interest touches the region of interest of Player 1 (i.e., of Embodiment of Record 1), a message is sent to Embodiment of Record 1, notifying it of that fact, and vice versa. Thus, this is how the Embodiment of Record 1 “sees” Embodiment of Record 0 walking towards it. In other words, Thing 0 is new to Thing 1, and a message needs to be propagated to reflect that fact.

Furthermore, in addition to Grid-definable Dead Reckoning models, the user or the game designer may define his own Dead Reckoning models, whose parameters would also be passed in a context agnostic manner. In certain contexts, there may be a benefit to having users define their own Dead Reckoning model, from the perspective of bandwidth conservation.

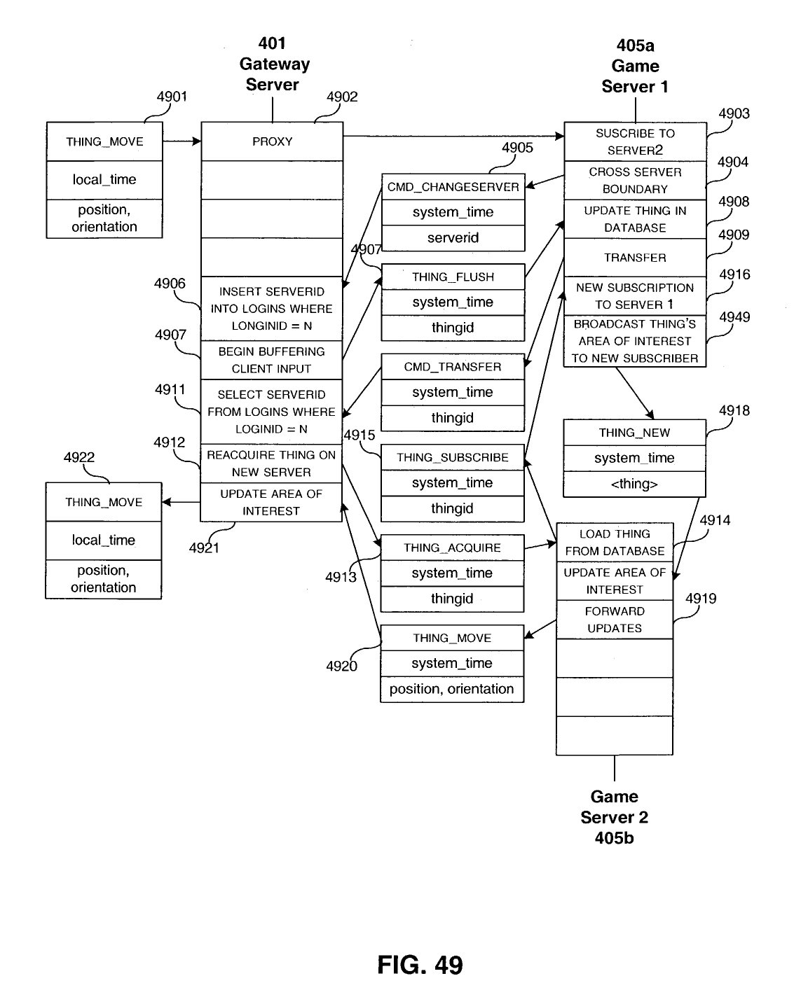

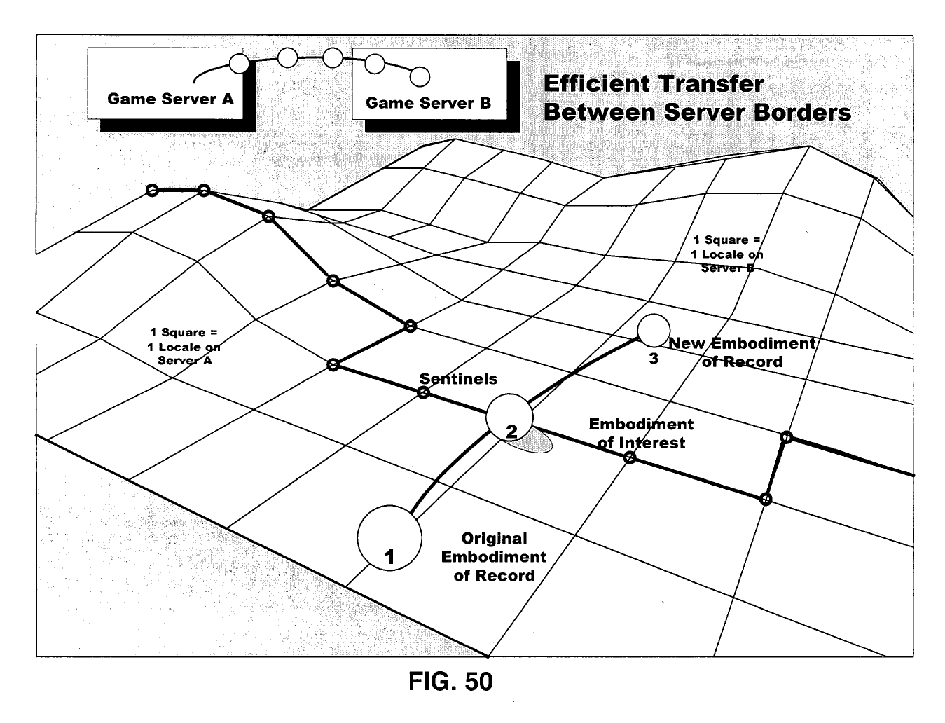

FIG. 49 illustrates one implementation of the process of movement by a Thing (THING_MOVE) in the game by a user. FIG. 49 is meant to illustrate, in flowchart form, the progression of steps that effect the movement, in order from 4901, 4902, 4903, 4904, 4905, 4906 . . . 4922.

The end result of the process of FIG. 49 is that the Thing is flushed into the database 104 by Game Server 1, and this information is then sent to Server 2 as an update. Thus, when a player moves from one Locale to another, the information related to that user is flushed from the database 104 for Game Server 1, and is added to the database 104 for Game Server 2.

FIG. 50 illustrates transfer of the Embodiment of Record between borders of Locales. Each square in FIG. 50 represents a Locale. The original Embodiment of Record moves from location 1 to location 2, where it comes in contact with a sentinel. By the time the Embodiment of Record moves from location 1 to location 3, a new Embodiment of Record will be created on Game Server B, and the old Embodiment of Record on Game Server A is deleted. Note that Game Server A and Game Server B may be on different physical hosts. Thus, FIG. 50 illustrates the movement of an Embodiment of Record corresponding to a user moving from one host to another, ultimately enabling the user to be anywhere in the world defined by the entire game. The sentinel, via a handshaking mechanism, allows for the Embodiment of Record to be transferred from one Game Server to another, including the situation of seamlessly transferring from one physical host machine to another.

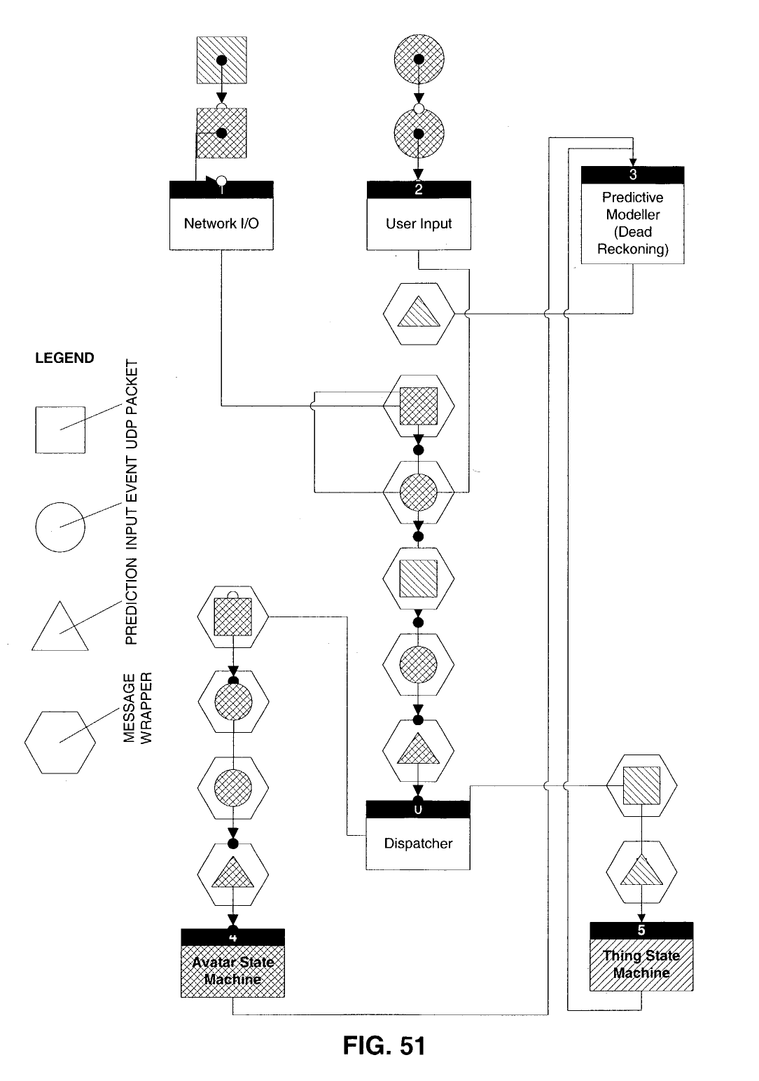

FIG. 51 illustrates event multiplexing as it relates to Dead Reckoning. As shown in FIG. 51, UDP packets are coming in into network I/O, input events (such as a joystick movement by the user) are coming in at user input, and the Predictive Modeler/Dead Reckoning process makes sure that the various Embodiments of Record interact with each other properly.

8. Area of Interest Management

The Area of Interest Management (AIM) subsystem applies state aggregation and filtering rules based upon the object states and identifications of the participants of the system. It works in concert with the state aggregation system, the Rules Enforcement Engine, and the authorization subsystem to mediate state transmissions.

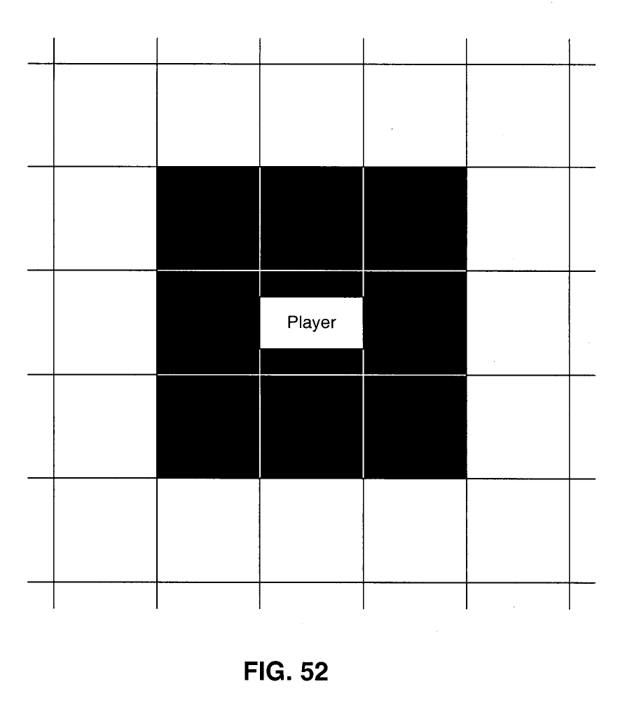

FIG. 52 illustrates one aspect of area of interest management, and in particular, one example of the topology where a player is located at a center Locale, and eight other Locales come in contact with the center Locale, and therefore need to be managed properly under this topology. Further, to the extent that the player can only “see” into half of the adjacent square, the Things that can affect that player may only be a subset of the Things present in the adjacent Locales, which are shown in black in FIG. 52.

Each Server Thing (see discussion above) interacts with others in its proximity through its area-of-interest. For example, each object on the Game Server 405 can have a range of vision (of block data subtype RANGE) within which other objects are visible, and a presence (of subtype PRESENCE) with which other objects can collide. These complementary range/presence values form the basis for area-of-interest management (as shown in FIG. 45, discussed in part previously).

In the example shown in FIG. 45, the area-of-interest of the “sniper” Server Thing is the region centered about the POSITION of the embodiment-of-record of that Avatar on its Server-of-Record in its Locale. The range of this area of this area-of-interest is defined by its RANGE and the type of region of the area-of-interest by its REGION_TYPE. The extent of a smaller region, the Avatar's region-of-presence, is define by the state value of PRESENCE. Being Grid properties, they are shared by each Game Server object, so every Server Thing becomes a potential source of packet interaction.

The list of packet sinks that are currently receptive to perceiving this Server Thing are kept internal to the embodiments-of-record. Each element on the list of packet sinks is a Server ThingRef that can be used for routing source packets to their corresponding sink(s).

In the example of FIG. 45, there would be a reference to the “sniper” Avatar on the list corresponding to the walking “victim” Avatar, and another reference to the “sniper” on the list corresponding to the bicycling “courier” Avatar. In order for the “sniper” to see the “victim”, he or she must receive messages as the walking Avatar moves back and forth. This implies that the victim is a packet source for messages to the sniper, which becomes a packet sink for messages about the changes in state of the Server Thing representing the walking Avatar. For the “sniper” to collide with the courier, it must receive messages as the bicycling Avatar pedals here and there. This implies that the courier is a packet source for messages to the sniper, which becomes a packet sink for messages about changes in state of the Server Thing representing the bicycling Avatar. Thus, there is a Server ThingRef maintained on the internal list of the victim and the courier that is used to route messages from these Server Things (as sources) to the sniper Avatar (as sinks). Packets routed in this way and rebroadcast to the Gateway 401 handling the login session for the sniper Avatar, and are proxied back to the client controlling the sniper.

As long as the victim is “in range” of the sniper, the area-of-interest manager continues to route packet information (ACTIVATE :: THING_SET messages) about the victim to the sniper. As long as the courier is “in the presence” of the sniper, the area-of-interest manager continues to route packet information (ACTIVATE :: THING_HERE messages) to the sniper. And whenever either the victim or the courier moves beyond the area-of-interest of the sniper, the area-of-interest manager routes notification (ACTIVATE :: THING_DROP messages) from the server-of-record, back through the Gateway 401 to the client controlling the sniper.

This process of area-of-interest management is not totally symmetrical. Note that the victim and the courier each have their own area-of-interest, whose shape and extent may differ from that of the sniper (the victim may be nearsighted, while the sniper may have a rifle scope). Thus, depending on the intent of the game designer, the flow of information of one Server Thing about another can be tuned and adjusted dynamically by the system.

In terms of computation complexity, area-of-interest management is essentially an O (n²) process, since each Server Thing in a region may potentially interact with every other Server Thing in that region. Every time some Avatar takes a step, they may come into range, collide with, or drop out of sight of some other object. However, many state changes do not involve changes that affect the Server ThingRef list of current packets sinks for this Avatar. For example, picking up a gold coin, striking a sword blow, losing stamina, or exchanging goods or services do not necessarily affect the norm or distance metric between two players. In these cases, incoming packets at the packet source are simply routed directly to the existing list of packet sinks: no recalculation of the Server ThingRef list is required. In other cases, dividing Server Things into sorted or partitioned lists can reduce potential candidates for interaction to a more manageable number. In the end, the complexity of area-of-interest management becomes effectively O (n log n) and allows for real-time interactions between Grid clients.

9. Instant Messaging and Clients

Packet source and packet sinks are useful for Locale interaction between clients, but clients that are otherwise out-of-range of each other also need to communicate. Since player-to-player chat forms such an important element of online gaming, the Grid provides a robust mechanism for instant messaging that allows packets to be proxied between clients while still maintaining the benefits of dynamic message management. This is unlike peer-to-peer systems, where a direct connection is established between trusted clients who communicate without any mediation at all.

There are reasons why having the Grid intermediate in the dissemination of Instant Messages provides a distinct advantage to a multi-player platform:

Security—clients may not wish to divulge their Internet addresses to one another directly.

Portability—clients may log in from another location at will, so the destination address may change without notice.

Reliability—clients may attempt to flood others in a denial-of-service attack, so the Grid may need to throttle their rate of messages down to a level that may be reliably handled.

Discovery—one client may need to determine if another is currently online. The essential element supporting Instant Messaging is a one-to-one mapping between a client's username and their access_key. If the client is online their access_key will be available to route packets throughout the Grid to their final destination.

Rules Enforcement—some messages may be special, secure, or restricted in scope. Having the Game Server 405 involved in the processing of these Instant Messages allows bringing all the intelligence of the game designer to bear upon the final outcome.

a. Instant Messaging and Rules Enforcement

Instant Messages also provide a unique mechanism for the Game Server 405 to interact with clients directly, i.e., through Secure Messages, to implement distributed transaction management (discussed in more detail above in reference to the Gateway 401). The sole originator of Secure Messages is the Game Server 405. It has access to the digital signatures of all the parties involved through its direct contact with the database 104. Thus, it can create, register, request, route, validate and execute Secure Messages to represent the current state of a distributed transaction as it flows across the Grid.

In addition, Instant Messages are generated by the Rules Enforcement Engine (an embedded Python code interpreter with a context agnostic Server interface) to notify clients of transient activity like explosions, sound effects and other such impermanent or one-shot events.

b. Python Packets

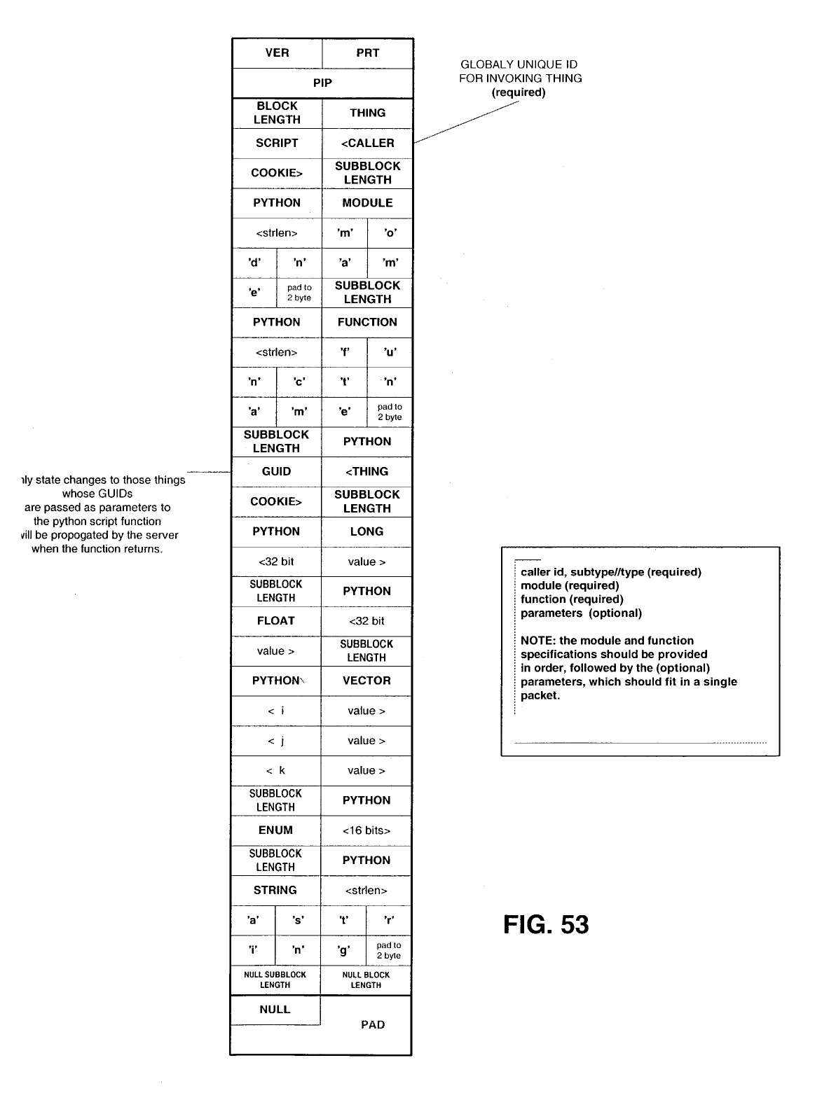

In order for the Rules Enforcement Engine to be invoked, the client must first issue a Python packet to request some sort of server-side game activity to take place. A Python packet has block type ACTIVATE :: THING SCRIPT and with a sub-block type of PYTHON, as shown in FIG. 53.

There are several related parts to any Python packet, which provide a generic interface to the Rules Enforcement Engine:

a) Specifying the Python module as a sub-block of type PYTHON :: MODULE is required.

b) Specifying the Python function as a sub-block of type PYHTON :: FUNCTION is required.

c) Passing Python parameters as sub-blocks of type PYTHON :: GUID, PYTHON :: LONG, PYTHON :: FLOAT, PYTHON :: VECTOR, PYTHON :: ENUM or PYTHON :: STRING are optional and vary depending upon which function is invoked. The provided parameters will be packed and passed with a format string to the function itself before being executed on the server. It is the game designer's responsibility to decide which parameters are expected by each function, and in what order the parameters are to be provided.

The GUID, or Globally Unique ID of the caller is also a required part of the script packet, and becomes the zero(th) parameter passed to each Python invocation. This allows the called Python function invoked on the Server to determine if the calling GUID represents a client that has permission to invoke this function: typically a client can only invoke a function upon itself or a limited number of other client objects or only at certain times; while a daemon client (a process with special permissions that controls all the non-player characters within a given Locale, discussed below) is allowed to invoke any function upon any client unconditionally.

When the invoking GUID of the client is that of a player who does not have pre-approval to execute a given function, the askApprovalByGUID ( . . . ) method can be from the executing Python script to seek system permission for rules enforcement to be take place. If approval is granted, the permitted activity becomes a distributed transaction and either takes place atomically, or not at all.

Upon exit from the invocation of any Python function, those Game Server objects whose GUIDs are referenced explicitly in the optional packet parameters are updated in the database 104 and checkpointed. This assures that all scripted changes will be persistent within the game world. By carefully designing the logic of rules enforcement scripts, the game designer can thus control the permissible actions on the Game Server 405 and thus within the overall game world itself.

For details of Python structure and syntax, see “Python Essential Reference, Second Edition” or any available Python reference manual. Below is example code for the module's buy_a_duck function, with a few comments added:

```
##################### begin python example code
#!/usr/Locale/bin/python
# butterfly.py - example python script
#
import sys
import types
from struct import *
from server import *
#all parameters to python functions are passed
#as a format string, followed by the packet parameters. . .
#use the utility “unpack” to extract these parameters into
#an argument list for processing by the python code. . .
#arguments passed to python routine “buy_a_duck”
#
#arg0—caller GUID (passed in by system)
#arg1—GUID of the particular duck to buy
#arg2—Thing_type of duck (animal type)
#arg3—GUID of prospective purchaser of the duck
#arg4—Thing_type of purchaser (Avatar type)
#arg5—PropertyID of the purchaser's inventory list
def buy_a_duck(format,parameters):
  args = unpack(format,parameters)
  sys.stderr.write(“python.buy_a_duck%s\n” % str(args))
  # check there are enough args and they are of correct types
  if len(args) > 5\
    and isinstance(args[1],types.IntType)\
    and isinstance(args[2],types.IntType)\
    and isinstance(args[3],types.IntType)\
    and isinstance(args[4],types.IntType)\
    and isinstance(args[5],types.IntType)\
```

```
  # properties as arguments to. . .ByGUID( )
  # methods are passed in CTHINGATTRIBUTEVALUEBUFFER
  value = CThingAttributeValueBuffer( )
  value.m_Attribute.Type = PROPERTY_STRING
  value.m_typeObject = 0
  value.m_bDirty = 0
  value.bufferString(17, “wanna buy a duck?”)
```

# ask the purchaser if they want to buy the duck

```
  # this may generate a secure dialog with the user
askApprovalByGUID(args[3],value)
# askApproval returns GUID of authorized purchaser
if(value.m_Attribute.Type != PROPERTY_LONG)\
    or not(value.m_bDirty):
    sys.stderr.write\
```

(“need authorisation to buy duck %d\n”\
% args[1])

```
    return
  # if we make it this far we have received approval
  # from the prospective purchaser of the duck (arg3)
  sys.stderr.write(“got approval %d ” % value.m_bDirty)
  sys.stderr.write(“from guid %d\n”\
```

% value.m_Attribute.Value.1Long)

```
  # the grabByGUID( ) method attempts to stuff the duck
  # into the purchaser's inventory list: it returns the
  # former location of the duck if the operation succeeds.
  value.m_Attribute.Type = PROPERTY_VECTOR
  value.m_idState = POSITION
  value.m_typeObject = 0
  value.m_bDirty = 0
  value.m_Attribute.Value.vVector.x = 0
  value.m_Attribute.Value.vVector.y = 0
  value.m_Attribute.Value.vVector.z = 0
  grabyGUID\
    args[1], args[2], args[3],args[4], args[5], value)
  # check the resulting value for the former location and
  # print out the result of this secure transaction. . ..
  if value.m_Attribute.Type != PROPERTY_VECTOR:
    sys.stderr.write(“failed to buy duck %d\n” \
```

% args[1])

```
  else:
    sys.stderr.write(“bought duck %1d ” % args[1])
    sys.stderr.write(“located at %f” % \
```

value.m_Attribute.Value.vVector.x)

sys.stderr.write(“, %f” % \

value.m_Attribute.Value.vVector.y)

sys.stderr.write(“, %f” % \

value.m Attribute.Value.vVector.z)

sys.stderr.write(“\n”)

return
##################### end python example code

c. Creating Python Scripts

Of particular interest in the example Python module above is the definition of the function

def buy_a duck(format, parameters):

that requires two arguments, a format argument and a parameters argument. All rules enforcement script functions take these two arguments exactly. The format argument is a text string that, using special control characters, describes the order and type of the parameters that are packed into the second text string argument.

The standard Python function unpack (provided in the struct module) processes these two argument and produces a new tuple (an object containing a variable list of values). The values contained in this tuple of unpacked parameters are the unpacked arguments that will be processed by the function itself:

args=unpack(format, parameters)

sys.stderr.write(“python.buy_a_duck %s\n” % str(args)) # print the list

# of unpacked

# arguments

To find out how many unpacked arguments have been passed as parameters the example calls len( . . . ) to return the size of the list contained in this new tuple. Each individual argument of this tuple may be referenced singly using an index:

isinstance (args[1], types.IntType)

In this case the standard isinstance function (provided in the new module) determines if unpacked argument number one is of type integer.

Rules enforcement scripts run on the Game Servers 405, as part of the execution environment, and are bound to the Game Server 405 with interface code that allows certain server functions written in C++ to be accessed by callbacks from the Python scripts themselves, such as: askApprovalByGUID( . . . )

This C++ server method is called by the buy_a_duck function to generate an approval dialog with the seller of the ‘duck’, whose response will control whether or not the transfer actually takes place. If the approval for this action is received, the script will call another C++ server method, grabByGUID( . . . ), which will attempt to stuff the purchased ‘duck’ into the buyer's inventory list.

In addition to the above utility methods, the Game Server 405 provides other basic C++ bindings for interacting with objects and object state. Validation of object types is accomplished via the callback method

getTypeByGUID (BNGUID Thing_id, CThingAttributeValue*value)

This C++ Server method returns the specified type of the object specified by its Thing_id argument in a field of the CThingAttributeValue class referenced by the value argument.

Interacting with object state is performed via the callback methods

setStateByGUID (BNGUID Thing_id, CThingAttributeValue*value) and

getStateByGUID (BNGUID Thing_Id, CThingAttributeValue*value)

These C++ Server methods modify (set) and retrieve (get) the state properties for a specific object by means of the CThingAttributeValue class referenced by the value argument.

The CThingAttributeValue class is a special in/out parameter that provides a variety of information about each state property. The fields of the CThingAttributeValue class are provided here for reference:

class CThingAttributeValue
{
public:

STATEID m_idState; // which specific state #
BNOBJECTTYPE m_typeObject; // object type referenced
FLAG m_bDirty; // has the value changed?
CTHINGATTRIBUTE m_Attribute; // the attribute value itself

};

Note that the m_Attribute field is itself an instance of the struct CTHINGATTRIBUTE that includes within it a union of the LONG/FLOAT/VECTOR/ENUM/STRING/TOKEN types. This allows the CThingAttributeValue argument to represent any one of the primitive types used for marshalling data to and from Server Things. It provides the means for Python scripts to pass information into and receive information out of the C++ Server callback methods using a single, integrated mechanism regardless of the underlying type of data transferred.

Using these and other C++ Server methods available for Python callback allows the Rules Enforcement Engine to validate that the calling object has the state properties to enable it to perform valid actions. The Python script may check that the caller really has two gold coins before allowing them to ‘buy_a_duck’, and that the vendor is actually in possession of a ‘duck’ to sell. In this way any set of rules may be correctly enforced.

d. Secure Requests, Dialogs, and Transactions

An important extension to the invocation of Python functions on the Game Server 405 is the generation of secure requests, dialogs, and approved transactions. The process of generating a secure request begins when the Rules Enforcement Engine executes a Python script that requires obtaining client approval for a particular action to take place. In the example Python code for the buy_a_duck ( ) function, this process is initiated with the execution of the callback function askApprovalByGUID ( ) that transmits a secure request to the prospective purchaser that includes the dialog prompt “wanna buy a duck?” Embedded in the secure request is a copy of the original Python packet that generated the request. Each secure request is numbered, registered, and digitally signed twice (once with the signature of the originator of the request, and once with the signature of the recipient of the request). The first signature guarantees that the receiver cannot modify or tamper with the original request undetected, and the second signature vouches that the secure request was generated by a trusted source (that is, some agent that shares a secret/password with the recipient client).

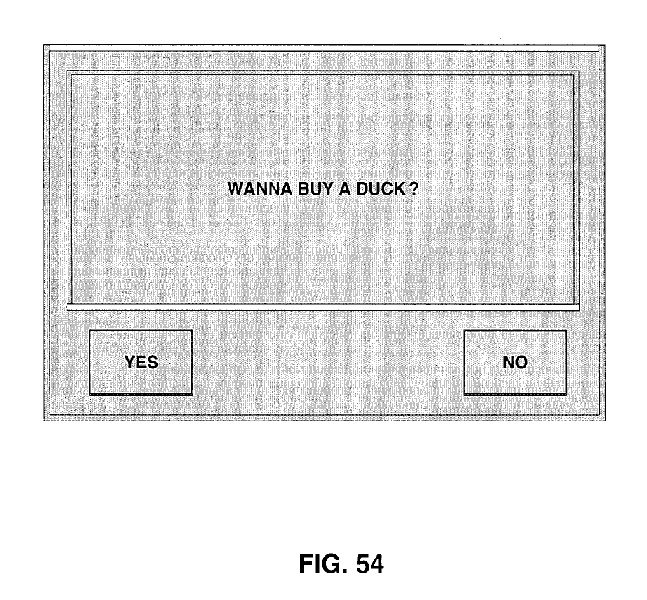

Given these pieces of structured information, the client who receives a secure request can perform validation to determine the authenticity and accuracy or the request, as shown in FIG. 54. The client can display the text prompt to the user whose approval is being sought. The client can (if that approval is granted) indicate that the yes option was selected, can countersign the request to make the selection binding. The client can reply to the request by transmitting that countersigned packet back to its source Game Server to complete the transaction and seal the deal.

When the source Game Server processes the approved, returned, countersigned, and validated secure request packet, it additionally checks to make sure that the request number is valid, that it is still registered with the system and has not already been satisfied, and that this request has not yet expired. If all these conditions are true, the embedded Python invocation is resubmitted for final execution.

10. Session Management Subsystem

As some participants will be transient (connecting and disconnecting to the system), session management is employed to save and restore state between sessions.

11. Daemon Controller

a. Enthralling Active Objects

Normally in the massively multi-player world, there are a multitude of objects. Avatar objects are Things connected to clients (real people pushing buttons and twitching joysticks somewhere out there on the Internet). Passive objects are Things that can be manipulated but aren't connected to any other form of control mechanism (gold coins that can be picked up and put into inventory, flags to capture, etc). Sentinels are specialized system objects that intercept and rebroadcast messages from Game Server to Game Server across Locale boundaries. The remaining objects form a special class: Active Objects.

Active Objects are objects, some of which are also known as Non-Player Characters (NPCs) that may have an independent life of their own; that walk and talk, or run and hide, or perform other changes of state actively of their own accord. These Non-Player Characters are not necessarily human characters. They may be animals, enchanted swords, or magic portals that take some positive role in directing game play. Some sort of Artificial Intelligence (AI) is attributed to this class of objects, and their object state changes appear to be directed by some sort of intelligent agent. Those changes of object state do not have to be physical ones. They may range from a proximity alarm that sounds a warning beacon if an Avatar approaches too closely to a morning glory that furls its petals at the setting of the sun. In other words, Active objects do something on their own or respond to external stimuli without having to be controlled by a real person sitting at the controls.

Something, however, needs to direct the object state changes of these Active objects. Packets to and from these objects need to be directed to an intelligent agent acting for the control of each NPC in the game. Within the Grid, that something is the Daemon Controller: an independent process (or privileged proxy client) that logs into each Locale and manipulates the state of every Active Thing within that Locale.

In other words, each Active object is enthralled by the Daemon Controller, and behaves something like a zombie when the daemon is present. Messages from each thrall flow to the daemon. Messages to each thrall flow from the daemon. Each enthralled object is directed by the daemon to behave according to the rules of each individual game.

Note that each Non-Player Character may thus behave differently in different situations and according to different personal properties within the same game.

Since the Daemon Controller is performing as a proxy client, it has complete access to the internal state of each enthralled NPC. If the Non-Player Character is low on health points, the daemon knows it. If it is carrying an axe, the Daemon Controller can swing it. Also, since messages from each enthralled NPC are redirected to the Daemon Controller, the daemon sees what the NPC sees. If a panther approaches the Non-Player Character, the Daemon Controller is aware of it; if an eclipse covers the sun the Daemon Controller senses the encroaching darkness. In this way, the daemon acts for the interests of its enthralled Active objects.

Assigning the function of control of Non-Player Characters to a privileged proxy client solves an additional problem as well: how to maintain context agnosticism in the integration of Al into each Locale. Since it is necessary to restrict the a priori knowledge of the Grid with respect to how NPCs interact within any specific game, the general purpose mechanism of the privileged proxy client is used to divide the world into pre-compiled and run-time regimes: while the pre-compiled Game Servers must host multiple games without modification, the run-time binding of objects to their controlling agents is provided to incorporate game-specific logic into the virtual world.

The independent processes comprising the Daemon Controllers for Grid Locales may reside anywhere: on dedicated hosts behind the firewall, on client machines out in the community, even on a handheld device carried in the system administrator's pocket (although for reasons or performance this last alternative is not preferred). Since the Daemon Controller process logs in to the Grid just like any other client process, it can potentially be running anywhere and on any machine connected to the Internet. It can be written in any language, compiled or interpreted. It can be hosted on any processor, and more powerful processing support can be provided at any time it becomes necessary or available. In short, the Daemon Controller is a flexible process for directing the Artificial Intelligence of the Grid.

b. Demultiplexing Daemon Packets

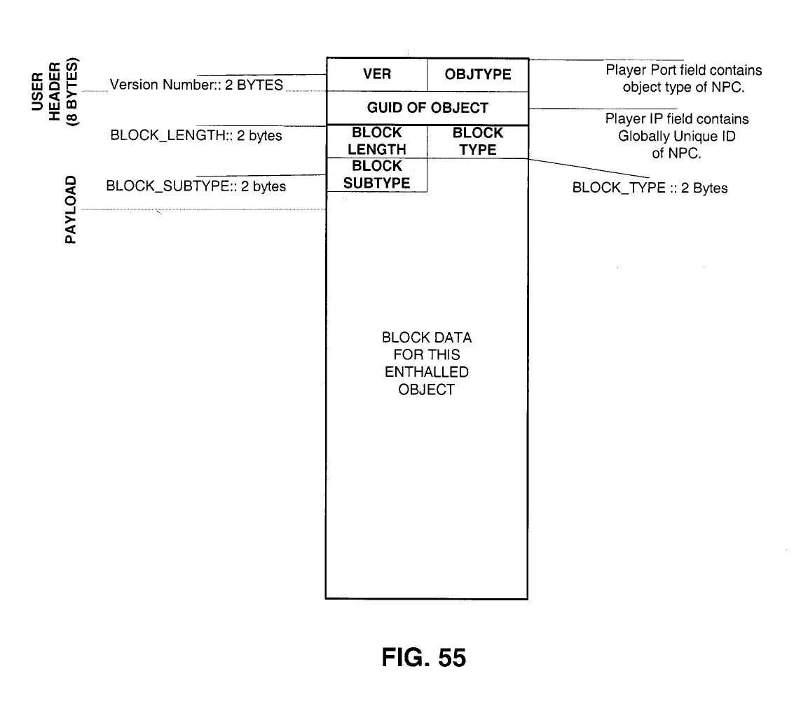

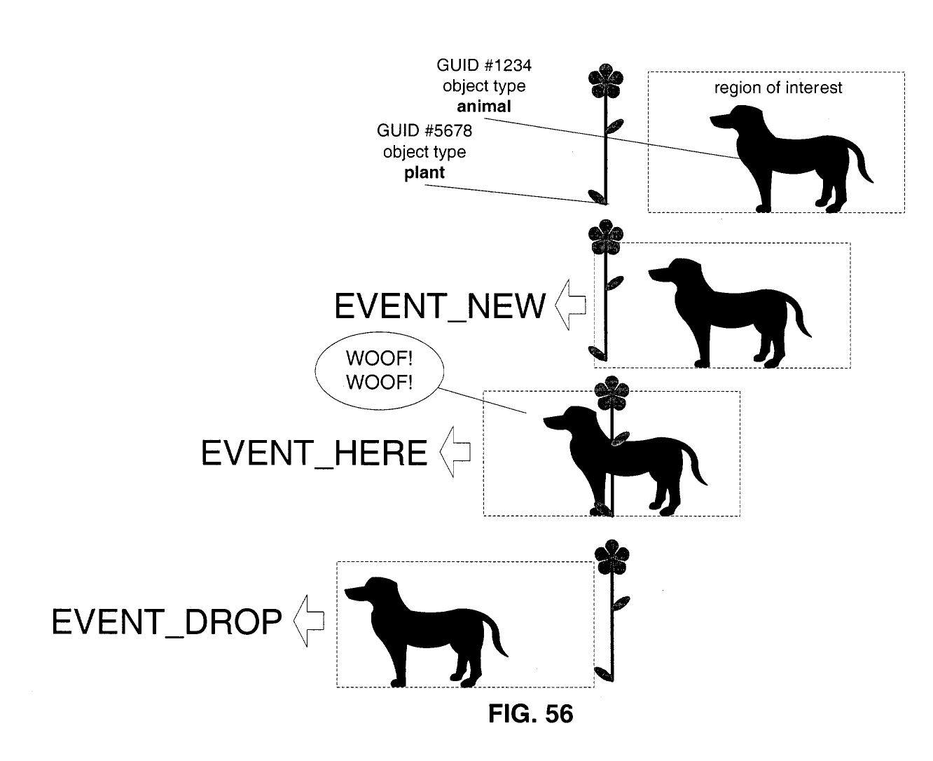

The daemon provided with the Grid is, in one embodiment, a multi-threaded process with support for packet demultiplexing. In one embodiment, it is written in C++ and provides a framework for implementing game specific logic packages within the context of a simple control protocol for sorting and directing packets to their proper logical destination. In order to understand how packets for NPCs within a given Locale are formatted and multiplexed together by the Game Server 405 for transmission to the Daemon Controller, and thus how the daemon demultiplexes these packets for processing, the User Header for enthralled objects is discussed below (see also FIG. 55):

The User Header for the packets representing NPCs (or enthralled objects) has special information passed in the general purpose fields PIP and PRT. The PIP (Player IP) field includes the Globally Unique ID of the Active object that generated this payload. The PRT (Player Port) field of this User Header includes the object type of the Active object that the GUID represents. The Daemon Controller shell code divides the incoming streams of payload messages first by object type, and then by GUID.

During the process of demultiplexing, all messages of a given type are divided by object type, to be handled by the same daemon logic module (for example, all objects of type ANIMAL are handled by the module ANIMAL_LOGIC). Within a given object type, objects of different GUIDs are handled by individual context elements (that is, each individual Active object has its own LOCALE CONTEXT). Each unique combination of object type and GUID gets its own finite-state machine, which is called asynchronously to process those payloads that are destined to it.

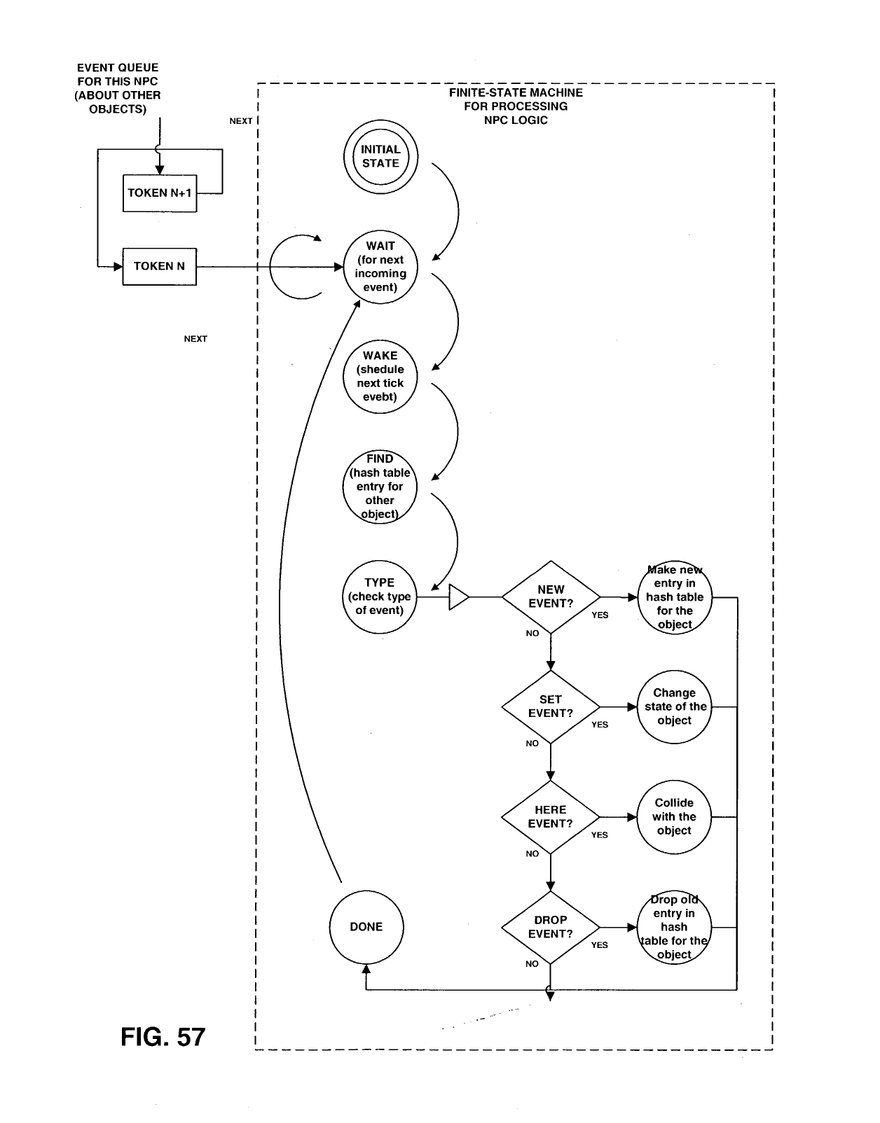

The packet payloads are divided up, parsed for content (block) type, and symbolically represented by lexical tokens that are queued as input to each finite-state machine based on the block type of each individual payload. Additional tokens representing time relationships are inserted into the input queue as well, to make certain that every finite-state machine is invoked at least once every clock tick. When the finite-state machine for each Active object is invoked, it is these synthetically generated tokens that drive the transition from object state to object state, resulting in activity for each individual thrall. As the input queue for each finite-state machine (see FIG. 57) is processed, it changes the LOCALE_CONTEXT for that Active object. When the input queue for each finite-state machine has been fully drained, the logic_module waits for additional packet payload to arrive.

c. Daemon Events

Input payloads are parsed in the main event loop of the Daemon Controller, producing input tokens or daemon events. Each daemon event becomes one of several types, the most important being EVENT_NEW, EVENT_SET, EVENT_HERE, and EVENT_DROP. Each daemon event includes the Globally Unique ID of its primary target Thing (the object that received this payload) and specific information about the secondary object that originated this payload and the object type or that other object, as well as an indication of which type of event this token represents, a pointer to the Locale_state for the primary object, and a packet time stamp.

class CDaemonEvent
{

| | |
|---|---|
| public: | |
| BNGUID | Thing; |
| BNGUID | other; |
| BNTYPE | otype; |
| ULONG | event; |
| void * | state; |
| CPacketTime | timer; |

CInternalListNode<CDaemonEvent *> m_node;

};

The basic event types are:

EVENT_NEW—this Thing has received a message about the appearance of a new secondary object with Globally Unique ID other and type otype.

EVENT_SET—the properties of an existing secondary object have been modified, and this Thing has been notified of the changes.

EVENT_HERE—this Thing is in close proximity to an existing secondary object: a collision is immanent.

EVENT_DROP—the secondary object with Globally Unique ID other and object type otype has moved out-of-range: it is no longer within this Thing's region of interest.

EVENT_TICK—a specific amount of time has elapsed since the last token was generated: this Thing may continue to processes states that are triggered by specific sequences of input events and are intended to continue for a given period.

As a primary object (an Active object controlled directly by the daemon) changes its state, it comes within range of other, secondary objects. Depending on it region of interest, messages are generated about the secondary object and forwarded to the Daemon Controller. Parsing these input payloads, the daemon generates Daemon Events and passes the secondary information through to the state logic module for the primary object.

Every so often a tick event is generated synthetically and inserted into the token stream. This allows periodic processing of state changes whether or not a specific input trigger is found (for example, a barking dog may stop barking after a few seconds of inactivity).

As an example, consider a case of just one such primary object “dog” (of type animal) with the Globally Unique ID #1234 whose behavior is being determined by the Daemon Controller (see FIG. 56).

This Active object is walking along controlled by the daemon process. It comes within range of a secondary object “flower” with Globally Unique ID #5678 and type PLANT. As the dog approaches the flower, it receives its first Daemon Event (of type NEW). Continuing to stroll, the dog brushes against the flower, and receives a series of Daemon Events (of type HERE) as long as it is in contact with that other object. In this case, the Daemon Controller initiates an object state change in the dog, causing it to bark every time a TICK event is synthetically generated eventually, the dog passes the flower and leaves it behind, and as the secondary object passes out of its region of interest it stops barking when it receives a final Daemon Event (of type DROP). In this way, the daemon process may keep a list of event tokens that represent the interactions between this flower and this dog, and the finite-state machine ANIMAL_LOGIC will be able to respond to these events.

d. NPC Logic

As each daemon event token is created, it is queued by the Daemon Controller as input for one particular finite-state machine associated with each NPC (see FIG. 57).

VII. Example System Operation

A. Gaming Example

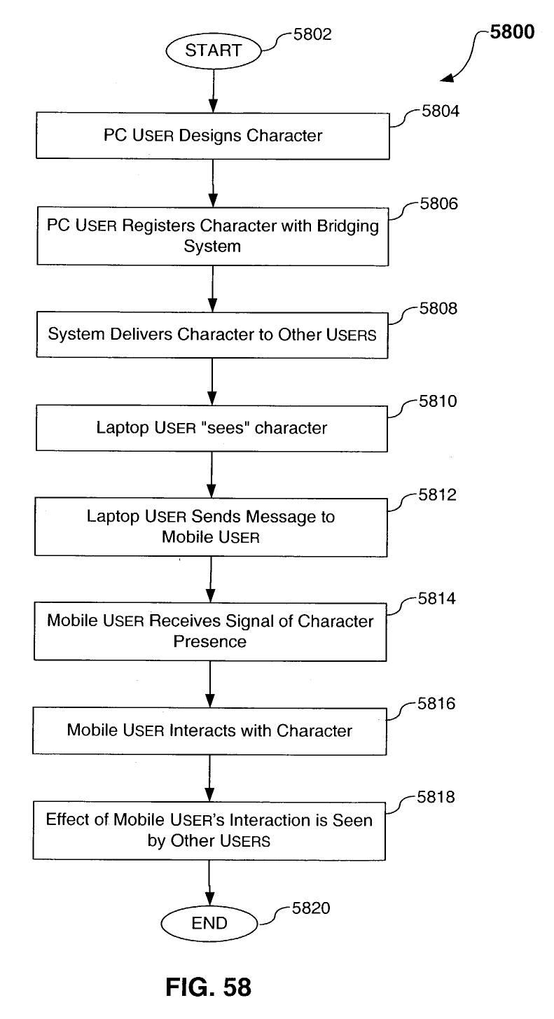

Referring to FIG. 58, a flowchart depicting an embodiment of the operation and control flow 5800 of Grid system 100 of the present invention is shown. More specifically, control flow 5800 depicts, in flowchart form, an example of multiple users in both the physical and synthetic worlds being bridged during the execution of one instance of an interactive multi-user gaming application. The description of FIG. 58 is presented with particularized reference to individual Multi-User Bridging system 100 components. Control flow 5800 begins at step 5802, with control passing immediately to step 5804.

In step 5804, a user on a PC client device 112f (“PC user”) designs a new character for the instance of an interactive, multi-user gaming application being executed within Grid system 100. As will be apparent to one skilled in the relevant art(s), after reading the teachings herein, one of the servers 102 within Grid system 100 would ensure (by checking database 104) that the PC user had “creation” permissions within the instance of the interactive, multi-user gaming application being executed (i.e., played). Such a new character is termed an avatar within the instance of the interactive, multi-user gaming application. Each avatar can be classified in terms of three definitions: (1) role—this encapsulates the role of that person or character (e.g. manager, administrator, guardian, wizard, secretary, etc.); (2) attributes—this encapsulates the person or character within the synthetic environment (e.g., hair color, eyes, description, inventory, location, etc.); and (3) name—which is the identifier used when registering the avatar with Grid system 100.

In an embodiment of the present invention, such user would design a “monster” character using one or more of the following steps: (a) use graphics software such as 3D Studio Max or Maya to create a 3D visual representation of the “monster” character; (b) use a JPEG file to create a 2D visual representation of the “monster” character; (c) create an MP3 file that includes audio content (i.e., sounds) that the “monster” character makes; (d) type text associated with the “monster” character (e.g., “85 Ft. Monster”); (e) use any commercially available gaming character creation utilities to create the “monster” character (e.g., www.creaturelabs.com by CyberLife Technology Ltd. of Cambridge, England); (f) define user response rules to the “monster” character (e.g., pressing *9999 will kill “monster” in 30 seconds); and (f) define how the “monster” character moves within the synthetic environment (e.g., x,y position to x′,y′ position at z rate).

In step 5806, the PC user would register the new “monster” character with Grid system 100. That is, the communications flow described with reference to FIG. 2 would allow the server 102 to centrally store the attributes of the new character in application database 104.

In step 5808, server 102 would cause the new “monster” character to be delivered to all other users playing the same instance of the interactive multi-user gaming application as the PC user. Such deliver would be affected by translator 108, under the control of server 102, via transportation network 103. Further, the server would place the new “monster” character in a PC user-dictated location within the synthetic environment, say for example, the Wall Street area of New York City.

As one skilled in the relevant art(s) would appreciate after reading the description herein, the PC user would need to have “creator” rights within the specific instance of the interactive multi-user gaming application in order to create the new “monster” character in step 5808. Such rights would be dictated by the identity, permissions, and gaming rules stored by Grid system 100 in application database 104.

In step 5810, a user on a laptop client device 112e (“laptop user”) would now “see” the new “monster” character on their laptop. More specifically, the laptop user would see the “monster” character on the synthetic representation of Wall Street in New York City. Grid system 100 ensures that the “monster” character is properly rendered for each user utilizing a different type of client device 112.

In step 5812, the laptop user sends a message to a user on a mobile phone client device 112a (“mobile user”). Such message, for example, would convey that “a new ‘monster’ character is two blocks from you.” This message may be sent because the mobile user is represented in the synthetic environment as being on Wall Street in New York City because in the physical world, they are.

In step 5814, the mobile user receives a signal (e.g., audio indication, text message, voice mail message, graphic display, etc.) on client device 112a reflecting the laptop user's message sent in step 5812.

In step 5816, the mobile user can interact with “monster” character (i.e., manipulate the “monster” character entity). Such interaction would involve, for example, pressing *9999 on their mobile phone client device 112a to kill the “monster” character. In step 5818, the synthetic representation of the “monster” character would disappear from the PC user's, laptops user's and mobile user's client devices. Again, Grid system 100 would ensure that the “monster” character's death would be properly rendered (using the proper signal) for each player's different type of client device.

Control flow 5800 then ends as indicated by step 5820.

B. Alternate Embodiments

It should be understood that control flow 5800, which highlights the functionality, scalability, and other advantages of Grid system 100, is presented for example purposes only. The architecture of the present invention is sufficiently flexible and configurable such that users may utilize Grid system 100 in ways other than that shown in FIG. 58. Such alternate embodiments are presented below.

In one embodiment, users of Multi-User Bridging system 100 may further bridge the synthetic environment with the physical environment. More specifically, in step 5816 of flow 5800, the mobile user may have taken a taxi in order to “run away” from (i.e., interact with) the “monster” character. If the mobile user also possessed a video camera client device 112, the video stream of the taxi ride may be uploaded to server 102 (via transportation network 103 and translator 108), so that the video stream of the mobile user running away from the “monster” character may be seen on the PC user's and laptops user's client devices.

In another embodiment of the present invention, as one skilled in the relevant art(s) will appreciate after reading the description herein, if the mobile user's taxi ride takes them outside of the Wall Street area of New York City, then the synthetic representation of the mobile user would disappear from the PC user's and laptops user's client devices.

In another embodiment of the present invention, as one skilled in the relevant art(s) will appreciate after reading the description herein, a user may create an MP3 file that includes audio content (e.g., a recorded voice message) that is played on a registered client device owned by another player when that player enters a specific area of the synthetic or physical environment. For example, the PC user could specify that the “monster” character speaks each time another player enters a specific building located on Wall Street in New York City. That sound would be played, for example, on a player's mobile phone 112a when they walk into the physical building, or on a player's PC 112f speaker when a player's synthetic representation walks into the specified building.

In yet another embodiment of the present invention, as one skilled in the relevant art(s) will appreciate after reading the description herein, application database 104 would contain billing information (i.e., address, telephone, credit card or bank account number) for each player registered with the ASP providing Grid system 100. This would allow players to actually incorporate financial transactions into the synthetic and physical environment bridging of the interactive multi-user gaming application being executed (i.e., played). More specifically, using the above taxi ride example, the mobile user could charge the PC user for the physical environment taxi ride he was forced to take in order to run away from the synthetic environment “monster” character.

VIII. Simultaneous Display Across Various Client Devices

Having described the solution to the problem of maintaining referential integrity between physical and synthetic environments, and describing an example gaming flow, the simultaneous display across multiple client devices 112 will be further described. Such simultaneous display across multiple client devices 112 would occur when Grid system 100 ensures that the “monster” character is properly rendered for each user utilizing a different type of client device 112.

Within Grid system 100, there is a need to bridge not only RL and synthetic environments, but also the need to bridge platforms (i.e., various client devices 112) so that users (on various platforms) share a common experience. That is, the delivery of the application delivered by Grid system 100 must be “cross-platform” (i.e., imposing the same interface on multiple platforms with similar displays and interface conventions). It must also allow interface conventions that make sense on each platform by translating from the “interface space” (e.g., buttons and menus) to “action space” (e.g., shooting a “monster” character or talking to a character) in a fashion that is transparent to end-user/end-user platform 112. The multi-tiered architecture (i.e., a “back-end” tier executing on server 102, a “middle” tier executing on translator 108, and a “front-end” tier executing on client devices 112) of the present invention supports this translation and allows users to interact in ways that are natural extensions of the technology (i.e., client devices 112) they use to access the shared environment provided by Grid system 100.

By employing a multi-tiered software architecture with object abstraction/control on one tier, attribute translation on the middle tier, and display on the client tier, the present invention provides a flexible architecture for the inhabitation of shared, distributed environments for users of widely disparate access platforms. These three tiers are detailed in more detail below.

A. Front-End Client Tier

The client device 112 provides a window into the shared environment, as well as the interface that allows the user to interact with objects (and people, by their extension). Data which have been translated to inherent protocols by the middle tier will be rendered appropriately by the client device 112 software. Going in the other direction, the client device 112 software provides natural interfaces for performing actions, which will in turn be translated by the middle tier, communicated to the back-end tier, and re-distributed to other client device 112 platforms, as appropriate to the environment and the context of the application(s) being executed within Grid system 100.

As suggested above, in an embodiment of the present invention client devices 112 can range from a text and menu-based system on a PDA device to a real-time 3D rendering engine on a hardware-accelerated graphics workstation.

For performance reasons, a particular client device 112 may perform certain use-logic calculations locally, but the results of these calculations will not be transmitted unmediated to other clients within system 100. For example, collision detection (i.e., a player collides into a wall within a shared environment) may be performed locally, but the back-end servers 102 must perform heuristics to ensure that collision constraints are met before transmitting updated position-states to other clients 112. If the heuristics are not met, more detailed calculations can be performed on the server 102 to disambiguate the situation (i.e., to avoid the “cheating problem”).

B. Middle Tier

The middle tier of the present invention translates the interactions, changes, and actions of objects to communications protocols which are understood by the end-user's client platform (i.e., device 112). In one embodiment, on a sufficiently complex or powerful client device 112 platform, this layer can be vanishingly thin using “lossless” translations. As will be appreciated by those skilled in the relevant art(s), “lossless” is a term describing data compression algorithms which retain all the information in the data, allowing it to be recovered perfectly by decompression. Examples include GNU's gzip utility and UNIX's compress command.

In an alternative embodiment, on more modest client device 112 platforms, this layer may be complex and could involve “lossy” translations, where certain data-elements are parsed out and not transmitted to the end-client. As will be appreciated by those skilled in the relevant art(s), “lossy” is a term describing a data compression algorithm that actually reduces the amount of information in the data, rather than just the number of bits used to represent that information. The lost information is usually removed because it is subjectively less important to the quality of the data (usually an image or sound) or because it can be recovered reasonably by interpolation from the remaining data. The JPEG and MPEG formats are lossy algorithms.

In essence, the middle tier aims to only transmit “useful” information to a particular client device 112 in order to conserve bandwidth within Multi-User Bridging system 100. Thus, in an embodiment, the middle tier performs both protocol level translations (e.g., from TCP/IP to WAP) and data-level translations (e.g., parsing user objects to textual descriptions for transmission to a wireless PDA client device, or as shown in control flow 5800 above).

C. The Back-End Tier

In an embodiment of the present invention, the back-end tier (i.e., server 102) includes all objects within an offered application (e.g., a particular game title) are represented by software objects. Such objects include players, users, Things and non-playing characters (NPCs) (i.e., characters within a game not controlled by any player). The environment is divided into sectors which are in turn, represented by objects which have their own controllers.

In an embodiment of the present invention, states and attributes—both abstract and concrete—are abstracted into objects. This allows for complex mappings of attributes to objects (e.g., one-to-one, many-to-one, or one-to-many). Examples of concrete attributes (attributes that apply to an object) are: color-applicable to graphic platforms, polygonal (“3D”) model, textural description and physical strength (used by a controller to determine outcome of an action that requires strength). An example of an abstract attribute (an attribute that can apply to multiple objects or classes of objects) is temperature which can apply to all objects within a location, and can be updated based upon environmental concerns which are not the result of any action of a participant.

Attributes can contain information which is applicable to all platforms, with filtering taking place on the middle tier. The database 104 provides a store of persistent information on objects, and can communicate object information to the back-end servers as needed. The database 104 also can provide checkpointing of the environment when the re-creation of the environment is necessary. As will be appreciated by those skilled in the relevant art(s), “checkpointing” refers to the process of taking a snapshot of the state of an executing process, so that the process can be later restarted for the purpose of fault tolerance or load balancing.

In an embodiment, a zone object simplifies the representation of users' movements in a shared environment when users are using disparate access client devices 112. Take the example of a user on a graphical platform moving from one room to another in a shared environment. This represents no conceptual problem for other users of graphical devices 112 (e.g., desktop 112f), but could be complicated to represent to a wireless PDA device 112c. Grid system 100 represents the players in the zone as attributes of the zone object. When a new player enters the zone, an event is triggered so that this information is communicated to the other users in the room. These player objects in turn have attributes that describe the abilities of their client device 112 platform (which is used in the middle tier to determine which description attribute (i.e., polygonal model, textual description, etc.) is transmitted to the other users (i.e., players).

The back-end tier has access to all attributes of all objects—both public and private attributes. Some attributes, however, are flagged private so that they will never be transmitted to client devices. This is important in a distributed environment because the client devices 112 cannot be relied upon to behave correctly with the information that is transmitted to them (the game users “cheating problem”).

IX. Environment

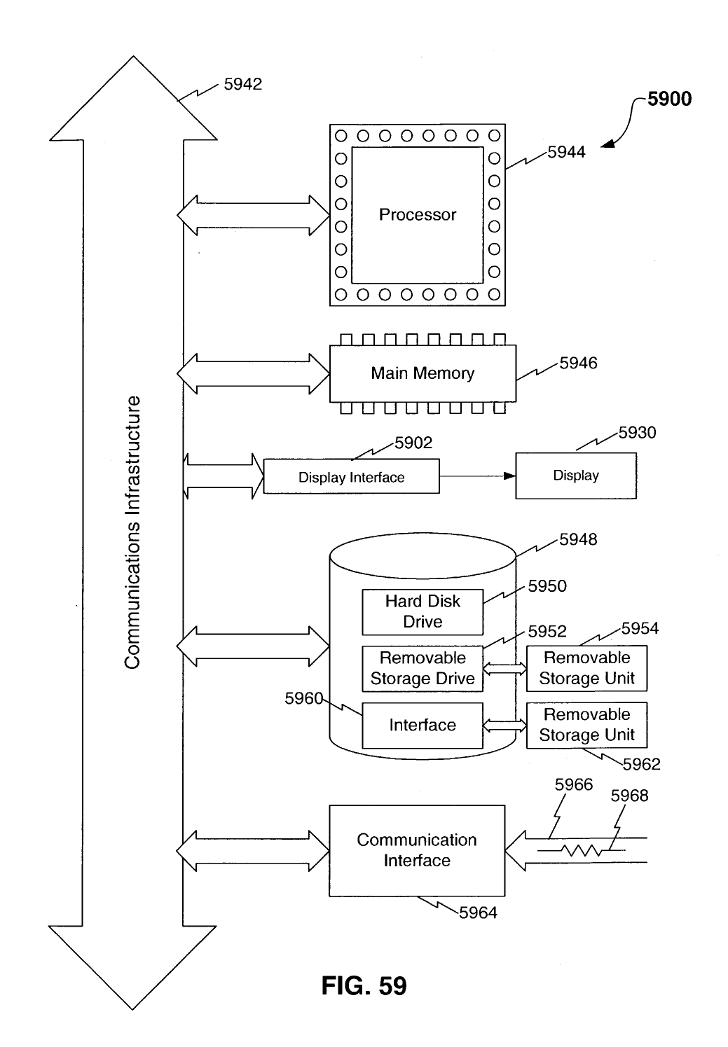

The present invention may be implemented using hardware, software or a combination thereof and may be implemented in one or more computer systems or other processing systems. An example of a computer system 5900 is shown in FIG. 59. The computer system 5900 represents any single or multi-processor computer. In conjunction, single-threaded and multi-threaded applications can be used. Unified or distributed memory systems can be used. Computer system 5900, or portions thereof, may be used to implement the present invention. For example, the system 100 of the present invention may comprise software running on a computer system such as computer system 5900.

In one example, the system 100 of the present invention is implemented in a multi-platform (platform independent) programming language such as JAVA, programming language/structured query language (PL/SQL), hyper-text mark-up language (HTML), practical extraction report language (PERL), common translator interface/structured query language (CGI/SQL) or the like. Java-enabled and JavaScript-enabled browsers are used, such as, Netscape, HotJava, and Microsoft Explorer browsers. Active content Web pages can be used. Such active content Web pages can include Java applets or ActiveX controls, or any other active content technology developed now or in the future. The present invention, however, is not intended to be limited to Java, JavaScript, or their enabled browsers, developed now or in the future, as would be apparent to a person skilled in the relevant art(s) given this description.

In another example, the system 100 of the present invention, may be implemented using a high-level programming language (e.g., C or C++) and applications written for the Microsoft Windows 2000, Linux or Solaris environments. It will be apparent to persons skilled in the relevant art(s) how to implement the invention in alternative embodiments from the teachings herein.

Computer system 5900 includes one or more processors, such as processor 5944. One or more processors 5944 can execute software implementing the routines described above. Each processor 5944 is connected to a communication infrastructure 5942 (e.g., a communications bus, cross-bar, or network). Various software embodiments are described in terms of this exemplary computer system. After reading this description, it will become apparent to a person skilled in the relevant art how to implement the invention using other computer systems and/or computer architectures.

Computer system 5900 can include a display interface 5902 that forwards graphics, text, and other data from the communication infrastructure 5942 (or from a frame buffer not shown) for display on the display unit 5930.

Computer system 5900 also includes a main memory 5946, preferably random access memory (RAM), and can also include a secondary memory 5948. The secondary memory 5948 can include, for example, a hard disk drive 5950 and/or a removable storage drive 5952, representing a floppy disk drive, a magnetic tape drive, an optical disk drive, etc. The removable storage drive 5952 reads from and/or writes to a removable storage unit 5954 in a well known manner. Removable storage unit 5954 represents a floppy disk, magnetic tape, optical disk, etc., which is read by and written to by removable storage drive 5952. As will be appreciated, the removable storage unit 5954 includes a computer usable storage medium having stored therein computer software and/or data.

In alternative embodiments, secondary memory 5948 may include other similar means for allowing computer programs or other instructions to be loaded into computer system 5900. Such means can include, for example, a removable storage unit 5962 and an interface 5960. Examples can include a program cartridge and cartridge interface (such as that found in video game console devices), a removable memory chip (such as an EPROM, or PROM) and associated socket, and other removable storage units 5962 and interfaces 5960 which allow software and data to be transferred from the removable storage unit 5962 to computer system 5900.

Computer system 5900 can also include a communications interface 5964. Communications interface 5964 allows software and data to be transferred between computer system 5900 and external devices via communications path 5966. Examples of communications interface 5964 can include a modem, a network interface (such as Ethernet card), a communications port, interfaces described above, etc. Software and data transferred via communications interface 5964 are in the form of signals which can be electronic, electromagnetic, optical or other signals capable of being received by communications interface 5964, via communications path 5966. Note that communications interface 5964 provides a means by which computer system 5900 can interface to a network such as the Internet.

The present invention can be implemented using software running (that is, executing) in an environment similar to that described above. In this document, the term “computer program product” is used to generally refer to removable storage unit 5954, a hard disk installed in hard disk drive 5950, or a carrier wave carrying software over a communication path 5966 (wireless link or cable) to communication interface 5964. A computer useable medium can include magnetic media, optical media, or other recordable media, or media that transmits a carrier wave or other signal. These computer program products are means for providing software to computer system 5900.

Computer programs (also called computer control logic) are stored in main memory 5946 and/or secondary memory 5948. Computer programs can also be received via communications interface 5964. Such computer programs, when executed, enable the computer system 5900 to perform the features of the present invention as discussed herein. In particular, the computer programs, when executed, enable the processor 5944 to perform features of the present invention. Accordingly, such computer programs represent controllers of the computer system 5900.

The present invention can be implemented as control logic in software, firmware, hardware or any combination thereof. In an embodiment where the invention is implemented using software, the software may be stored in a computer program product and loaded into computer system 5900 using removable storage drive 5952, hard disk drive 5950, or interface 5960. Alternatively, the computer program product may be downloaded to computer system 5900 over communications path 5966. The control logic (software), when executed by the one or more processors 5944, causes the processor(s) 5944 to perform functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s) from the teachings herein.

X. Conclusion

It will be appreciated that while the invention has been described primarily in terms of game terminology, it is not limited to that particular application, and is applicable more generally to such fields as concurrent engineering, to collaborative environments, simulations and distributed work flow environment. The invention is also applicable to such fields as construction engineering, where construction machinery can be equipped transmitters that are connected to the Grid. It is also applicable to military war games, manufacturing or distributed telepresence.

While various embodiments of the present invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus, the present invention should not be limited by any of the above-described exemplary embodiments, but should be defined only in accordance with the following claims and their equivalents.

What is claimed is:

1. A method of managing a collaborative process comprising:
defining a plurality of locales on a plurality of servers;
creating a plurality of objects corresponding to players in the plurality of locales; and
mediating object state of the objects between the locales in a seamless manner so that the locales form a seamless world.

2. The method of claim 1, wherein the plurality servers are hosted on multiple hosts.

3. The method of claim 1, wherein the objects include non-player characters.

4. The method of claim 1, wherein the object state is mediated by exchange of context-agnostic information across process boundaries.

5. The method of claim 4, further including syntactic validation during the exchange.

6. The method of claim 1, wherein the collaborative process is a game.

7. The method of claim 1, wherein the collaborative process is a simulation task.

8. The method of claim 1, wherein the collaborative process includes telepresence.

9. The method of claim 1, wherein the object state is distributed asymmetrically between the servers.

10. The method of claim 1, wherein sentinels are used to mediate object state between two different servers of the plurality of servers.

11. The method of claim 1, wherein the plurality of servers includes a first server and a second server, the method further comprising:
launching a proxy sentinel from the first server into the second server;
starting a stub sentinel on the first server to correspond to the proxy sentinel; and
communicating the object state from the proxy sentinel to the stub sentinel.

12. The method of claim 11, wherein the proxy sentinel is a sink for object state information of objects on the second server, and the stub sentinel is a source for the object state information of objects on the second server.

13. The method of claim 12, wherein the stub sentinel creates ghost objects that correspond to the objects on the second server that come in contact with the proxy sentinel.

14. The method of claim 11, wherein the object state of an object on the first server is transmitted to multiple objects on the second server.

15. The method of claim 1, wherein only a subset of the object state is mediated.

16. The method of claim 1, further comprising moving an object seamlessly from one host to another host.

17. The method of claim 1, further comprising moving an object seamlessly from one server to another server.

18. The method of claim 1, wherein additional locales can be added dynamically to the collaborative process to expand the seamless world.

19. The method of claim 1, wherein additional servers running additional locales can be added dynamically to the collaborative process to expand the seamless world.

20. The method of claim 1, wherein each locale is a thread in a single server.

21. The method of claim 1, wherein the object state is mediated using proxies.

22. The method of claim 1, wherein the object state is mediated asymmetrically between the servers involved in the mediating step.

23. A method of distributing object state across a plurality of hosts comprising:
initiating a plurality of server processes on the multiple hosts;
defining a plurality of objects whose object state is maintained by a corresponding server process; and
mediating exchanges of object state information between the plurality of objects such that the plurality of objects perceive a seamless world formed by the server processes residing on multiple hosts.

24. The method of claim 23, wherein only a subset of the object state for each object is exchanged.

25. The method of claim 23, wherein the object state is transmitted as an abstraction.

26. The method of claim 23, wherein the plurality of server processes are hosted on multiple hosts.

27. The method of claim 23, wherein the objects also include non-player characters.

28. The method of claim 23, wherein the object state is mediated by exchange of context agnostic information across process boundaries.

29. The method of claim 23, wherein sentinels are used to marshal object state between two different server processes of the plurality of server processes.

30. The method of claim 23, wherein the plurality of server processes includes a first server process and a second server process, and further including:
launching a proxy sentinel from the first server process into the second server process, starting a stub sentinel on the first server process to correspond to the proxy sentinel; and
communicating the object state from the proxy sentinel to the stub sentinel.

31. The method of claim 30, wherein the proxy sentinel is a sink for object state of objects on the second server process, and the stub sentinel is a source for the object state of objects on the second server process.

32. The method of claim 31, wherein the stub sentinel creates ghost objects that correspond to the objects on the second server process that come in contact with the proxy sentinel.

33. The method of claim 30, wherein the object state of an object on the first server process is transmitted to multiple objects on the second server process.

34. The method of claim 23, wherein an object can seamlessly move from one host to another host.

35. The method of claim 23, wherein an object can seamlessly move from one server process to another server process.

36. The method of claim 23, wherein the object state is mediated using proxies.

37. A method of distributing object state across server process boundaries comprising:
initiating a plurality of server processes;
defining a plurality of objects whose object state is maintained by a corresponding server process;
marshalling the object state on a first server process using a Network Protocol Stack (NPS) and at least one NPS packet;
transmitting the object state across a process boundary to a second server process; and
de-marshalling the object state on the second server.

38. The method of claim 37, further including transmitting the object state of an object on the first server process to multiple objects on the second server process.

39. The method of claim 37, further including transmitting heartbeat packets with a beat that increases as packet traffic decreases.

40. A method of distributing object state across server process boundaries comprising:
initiating a plurality of server processes;
defining a plurality of objects whose object state is maintained by a corresponding server process;
initiating a message sink for the object state on a first server process; and
creating a message source for the object state on the second server process such that the message source transmits the object state of objects on the first server process to objects on the second server process.

41. A method of managing a collaborative process comprising:
initiating a plurality of server processes;
initiating at least one gateway connected to the plurality of server processes;
directing data from a user to a server process by performing a discovery process to match the user to the server process; and
dynamically redirecting the data from the user to another server process when a user moves from one server process to the another server process.

42. The method of claim 41, wherein the gateway dynamically routes instant messages through the discovery process and dynamic redirection to another gateway.

43. The method of claim 41, wherein the discovery process is performed in a multicast manner.

44. The method of claim 41, wherein the gateway acts as a proxy for a user for transmission of data from the user to a matched server process.

45. A method of managing a collaborative process comprising:
defining a plurality of objects on a plurality of servers, each server having a Network Protocol Stack; and
exchanging information about state of the objects between the servers using their Network Protocol Stacks,
wherein, during the exchanging step, reliable packets and unreliable packets are exchanged such that only dropped reliable packets are resent upon notification from a corresponding Network Protocol Stack to a sender of a dropped packet.

46. A method of managing a collaborative process comprising:
initiating at least one gateway connected-to a plurality of hosts;
performing a discovery process to match a user to a host when a user sends data to an object residing on at least one of the hosts; and
redirecting the data from the user to another host when the object moves from one host to the another host.

47. The method of claim 46, further including binding the user to an Identity residing on one of the plurality of hosts.

48. The method of claim 46, further including authenticating the user.

49. The method of claim 46, wherein the data is sent in a context agnostic manner.

50. The method of claim 46, wherein the Identity corresponds to an Avatar.

51. The method of claim 46, further including blocking messages from a user when the messages exceed a predetermined quota.

52. The method of claim 46, further including syntactically validating packets sent from the user to an object on the plurality of hosts.

53. A method of conducting a distributed secure transaction comprising:
receiving a proposal the distributed secure transaction between a first party and a second party, wherein the first party and the second party are represented by object states distributed across a plurality of servers;
receiving approval for the distributed secure transaction from the first party and the second party;
mediating the distributed secure transaction across the plurality of servers;
verifying that object states of objects maintained on the plurality of servers before and after the distributed secure transaction are valid; and
verifying that the distributed secure transaction is consistent with the original proposal for the distributed secure transaction.

54. A method of distributing object state across locale boundaries comprising:
initiating a plurality of locale threads;
defining a plurality of objects whose object state is maintained in the locale threads;
changing the object state of at least one object in a first locale;
proxying marshaled data representing the changed object state through a proxy sentinel at the first locale to its corresponding stub sentinel at a second locale;
distributing the marshaled data through the stub sentinel to a receiving object at the second locale.

55. A method of effecting a distributed secure transaction comprising:
receiving a proposal for a transaction from a first user;
verifying that the proposal is genuine;
securing the proposal against tampering with a first password;
embedding the sealed proposal in a secure message, the secure message being sealed with a second password;
transmitting the secure message to a second user;
receiving the secure message from the second user, wherein the authenticity of the secure message has been verified, and the secure message has been countersigned by the second user;
verifying that the secure message has been properly countersigned by the second user; and
executing the transaction.

56. The method of claim 55, further including registering the proposal prior to embedding.

57. The method of claim 55, further including preserving atomicity of the transaction.

58. The method of claim 55, further including preserving consistency of the transaction.

59. The method of claim 55, further including preserving isolation of the transaction.

60. The method of claim 55, further including preserving durability of the transaction.

61. A system for managing a collaborative process comprising:
means for defining a plurality of locales on a plurality of servers;
means for creating a plurality of objects corresponding to players in the plurality of locales; and
means for mediating object state of the objects between the locales in a seamless manner so that the locales form a seamless world.

62. A system for distributing object state across a plurality of hosts comprising:
means for initiating a plurality of server processes on the multiple hosts;
means for defining a plurality of objects whose object state is maintained by a corresponding server process; and
means for mediating exchanges of object state information between the plurality of objects such that the plurality of objects perceive a seamless world formed by the server processes residing on multiple hosts.

63. A system for distributing object state across server process boundaries comprising:
means for initiating a plurality of server processes;
means for defining a plurality of objects whose object state is maintained by a corresponding server process;
means for marshalling the object state on a first server process using a Network Protocol Stack (NPS) and at least one NPS packet;
means for transmitting the object state across a process boundary to a second server process; and
means for de-marshaling the object state on the second server.

64. A system for distributing object state across server process boundaries comprising:
means for initiating a plurality of server processes;
means for defining a plurality of objects whose object state is maintained by a corresponding server process;
means for initiating a message sink for the object state on a first server process; and
means for creating a message source for the object state on the second server process such that the message source transmits the object state of objects on the first server process to objects on the second server process.

65. A system for managing a collaborative process comprising:
means for initiating a plurality of server processes;
means for initiating at least one gateway connected to the plurality of server processes;
means for directing data from a user to a server process by performing a discovery process to match the user to the server process; and
means for dynamically redirecting the data from the user to another server process when a user moves from one server process to the another server process.

66. A system for managing a collaborative process comprising:
means for defining a plurality of objects on a plurality of servers, each server having a Network Protocol Stack; and
means for exchanging information about state of the objects between the servers using their Network Protocol Stacks,
wherein, during the exchange of information, reliable packets and unreliable packets are exchanged such that only dropped reliable packets are resent upon notification from a corresponding Network Protocol Stack to a sender of a dropped packet.

67. A system for managing a collaborative process comprising:
means for initiating at least one gateway connected to a plurality of hosts;
means for performing a discovery process to match a user to a host when a user sends data to an object residing on at least one of the hosts; and
means for redirecting the data from the user to another host when the object moves from one host to the another host.

68. A system for conducting a distributed secure transaction comprising:
means for receiving a proposal the distributed secure transaction between a first party and a second party, wherein the first party and the second party are represented by object states distributed across a plurality of servers;
means for receiving approval for the distributed secure transaction from the first party and the second party;
means for mediating the distributed secure transaction across the plurality of servers;
means for verifying that object states of objects maintained on the plurality of servers before and after the distributed secure transaction are valid; and
means for verifying that the distributed secure transaction is consistent with the original proposal for the distributed secure transaction.

69. A system for distributing object state across locale boundaries comprising:
means for initiating a plurality of locale threads;
means for defining a plurality of objects whose object state is maintained in the locale threads;
means for changing the object state of at least one object in a first locale;
means for proxying marshaled data representing the changed object state through a proxy sentinel at the first locale to its corresponding stub sentinel at a second locale; and
means for distributing the marshaled data through the stub sentinel to a receiving object at the second locale.

70. A system for effecting a distributed secure transaction comprising:
means for receiving a proposal for a transaction from a first user;
means for verifying that the proposal is genuine;
means for securing the proposal against tampering with a first password;
means for embedding the sealed proposal in a secure message, the secure message being sealed with a second password;
means for transmitting the secure message to a second user;
means for receiving the secure message from the second user, wherein the authenticity of the secure message has been verified, and the secure message has been countersigned by the second user;
means for verifying that the secure message has been properly countersigned by the second user; and
means for executing the transaction.

71. A computer program product for managing a collaborative process, the computer program product comprising a computer useable medium having computer program logic recorded thereon for controlling a processor, the computer program logic comprising:
a procedure that defines a plurality of locales on a plurality of servers;
a procedure that creates a plurality of objects corresponding to players in the plurality of locales; and
a procedure that mediates object state of the objects between the locales in a seamless manner so that the locales form a seamless world.

72. A computer program product for distributing object state across a plurality of hosts, the computer program product comprising a computer useable medium having computer program logic recorded thereon for controlling a processor, the computer program logic comprising:
a procedure that initiates a plurality of server processes on the multiple hosts;
a procedure that defines a plurality of objects whose object state is maintained by a corresponding server process; and
a procedure that mediates exchanges of object state information between the plurality of objects such that the plurality of objects perceive a seamless world formed by the server processes residing on multiple hosts.

73. A computer program product for distributing object state across server process boundaries, the computer program product comprising a computer useable medium having computer program logic recorded thereon for controlling a processor, the computer program logic comprising:
a procedure that initiates a plurality of server processes;
a procedure that defines a plurality of objects whose object state is maintained by a corresponding server process;
a procedure that marshals the object state on a first server process using a Network Protocol Stack (NPS) and at least one NPS packet;
a procedure that transmits the object state across a process boundary to a second server process; and
a procedure that de-marshals the object state on the second server.

74. A computer program product for distributing object state across server process boundaries, the computer program product comprising a computer useable medium having computer program logic recorded thereon for controlling a processor, the computer program logic comprising:
a procedure that initiates a plurality of server processes;
a procedure that defines a plurality of objects whose object state is maintained by a corresponding server process;
a procedure that initiates a message sink for the object state on a first server process; and
a procedure that creates a message source for the object state on the second server process such that the message source transmits the object state of objects on the first server process to objects on the second server process.

75. A computer program product for managing a collaborative process, the computer program product comprising a computer useable medium having computer program logic recorded thereon for controlling a processor, the computer program logic comprising:
a procedure that initiates a plurality of server processes;
a procedure that initiates at least one gateway connected to the plurality of server processes;
a procedure that directs data from a user to a server process by performing a discovery process to match the user to the server process; and
a procedure that dynamically redirects the data from the user to another server process when a user moves from one server process to the another server process.

76. A computer program product for managing a collaborative process, the computer program product comprising a computer useable medium having computer program logic recorded thereon for controlling a processor, the computer program logic comprising:
a procedure that defines a plurality of objects on a plurality of servers, each server having a Network Protocol Stack; and
a procedure that exchanges information about state of the objects between the servers using their Network Protocol Stacks,
wherein, during the exchange of information, reliable packets and unreliable packets are exchanged such that only dropped reliable packets are resent upon notification from a corresponding Network Protocol Stack to a sender of a dropped packet.

77. A computer program product for managing a collaborative process, the computer program product comprising a computer useable medium having computer program logic recorded thereon for controlling a processor, the computer program logic comprising:
a procedure that initiates at least one gateway connected to a plurality of hosts;
a procedure that performs a discovery process to match a user to a host when a user sends data to an object residing on at least one of the hosts; and
a procedure that redirects the data from the user to another host when the object moves from one host to the another host.

78. A computer program product for conducting a distributed secure transaction, the computer program product comprising a computer useable medium having computer program logic recorded thereon for controlling a processor, the computer program logic comprising:
a procedure that receives a proposal the distributed secure transaction between a first party and a second party, wherein the first party and the second party are represented by object states distributed across a plurality of servers;
a procedure that receives approval for the distributed secure transaction from the first party and the second party;
a procedure that mediates the distributed secure transaction across the plurality of servers;
a procedure that verifies that object states of objects maintained on the plurality of servers before and after the distributed secure transaction are valid; and
a procedure that verifies that the distributed secure transaction is consistent with the original proposal for the distributed secure transaction.

79. A computer program product for distributing object state across locale boundaries, the computer program product comprising a computer useable medium having computer program logic recorded thereon for controlling a processor, the computer program logic comprising:
a procedure that initiates a plurality of locale threads;
a procedure that defines a plurality of objects whose object state is maintained in the locale threads;
a procedure that changes the object state of at least one object in a first locale;
a procedure that proxies marshaled data representing the changed object state through a proxy sentinel at the first locale to its corresponding stub sentinel at a second locale; and
a procedure that distributes the marshaled data through the stub sentinel to a receiving object at the second locale.

80. A computer program product for effecting a distributed secure transaction, the computer program product comprising a computer useable medium having computer program logic recorded thereon for controlling a processor, the computer program logic comprising:
a procedure that receives a proposal for a transaction from a first user;
a procedure that verifies that the proposal is genuine;
a procedure that secures the proposal against tampering with a first password;
a procedure that embeds the sealed proposal in a secure message, the secure message being sealed with a second password;
a procedure that transmits the secure message to a second user;
a procedure that receives the secure message from the second user, wherein the authenticity of the secure message has been verified, and the secure message has been countersigned by the second user;
verifies that the secure message has been properly countersigned by the second user; and
a procedure that executes the transaction.
